(19) United States
(12) Patent Application Publication
(10) Pub. No.: US 2007/0168674 A1
(43) Pub. Date: Jul. 19, 2007

(54) Authentication system, authentication apparatus, and recording medium

(76) Inventors: Masao Nonaka, Osaka (JP); Makoto Tatebayashi, Hyogo (JP); Motoji Ohmori, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/581,445

(22) PCT Filed: Nov. 30, 2004
(86) PCT No.: PCT/JP04/17758

§ 371 Date: Jun. 2, 2006

(30) Foreign Application Priority Data
Dec. 9, 2003 (JP) 2003-410784

(51) Int. Cl. H04L 9/00; H04K 1/00

(52) U.S. Cl. 713/182; 713/185; 713/186; 713/172; 713/173; 713/175; 713/168

(57) ABSTRACT

An authentication system that verifies various types of authenticity in regards with a visit by a forwarding agent. An identity authentication system is composed of an authentication card, a user terminal, and a card reader. Upon insertion of the authentication card into the card reader, the user terminal generates a random number, stores therein the generated random number, and outputs the random number to the authentication card. The authentication card generates encrypted information by encrypting the received random number using an identity certification key having been stored therein, and outputs the generated encrypted information to the user terminal. The user terminal decrypts the received encrypted information using an identity authentication key having been stored therein, and performs an authentication by judging whether or not the decrypting result matches the stored random number.

### TECHNICAL FIELD

The present invention relates to a technology for authenticating the identity of the owner of a recording medium.

### BACKGROUND ART

Conventionally, as a method of checking a visitor from inside the residence, an intercommunication system or a TV door-phone has been used.

With the above-mentioned methods, however, it is difficult to accurately identify a visitor who has disguised his/her appearance or voice.

As a technology for overcoming the above-stated problem, the following personal information display system has been disclosed. The personal information display system includes a server for prestoring personal information and personal identification information, an input apparatus for receiving input personal identification information, and a user terminal for transmitting the received personal identification information to the server via a communication line.

The input apparatus has a fingerprint input apparatus. The fingerprint input apparatus receives a fingerprint input by a visitor. The input apparatus outputs the received fingerprint as the personal identification information to the user terminal. Upon receiving the personal identification information, the user terminal transmits the received personal identification information to the server. The server matches the received personal identification information against the personal identification information is has prestored. Depending on the matching result, the server transmits personal information that has been stored in correlation with the personal identification information. The user terminal displays the personal information received from the server.

Such a personal information display system enables the user to securely confirm the identity of a visitor, who can be a forwarding agent for example, that is to say, enables the user to verify the authenticity of the visit by the visitor.

### DISCLOSURE OF THE INVENTION

### The Problems the Invention is Going to Solve

However, although the above-introduced personal information display system can verify the authenticity of a person by checking his/her fingerprint, it cannot verify other types of authenticity such as the authenticity of an organization like a forwarding agent, or the authenticity of the business of the visit.

It is therefore an object of the present invention to provide an identity authentication system, authentication apparatus, recording medium, authentication method, authentication program, and a program recording medium that verify various types of authenticity in regards with a visit by a forwarding agent, which is not available with conventional technologies.

### Means to Solve the Problems

The above-stated object is fulfilled by an authentication system, comprising: a portable recording medium which a forwarding agent has; an authentication apparatus operable to verify authenticity of a visit by the forwarding agent, the authentication apparatus being provided in a residence of a person who is visited by the forwarding agent; and an input/output apparatus operable to perform inputting and outputting of information between the portable recording medium and the authentication apparatus, the input/output apparatus being provided at an entrance of the residence, wherein the portable recording medium stores therein in advance at least one piece of information concerning authenticity of the visit by the forwarding agent, and the authentication apparatus stores therein at least one piece of information used for verifying authenticity of the visit by the forwarding agent, and judges whether or not the visit by the forwarding agent is authentic by, via the input/output apparatus, performing an authentication using the information stored in the portable recording medium and the information stored in the authentication apparatus.

### Effects of the Invention

With the above-described construction, the authentication apparatus of the authentication system can judge whether or not a visit by a home-visit company is authentic by, via the input/output apparatus, performing an authentication using the information stored in the portable recording medium which the forwarding agent has and the information concerning the authenticity of the visit by the forwarding agent. While the conventional personal information display system can verify only the authenticity of a visitor himself/herself, the authentication apparatus of the present invention can verify various types of authenticity in regards with the visit by the forwarding agent, using the information concerning authenticity of the visit by the forwarding agent that is stored in the portable recording medium. Also, this enables a person visited by such a visitor to recognize, while staying inside the residence, whether or not the visit by a home-visit company is authentic.

In the above stated-authentication system, the portable recording medium may be an IC card, the input/output apparatus is a card reader for the IC card, the card reader detects a lock status of an entrance door, and the authentication apparatus performs the authentication if the card reader detects that the entrance door is locked.

With the above-described construction, the authentication apparatus of the authentication system can perform the authentication while the entrance door is locked. This enables a person visited by a visitor can judge whether or not to let the visitor in depending on the authentication result, without letting the visitor in until the authentication apparatus completes the authentication. That is to say, if the authentication apparatus judges that a visit by a home-visit company is authentic, the person visited by the visitor can unlock the entrance door and let the visitor in.

In the above stated-authentication system, the IC card may store therein certification information that certifies authenticity of the forwarding agent, as the information concerning authenticity of the visit by the forwarding agent, the authentication apparatus stores therein, as the information concerning verifying authenticity of the visit by the forwarding agent, authentication information that is used to examine the certification information, and the authentication apparatus performs, via the card reader, the authentication using the certification information and the stored authentication information to judge whether or not the visit by the forwarding agent is authentic.

With the above-described construction, the authentication apparatus of the authentication system can perform an authentication using the certification information stored in the IC card and the authentication information stored in the authentication apparatus.

In the above stated-authentication system, the IC card may further store therein first visit information that indicates a business of the visit by the forwarding agent, as the information concerning authenticity of the visit by the forwarding agent, the authentication apparatus further stores therein, as the information concerning verifying authenticity of the visit by the forwarding agent, second visit information used to examine the first visit information, and the authentication apparatus, if a result of the authentication using the certification information and the authentication information is positive, acquires the first visit information from the IC card via the card reader, judges whether or not the acquired first visit information matches the stored second visit information, and if a result of the judgment is positive, judges that the visit by the forwarding agent is authentic.

With the above-described construction, the authentication apparatus of the authentication system can judge that a visit by a home-visit company is authentic if the result of the authentication using the certification information and the authentication information is positive, and the first visit information matches the second visit information. That is to say, the authentication apparatus can judge that a visit by a home-visit company is authentic if it judges that the home-visit company is authentic and judges that the business of the visit by the forwarding agent is authentic. This enables a person visited by such a visitor to avoid an improper visit. For example, it is possible to avoid an improper visit by someone who disguises an authentic visitor.

In the above stated-authentication system, the first visit information may be first time information that indicates a time period for the visit by the forwarding agent, the second visit information is second time information that indicates a time period for the visit by the forwarding agent, and the authentication apparatus judges whether or not the first time information matches the second time information.

With the above-described construction, the authentication system can include the first and second visit information that indicate a time period for a visit by a home-visit company, and the authentication apparatus can judge that the visit by the home-visit company is authentic if the first and second visit information indicates the same time period.

In the above stated-authentication system, the first visit information may be first business information that indicates a business of the visit by the forwarding agent, the second visit information is second business information that indicates a business of the visit by the forwarding agent, and the authentication apparatus judges whether or not the first business information matches the second business information.

With the above-described construction, the authentication system can include the first and second visit information that indicate a business of a visit by a home-visit company, and the authentication apparatus can judge that the visit by the home-visit company is authentic if the first and second visit information indicates the same business of a visit.

In the above stated-authentication system, the first visit information may include (i) first time information that indicates a time period for the visit by the forwarding agent and (ii) first business information that indicates a business of the visit by the forwarding agent, the second visit information may include (iii) second time information that indicates a time period for the visit by the forwarding agent and (iv) second business information that indicates a business of the visit by the forwarding agent, and the authentication apparatus judges whether or not the first time information matches the second time information, and judges whether or not the first business information matches the second business information.

With the above-described construction, the authentication system can include the first and second visit information that indicate a time period and a business of a visit by a home-visit company, and the authentication apparatus can judge that the visit by the home-visit company is authentic if the first and second visit information indicates the same time period and business of a visit.

In the above stated-authentication system, the IC card may further store therein article information concerning an article delivered by the forwarding agent, and the authentication apparatus further acquires the article information from the IC card via the card reader, and if the authentication apparatus judges that the visit by the forwarding agent is authentic, displays the article information.

With the above-described construction, the authentication apparatus of the authentication system can display article information acquired from the IC card if the authentication apparatus judges that the visit by the home-visit company is authentic.

In the above stated-authentication system, the article information may be a name of a sender of the article, and the authentication apparatus acquires the name of the sender from the IC card and displays the acquired name.

With the above-described construction, the authentication apparatus of the authentication system can display the name of the sender of the article if the authentication apparatus judges that the visit by the home-visit company is authentic. This enables the person visited by a visitor to check the sender's name and reject to receive the article if the displayed name is a stranger to the person. Accordingly, the person can reject receiving the article that has been sent from a suspicious sender.

In the above stated-authentication system, the article information may be a name of the article, and the authentication apparatus acquires the name of the article from the IC card and displays the acquired name of the article.

With the above-described construction, the authentication apparatus of the authentication system can display the name of the article if the authentication apparatus judges that the visit by the home-visit company is authentic. This enables the person visited by a visitor to reject to receive a suspicious article by checking the name of the article.

In the above stated-authentication system, the article information may be a message from a sender of the article, and the authentication apparatus acquires the message from the IC card and displays the acquired message.

With the above-described construction, the authentication apparatus of the authentication system can display a message from a sender of the article if the authentication apparatus judges that the visit by the home-visit company is authentic.

In the above stated-authentication system, the IC card may further store therein visitor information for identifying a visitor, the authentication apparatus further acquires the visitor information from the IC card via the card reader, and if the authentication apparatus judges that the visit by the forwarding agent is authentic, displays the visitor information.

With the above-described construction, the authentication apparatus of the authentication system can display visitor information acquired from the IC card if the authentication apparatus judges that the visit by the home-visit company is authentic.

In the above stated-authentication system, the visitor information may be a name of the visitor, and the authentication apparatus acquires the name of the visitor from the IC card and displays the acquired name of the visitor.

With the above-described construction, the authentication apparatus of the authentication system can display the name of the visitor if the authentication apparatus judges that the visit by the home-visit company is authentic. This enables the person visited by a visitor to judge whether or not the name written on the name tag of the visitor, which can be confirmed through a peephole of the door, matches the displayed name.

In the above stated-authentication system, the visitor information may be an image of a facial photo of the visitor, and the authentication apparatus acquires the image of the facial photo of the visitor from the IC card and displays the acquired image of the facial photo.

With the above-described construction, the authentication apparatus of the authentication system can display an image of a facial photo of the visitor if the authentication apparatus judges that the visit by the home-visit company is authentic. This enables the person visited by a visitor to judge whether or not the face of the visitor, which can be confirmed through a peephole of the door, matches the displayed image of the facial photo.

In the above stated-authentication system, the visitor information may be a name and an image of a facial photo of the visitor, and the authentication apparatus acquires the name and the image of the facial photo of the visitor from the IC card and displays the acquired name and image of the facial photo.

With the above-described construction, the authentication apparatus of the authentication system can display the name and an image of a facial photo of the visitor if the authentication apparatus judges that the visit by the home-visit company is authentic. This enables the person visited by a visitor to judge whether or not the name written on the name tag of the visitor and the face of the visitor, which can be confirmed through a peephole of the door, match the displayed name and image of the facial photo.

In the above stated-authentication system, the authentication apparatus and the IC card may perform a challenge-response authentication process using the certification information and the authentication information.

With the above-described construction, the authentication apparatus of the authentication system can perform a challenge-response authentication process using the certification information and the authentication information.

In the above stated-authentication system, the certification information may be an encryption key, the authentication information is a decryption key, the authentication apparatus generates challenge data, and outputs the generated challenge data to the IC card via the card reader, the IC card receives the challenge data from the authentication apparatus, generates response data by encrypting the challenge data using the encryption key, and outputs the generated response data to the authentication apparatus via the card reader, and the authentication apparatus receives the response data from the IC card, generates decrypted data by decrypting the response data using the decryption key, and performs an authentication by judging whether or not the generated decrypted data matches the challenge data.

With the above-described construction, the authentication apparatus of the authentication system can receive from the IC card the response data that was generated by encrypting the challenge data using the encryption key stored in the IC card, decrypt the response data, and perform the authentication using the decrypting result and the challenge data. This enables information to be securely protected from wiretapping during a transmission on a transmission path between the authentication apparatus and the IC card since the information is encrypted prior to the transmission. Also, even if the information obtained through a wiretapping is decrypted, only the challenge data is revealed, but the certification information that indicates the authenticity of the home-visit company is not revealed.

In the above stated-authentication system, the encryption key may be holder certification information that shows biometric characteristics of a holder of the IC card, and the authentication apparatus further receives holder authentication information that shows biometric characteristics of a visitor, and uses the holder authentication information as the decryption key.

With the above-described construction, the authentication system can use, as the encryption key, holder certification information that shows biometric characteristics of a holder of the IC card, and can use, as the decryption key, holder authentication information that shows biometric characteristics of a visitor.

In the above stated-authentication system, the authentication apparatus may be connected, via a network, to a distribution apparatus that distributes the decryption key, the authentication apparatus receives the decryption key distributed from the distribution apparatus and stores the received decryption key prior to the visit by the forwarding agent.

With the above-described construction, the authentication apparatus of the authentication system can receive the decryption key from the distribution apparatus and store the received decryption key prior to the visit by the home-visit company.

In the above stated-authentication system, the authentication information may be a secret key, the IC card stores therein a first key that is obtained by executing a one-way function on a key that is identical with the secret key, the authentication apparatus generates challenge data, and outputs the generated challenge data to the IC card via the card reader, the IC card receives the challenge data from the authentication apparatus, generates response data by encrypting the challenge data using the first key, and outputs the generated response data to the authentication apparatus via the card reader, and the authentication apparatus receives the response data from the IC card, generates a second key by executing a function, which is identical with the one-way function, on the secret key, generates decrypted data by decrypting the response data using the second key, and performs an authentication by judging whether or not the generated decrypted data matches the challenge data.

With the above-described construction, the authentication apparatus of the authentication system can receive from the IC card the response data that was generated by encrypting the challenge data using the first key stored in the IC card, generate the second key, decrypt the response data using the generated second key, and perform the authentication using the decrypting result and the challenge data. This enables information to be securely protected from wiretapping during a transmission on a transmission path between the authentication apparatus and the IC card since the information is encrypted prior to the transmission. Also, even if the information obtained through a wiretapping is decrypted, only the challenge data is revealed, but the certification information that indicates the authenticity of the home-visit company is not revealed. Also, even if the first key stored in the IC card is revealed, the secret key is not revealed since due to the property of the one-way function, the secret key cannot be generated from the first key. These are a few of advantageous effects of the present invention.

In the above stated-authentication system, the authentication information may be is a first secret key, the IC card stores therein a second secret key that is identical with the first secret key, the authentication apparatus generates challenge data, and outputs the generated challenge data to the IC card via the card reader, the IC card receives the challenge data from the authentication apparatus, generates response data by encrypting the challenge data using the second secret key, and outputs the generated response data to the authentication apparatus via the card reader, and the authentication apparatus receives the response data from the IC card, generates encrypted data by encrypting the challenge data using the first secret key, and performs an authentication by judging whether or not the generated encrypted data matches the response data.

With the above-described construction, the authentication apparatus of the authentication system can receive from the IC card the response data that was generated by encrypting the challenge data using the first key stored in the IC card, generate encrypted data, and perform the authentication using the generated encrypted data and the response data.

In the above stated-authentication system, the certification information may be a secret key, the authentication information is a public key that corresponds to the secret key, the authentication apparatus generates challenge data, and outputs the generated challenge data to the IC card via the card reader, the IC card receives the challenge data from the authentication apparatus, generates a digital signature of the received challenge data using the secret key, and outputs the generated digital signature as response data, to the authentication apparatus via the card reader, and the authentication apparatus receives the response data from the IC card, and then performs an authentication by performing a signature verification on the received digital signature using the public key and the challenge data.

With the above-described construction, the authentication apparatus of the authentication system can perform a challenge-response authentication using a digital signature.

In the above stated-authentication system, the secret key may be holder certification information that shows biometric characteristics of a holder of the IC card, and the authentication apparatus further receives holder authentication information that shows biometric characteristics of a visitor, and uses the holder authentication information as the public key.

With the above-described construction, the authentication system can use, as the secret key used for the digital signature, holder certification information that shows biometric. characteristics of a holder of the IC card, and use, as the public key used for verifying the digital signature, holder authentication information that shows biometric characteristics of a visitor.

In the above stated-authentication system, the certification information maybe a secret key, the authentication information is a public key that corresponds to the secret key, the authentication apparatus generates challenge data, generates encrypted challenge data by encrypting the generated challenge data using the public key, and outputs the generated encrypted challenge data to the IC card via the card reader, the IC card receives the encrypted challenge data from the authentication apparatus, generates response data by decrypting the received encrypted challenge data using the secret key, and outputs the generated response data to the authentication apparatus via the card reader, and the authentication apparatus receives the response data from the IC card, and performs an authentication by judging whether or not the received response data matches the challenge data.

With the above-described construction, the authentication apparatus of the authentication system can encrypt the challenge data using the public key, the IC card can generate response data by decrypting the encrypted challenge data and output the generated response data to the authentication apparatus, and the authentication apparatus can perform an authentication using the challenge data and the response data.

In the above stated-authentication system, the IC card may store therein a public key certificate that is a proof of validity for the public key, which is also contained in the public key certificate, and the authentication apparatus further acquires the public key certificate from the IC card, performs an authentication by judging whether or not the acquired public key certificate is authentic, and if a result of the authentication is positive, stores therein the public key that is contained in the public key certificate.

With the above-described construction, the authentication apparatus of the authentication system can acquire a public key from the public key certificate stored in the IC card, and store therein the acquired public key.

In the above stated-authentication system, the IC card may store therein a second visit key that is identical with a first visit key that is distributed from the forwarding agent to the authentication apparatus prior to the visit, the authentication apparatus further stores therein the first visit key, if a result of an authentication by a challenge-response is positive, the authentication apparatus further generates visit examination data, and outputs the generated visit examination data to the IC card via the card reader, the IC card receives the visit examination data from the authentication apparatus, generates encrypted visit examination data by encrypting the received visit examination data using the second visit key, and outputs the generated encrypted visit examination data to the authentication apparatus via the card reader, and the authentication apparatus receives the encrypted visit examination data from the IC card, decrypts the encrypted visit examination data using the first visit key, judges whether or not a result of the decrypting matches the visit examination data, and if it judges that the result of the decrypting matches the visit examination data, judges whether or not first visit information matches second visit information.

With the above-described construction, the authentication apparatus of the authentication system can perform an authentication using the first visit key and the second visit key if a result of a challenge-response authentication using the certification information and the authentication information is positive.

In the above stated-authentication system, when the authentication apparatus outputs the challenge data to the IC card, the authentication apparatus may convert the challenge data into converted challenge information that has the same contents as the challenge data but has a different data structure from the challenge data, and output, to the IC card, the converted challenge information as the challenge data.

With the above-described construction, the authentication apparatus of the authentication system, when outputting the challenge data to the IC card, can generate converted challenge information using the challenge data, and output the generated converted challenge information, as the challenge data, to the IC card.

In the above stated-authentication system, when the IC card outputs the response data to the authentication apparatus, the IC card may convert the response data into converted response information that has the same contents as the response data but has a different data structure from the response data, and outputs, to the authentication apparatus, the converted response information as the response data.

With the above-described construction, the IC card of the authentication system, when outputting the response data to the authentication apparatus, can generate converted response information using the response data, and output the generated converted response information, as the response data, to the IC card.

In the above stated-authentication system, the converted challenge information may be composed of one of an optical signal, a bar code, a QR code, an infrared signal, and an audio signal, and the converted response information is composed of one of an optical signal, a bar code, a QR code, an infrared signal, and an audio signal.

With the above-described construction, the authentication apparatus of the authentication system can output converted challenge information, which is composed of one of an optical signal, bar code, QR code, infrared signal, and audio signal, to the IC card, and the IC card can output converted response information, which is composed of one of an optical signal, bar code, QR code, infrared signal, and audio signal, to the authentication apparatus.

In the above stated-authentication system, the authentication apparatus may further store therein an apparatus identifier for identifying the authentication apparatus itself, the authentication apparatus outputs the apparatus identifier to the IC card via the card reader if the authentication apparatus judges that the visit by the forwarding agent is authentic, and the IC card, upon receiving the apparatus identifier from the authentication apparatus, stores therein the received apparatus identifier.

With the above-described construction, the authentication apparatus of the authentication system can output the apparatus identifier to the IC card.

The object of the present invention is also fulfilled by an authentication apparatus for verifying authenticity of a visit by a forwarding agent using a portable recording medium which the forwarding agent has, the authentication apparatus being provided in a residence of a person who is visited by the forwarding agent, the authentication apparatus comprising: an information storage unit operable to store therein information used for the verifying of authenticity of the visit by the forwarding agent; and a judgment unit operable to judge whether or not the visit by the forwarding agent is authentic by, via an input/output apparatus provided at an entrance of the residence, performing an authentication using information stored in the portable recording medium concerning authenticity of the visit by the forwarding agent and using the information stored in the information storage unit.

With the above-described construction, the authentication apparatus can judge whether or not a visit by a home-visit company is authentic by, via the input/output apparatus, performing an authentication using the information stored in the portable recording medium which the forwarding agent has and the information stored in the authentication apparatus. While the conventional personal information display system can verify only the authenticity of a visitor himself/herself, the authentication apparatus of the present invention can verify various types of authenticity in regards with the visit by the forwarding agent, using the information concerning authenticity of the visit by the forwarding agent that is stored in the portable recording medium. Also, this enables a person visited by such a visitor to recognize, while staying inside the residence, whether or not the visit by a home-visit company is authentic.

In the above stated-authentication apparatus, the input/output apparatus may be a card reader for the recording medium, the card reader detects a lock status of an entrance door, and the judgment unit performs the authentication if the card reader detects that the entrance door is locked.

With the above-described construction, the authentication apparatus can perform the authentication while the entrance door is locked. This enables a person visited by a visitor can judge whether or not to let the visitor in depending on the authentication result, without letting the visitor in until the authentication apparatus completes the authentication. That is to say, if the authentication apparatus judges that a visit by a home-visit company is authentic, the person visited by the visitor can unlock the entrance door and let the visitor in.

In the above stated-authentication apparatus, the recording medium may store therein certification information that certifies authenticity of the forwarding agent, as the information concerning authenticity of the visit by the forwarding agent, the information storage unit stores therein, as the information concerning verifying authenticity of the visit by the forwarding agent, authentication information that is used to examine the certification information, and the judgment unit performs, via the card reader, the authentication using the certification information and the stored authentication information to judge whether or not the visit by the forwarding agent is authentic.

With the above-described construction, the authentication apparatus can perform an authentication using the authentication information and the certification information.

In the above stated-authentication apparatus, the recording medium may further store therein first visit information that indicates a business of the visit by the forwarding agent, as the information concerning authenticity of the visit by the forwarding agent, the information storage unit further stores therein, as the information concerning verifying authenticity of the visit by the forwarding agent, second visit information used to examine the first visit information, and the judgment unit, if a result of the authentication using the certification information and the authentication information is positive, acquires the first visit information from the recording medium via the card reader, judges whether or not the acquired first visit information matches the stored second visit information, and if a result of the judgment is positive, judges that the visit by the forwarding agent is authentic.

With the above-described construction, the authentication apparatus can judge that a visit by a home-visit company is authentic if the result of the authentication using the certification information and the authentication information is positive, and the first visit information matches the second visit information. That is to say, the authentication apparatus can judge that a visit by a home-visit company is authentic if it judges that the home-visit company is authentic and judges that the business of the visit by the forwarding agent is authentic. This enables a person visited by such a visitor to avoid an improper visit. For example, it is possible to avoid an improper visit by someone who disguises an authentic visitor.

In the above stated-authentication apparatus, the recording medium may further store therein article information concerning an article delivered by the forwarding agent, and the authentication apparatus further comprises: an article information acquiring unit operable to acquire the article information from the recording medium via the card reader; and an article information display unit operable to display the article information if the judgment unit judges that the visit by the forwarding agent is authentic.

With the above-described construction, the authentication apparatus can display article information acquired from the IC card if the authentication apparatus judges that the visit by the home-visit company is authentic.

In the above stated-authentication apparatus, the recording medium may further store therein visitor information for identifying a visitor, and the authentication apparatus further comprises: a visitor information acquiring unit operable to acquire the visitor information from the recording medium via the card reader; and a visitor information display unit operable to display the visitor information if the judgment unit judges that the visit by the forwarding agent is authentic.

With the above-described construction, the authentication apparatus can display the visitor information, which is acquired from the recording medium, if the authentication apparatus judges that the visit by the home-visit company is authentic.

In the above stated-authentication apparatus, the authentication apparatus and the recording medium may perform a challenge-response authentication process using the certification information and the authentication information.

With the above-described construction, the authentication apparatus can perform a challenge-response authentication using the authentication information and the certification information.

In the above stated-authentication apparatus, the authentication apparatus may be a mobile phone.

With the above-described construction, the authentication apparatus can be a mobile phone.

The object of the present invention is also fulfilled by a portable recording medium which a forwarding agent has and is used by an authentication apparatus operable to verify authenticity of a visit by the forwarding agent, the authentication apparatus being provided in a residence of a person who is visited by the forwarding agent, the portable recording medium comprising: a storage unit operable to store therein in advance at least one piece of information concerning authenticity of the visit by the forwarding agent; a receiving unit operable to receive first data from the authentication apparatus via an input/output apparatus provided at an entrance of the residence; a data generating unit operable to generate second data from the first data using the information stored in the storage unit, the second data being used for an authentication process; and an output unit operable to output the second data to the authentication apparatus via the input/output apparatus.

With the above-described construction, the recording medium can receive the first data from the authentication apparatus via the input/output apparatus, generate the second data, which is used for the authentication process, from the first data using the stored information, and output the generated second data to the authentication apparatus. This enables the authentication apparatus to acquire, from the recording medium which the visitor who is outside the residence has, the second data that is necessary for the authentication process.

In the above-stated recording medium, the storage unit may store therein certification information that certifies authenticity of the forwarding agent, as the information concerning authenticity of the visit by the forwarding agent, and the data generating unit generates the second data using the certification information.

With the above-described construction, the recording medium can generate the second data using the certification information.

In the above-stated recording medium, the storage unit may further store therein visit information that indicates a business of the visit by the forwarding agent, as the information concerning authenticity of the visit by the forwarding agent, and the output unit further outputs the visit information to the authentication apparatus via the input/output apparatus.

With the above-described construction, the recording medium can store therein visit information as the information concerning authenticity of the visit by the forwarding agent, and output the visit information to the authentication apparatus.

In the above-stated recording medium, the storage unit may further store therein article information concerning an article delivered by the forwarding agent, and the output unit further outputs the article information to the authentication apparatus via the input/output apparatus.

With the above-described construction, the recording medium can store therein article information concerning the article, and output the article information to the authentication apparatus.

In the above-stated recording medium, the storage unit may further store therein visitor information for identifying a visitor, and the output unit further outputs the visitor information to the authentication apparatus via the input/output apparatus.

With the above-described construction, the recording medium can store therein visitor information concerning the visitor, and output the visitor information to the authentication apparatus.

In the above-stated recording medium, the authentication apparatus may store therein authentication information that is used to examine the certification information, and the authentication apparatus and the recording medium perform a challenge-response authentication process using the certification information and the authentication information.

With the above-described construction, the recording medium can perform a challenge-response authentication using the certification information and the authentication information.

The above-stated recording medium may be attached to a mobile phone.

With the above-described construction, the recording medium can be attached to a mobile phone for use.

### BRIEF DESCRIPTION OF THE DRAWING

FIG. 1 shows an outline of the entire identity authentication system 1.

FIG. 2 is a block diagram showing the construction of the authentication card 10.

FIG. 3 is a block diagram showing the construction of the user terminal 20 and the card reader 30.

FIG. 4 shows the data structure of the key information table T100 that is provided in the authentication key storage unit 201.

FIG. 5 is a flowchart showing the operation of the identity authentication system 1 in the identity authentication process.

FIG. 6 is a flowchart showing the operation of the identity authentication system 1 in the authentication process.

FIG. 7 shows an outline of the entire identity authentication system 1A.

FIG. 8 is a block diagram showing the construction of the distribution apparatus 50A.

FIG. 9 shows the data structure of the distribution key information table T200 that is provided in the distribution key storage unit 501A.

FIG. 10 is a block diagram showing the construction of the authentication card 10A.

FIG. 11 is a block diagram showing the construction of the user terminal 20A and the card reader 30A.

FIG. 12 is a flowchart showing the operation of the identity authentication system 1A in the distribution process.

FIG. 13 is a flowchart showing the operation of the identity authentication system 1A in the identity authentication process.

FIG. 14 is a flowchart showing the operation of the identity authentication system 1A in the authentication process.

FIG. 15 shows an outline of the entire identity authentication system 1B.

FIG. 16 is a block diagram showing the construction of the authentication card 10B.

FIG. 17 is a block diagram showing the construction of the user terminal 20B and the card reader 30B.

FIG. 18 is a flowchart showing the operation of the identity authentication system 1B in the identity authentication process.

FIG. 19 is a flowchart showing the operation of the identity authentication system 1B in the authentication process.

FIG. 20 shows an outline of the entire identity authentication system 1C.

FIG. 21 is a block diagram showing the construction of the distribution apparatus 50C.

FIG. 22 is a block diagram showing the construction of the authentication card 10C.

FIGS. 23A and 23B show the data structure of the certification visit information table T300 and the certification visit key table T310 that are provided in the visit key storage unit 105C.

FIG. 24 is a block diagram showing the construction of the user terminal 20C and the card reader 30C.

FIG. 25 is a flowchart showing the operation of the identity authentication system 1C in the visit information distribution process.

FIG. 26 is a flowchart showing the operation of the identity authentication system 1C in the identity authentication process, continuing to FIG. 27.

FIG. 27 is a flowchart showing the operation of the identity authentication system 1C in the identity authentication process, continued from FIG. 26.

FIG. 28 is a flowchart showing the operation of the identity authentication system 1C in the visit key authentication process.

FIG. 29 is a flowchart showing the operation of the identity authentication system 1C in the visit information authentication process.

FIG. 30 shows an outline of the entire identity authentication system 1D.

FIG. 31 is a block diagram showing the construction of the authentication card 10D and the second input/output apparatus 70D.

FIG. 32 is a block diagram showing the construction of the user terminal 20D and the first input/output apparatus 60D.

FIG. 33 shows the data structure of the key information table T500.

FIG. 34 shows the data structure of the information table T600.

FIG. 35 is a block diagram showing the construction of the authentication card 1010.

FIG. 36 is a block diagram showing the construction of the user terminal 1020 and the card reader 1030.

FIG. 37 is a flowchart showing the operation of the identity authentication system 1000 in the identity authentication process.

FIG. 38 is a flowchart showing the operation of the identity authentication system 1000 in the examination process.

FIG. 39 is a flowchart showing the operation of the identity authentication system 1000 in the authentication process.

### DESCRIPTION OF CHARACTERS

identity authentication system 1
authentication card 10
user terminal 20
card reader 30
cable 40
certification key storage unit 101
control unit 102
input/output unit 103
authentication key storage unit 201
authentication unit 202
display unit 203
input/output unit 204
random number storage area 250
ID storage area 251
receiver 290
lock status detection unit 300
card reading unit 301
input/output unit 302
call button 390
microphone 391
speaker 392
insertion slot 394

### BEST MODE FOR CARRYING OUT THE INVENTION

### 1. Embodiment 1

The following describes an identity authentication system 1 in Embodiment 1 of the present invention.

1.1 Outline of Identity Authentication System 1

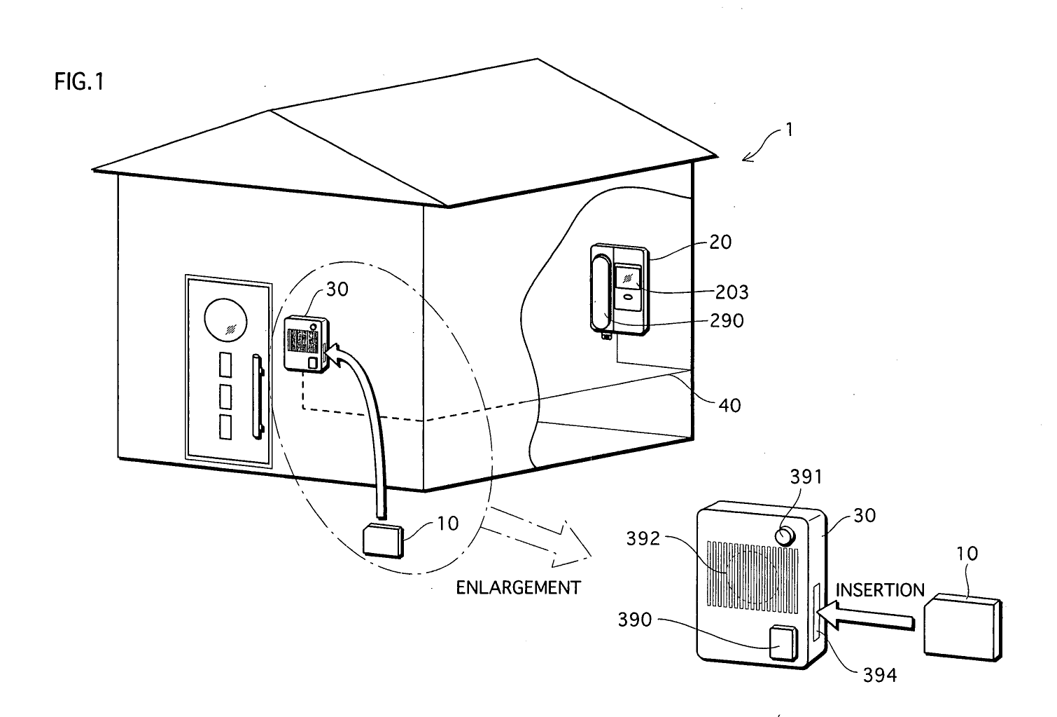

The identity authentication system 1, as shown in FIG. 1, is composed of an authentication card 10, a user terminal 20, and a card reader 30.

The authentication card 10 belongs to a home-visit company (for example, a forwarding agent) which sends a person to visit the residence of the user. The authentication card 10 prestores an identity certification key that is unique to the home-visit company and certifies the authenticity of the authentication card 10 itself. The identity certification key is securely managed by the home-visit company. The identity certification key stored in the authentication card is different for each home-visit company. That is to say, a home-visit company that is different from the home-visit company, which has the authentication card 10, has an authentication card 11 (not illustrated) which prestores an identity certification key that is different from the one stored in the authentication card 10.

It is stated above that the identity certification key stored in the authentication card is different for each home-visit company. However, the identity certification key stored in the authentication card may be different for each authentication card held by the visitors belonging to the same home-visit company. In this case, the identity certification keys, which are used to certify the authenticity of the authentication cards themselves and are uniquely assigned to the visitors, are securely managed by the home-visit company.

The user terminal 20 and the card reader 30 are apparatuses distributed by the home-visit company. The user terminal 20 prestores an identity authentication key for verifying the authenticity of the authentication card 10.

The user terminal 20 is provided in a residence of a user. More specifically, the user terminal 20 is a base unit of an intercommunication system. The card reader 30, to/from which the authentication card 10 is attachable and detachable, is provided outside the residence of the user (for example, at an entrance of the residence). More specifically, the card reader 30 is a sub-unit of the intercommunication system that has the function of a card reader/writer that performs input/output of information with the authentication card 10 attached thereto. The user terminal 20 and the card reader 30 are connected to each other via a cable 40. The user terminal 20 is provided with a receiver 290 and functions and operates as the base unit of the intercommunication system. The card reader 30 is provided with a call button 390, a microphone 391, and a speaker 392 and functions and operates as a sub-unit of the intercommunication system. For example, a visitor depresses the call button 390 of the card reader 30 to call the user inside the residence, and the user uses the receiver 290 to, over the intercommunication system, speak to the visitor, who uses the microphone 391 and the speaker 392 to speak with the user.

The operation outline of the identity authentication system 1 will be described using the authentication card 10, the user terminal 20, and the card reader 30.

The identity authentication system 1, upon insertion of the authentication card 10 into an insertion slot 394 of the card reader 30, performs an authentication by a challenge-response system, based on the identity certification key stored in the authentication card 10 and the identity authentication key stored in the user terminal 20, and displays the authentication result on a display unit 203 of the user terminal 20.

The user can keep the entrance door locked while the visitor inserts the authentication card 10 into the card reader 30. Also, the user can determine whether or not to unlock the door depending on the authentication result of the user terminal 20. That is to say, the user can open the door if the authentication result is affirmative, and can keep the door closed if the authentication result is negative.

The encryption process used here is an encryption process using a secret key. One example of the encryption process using a secret key is DES. The description of DES is omitted here since it is well known. It is needless to say however that the same key is used as the identity certification key and the identity authentication key.

Since the authentication card 11 (not illustrated) inserted in the card reader 30 of the identity authentication system 1 operates in a similar manner to the authentication card 10, the authentication card 10 is used in the following description.

1.2 Construction of Authentication Card 10

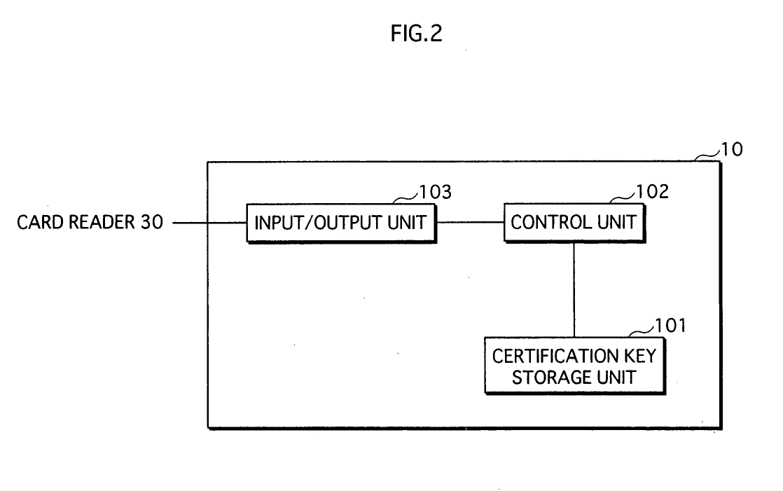

The construction of the authentication card 10 will be described. The authentication card 10 is a portable recording medium in which an IC is embedded. One specific example of the authentication card 10 is a memory card having an IC card function. As shown in FIG. 2, the authentication card 10 is composed of a certification key storage unit 101, a control unit 102, and an input/output unit 103.

The authentication card 10 is specifically a computer system that includes a microprocessor, ROM, RAM and the like. A computer program is stored in the ROM. The microprocessor operates in accordance with the computer program and causes the authentication card 10 to achieve the functions.

(1) Certification Key Storage Unit 101

The certification key storage unit 101 is tamper-resistant, and stores a pair of an identity certification key and a certification key ID that identifies the identity certification key.

In the following description, an identity certification key “SK1” is used as necessary.

(2) Control Unit 102

The control unit 102, upon receiving, from the card reader 30 via the input/output unit 103, ID request information that requests a certification key ID, acquires a certification key ID from the certification key storage unit 101, and outputs the acquired certification key ID to the card reader 30 via the input/output unit 103.

Further, upon receiving a random number “N” from the card reader 30, the control unit 102 acquires the identity certification key “SK1” from the certification key storage unit 101, and generates encrypted information Enc(SK1,N) by encrypting the random number “N”, which was received from the card reader 30, using the acquired identity certification key “SK1”. The control unit 102 outputs the generated encrypted information Enc(SK1,N) to the card reader 30 via the input/output unit 103. The “Enc(SK1,N)” indicates that the information is encrypted information that was generated by encrypting random number “N” using identity certification key “SK1”.

(3) Input/Output Unit 103

The input/output unit 103 receives information from the card reader 30 and outputs the information to the control unit 102. Also, the input/output unit 103 receives information from the control unit 102 and outputs the information to the card reader 30.

1.3 Construction of User Terminal 20

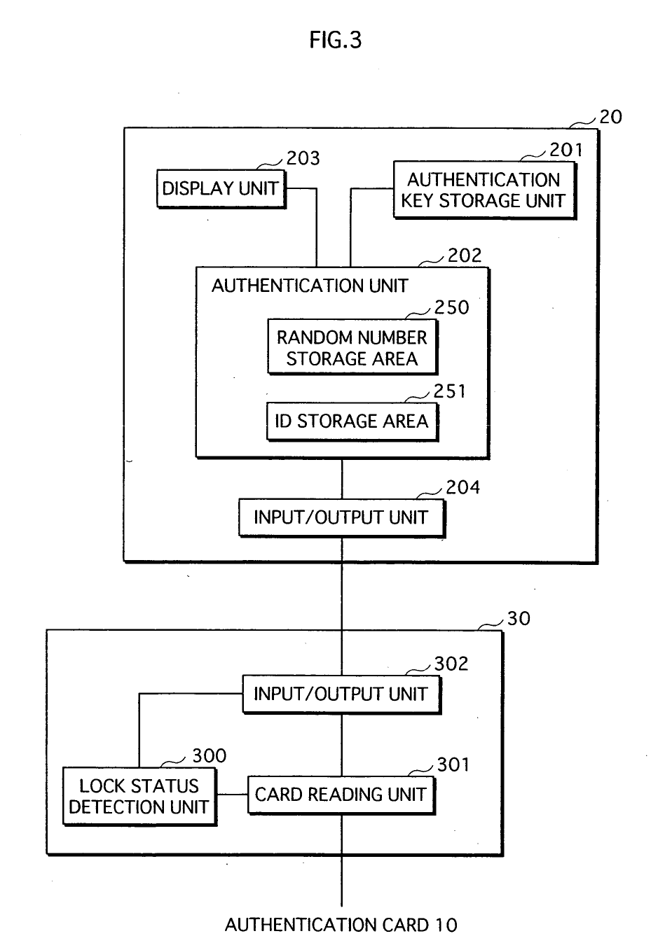

The construction of the user terminal 20 will be described. The user terminal 20 authenticates the authentication card 10 inserted in the card reader 30. As shown in FIG. 3, the user terminal 20 includes an authentication key storage unit 201, an authentication unit 202, a display unit 203, and an input/output unit 204.

The user terminal 20 is specifically a computer system that includes a microprocessor, ROM, RAM, a hard disk unit, a display unit and the like. A computer program is stored in the ROM or the hard disk unit. The microprocessor operates in accordance with the computer program and causes the user terminal 20 to achieve the functions.

It should be noted here that since the function of the user terminal 20 as the base unit of the intercommunication system is well known, the illustration of the construction and description of it as the base unit are omitted.

(1) Authentication Key Storage Unit 201

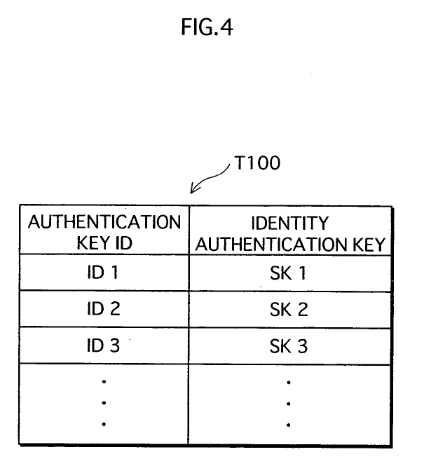

The authentication key storage unit 201 is tamper-resistant, and includes a key information table T100, on example of which is shown in FIG. 4.

The key information table T100 has an area for storing a plurality of pairs of an identity authentication key and an authentication key ID.

The identity authentication key is used to verify the authenticity of the authentication card inserted in the card reader 30, and as described earlier, is the same as the identity certification key.

The authentication key ID is an identifier for identifying an identity authentication key, and is the same as a corresponding certification key ID. This enables an identity authentication key to be correlated with an identity certification key.

The number of identity authentication keys stored in the key information table T100 is the same as the number of companies.

That is to say, the key information table T100 stores the same number of pairs of an identity authentication key and an authentication key ID as the number of pairs of an identity certification key and a certification key ID respectively stored in the authentication card 10, 11, . . . 12.

(2) Authentication Unit 202

The authentication unit 202 includes: a random number storage area 250 for storing random numbers; and an ID storage area 251 for storing certification key IDs received from the card reader 30 via the input/output unit 204.

The authentication unit 202 receives, from the card reader 30 via the input/output unit 204, a certification key ID and detection information that indicates detection of an insertion of the authentication card 10 into the card reader 30, and stores the received certification key ID in the ID storage area 251. Then, the authentication unit 202 generates a random number “N”, outputs the generated random number “N” to the card reader 30 via the input/output unit 204, and stores the generated random number “N” in the random number storage area 250.

Further, the authentication unit 202 receives the encrypted information Enc(SK1,N) from the card reader 30 via the input/output unit 204. The authentication unit 202 then acquires, from the key information table T100, an identity authentication key that corresponds to an authentication key ID that matches the certification key ID stored in the ID storage area 251. The authentication unit 202 decrypts the encrypted information Enc(SK1,N) using the acquired identity authentication key, and judges whether or not the decrypting result matches the random number “N” stored in the random number storage area 250.

If the decrypting result matches the random number “N”, the authentication unit 202 verifies the authenticity of the authentication card inserted in the card reader 30, that is to say, determines that the authentication card inserted in the card reader 30 is authentic. And as the authentication result, the authentication unit 202 generates authentic visitor information that indicates that the visitor is an authentic visitor, and outputs the generated authentic visitor information to the display unit 203. If the decrypting result does not match the random number “N”, the authentication unit 202 determines that the authentication card inserted in the card reader 30 is unauthentic, and as the authentication result, generates unauthentic visitor information that indicates that the visitor is an unauthentic visitor, and outputs the generated unauthentic visitor information to the display unit 203. Further, the authentication unit 202 deletes the random number “N” from the random number storage area 250, and deletes the certification key ID from the ID storage area 251.

Also, upon receiving, from the card reader 30, a door lock message that urges the user to lock the entrance door, the authentication unit 202 outputs the received door lock message to the display unit 203.

(3) Display Unit 203

The display unit 203 is provided with, for example, a display, and displays information of the authentication result received from the authentication unit 202, toward outside.

The display unit 203 also displays the door lock message received from the authentication unit 202 toward outside.

(4) Input/Output Unit 204

The input/output unit 204 receives information from the card reader 30 and outputs the information to the authentication unit 202. Also, the input/output unit 204 receives information from the authentication unit 202 and outputs the information to the card reader 30.

1.4 Card Reader 30

The card reader 30, as shown in FIG. 3, includes a card reading unit 301, an input/output unit 302, and a lock status detection unit 300.

The card reader 30 is specifically a computer system that includes a microprocessor, ROM, RAM and the like. A computer program is stored in the ROM. The microprocessor operates in accordance with the computer program and causes the card reader 30 to achieve the functions.

It should be noted here that since the function of the card reader 30 as the sub-unit of the intercommunication system is well known, the illustration of the construction and description of it as the sub-unit are omitted.

(1) Card Reading Unit 301

The card reading unit 301 detects an insertion of the authentication card 10. Upon detecting the insertion of the authentication card 10, the card reading unit 301 outputs a lock status detection instruction, which instructs to detect the lock status of the entrance door, to the lock status detection unit 300.

Upon receiving, from the lock status detection unit 300, the lock detection information that indicates that it was detected that the entrance door is locked, the card reading unit 301 generates the detection information and the ID request information, and outputs the generated ID request information to the authentication card 10. After this, when it receives from the authentication card 10 a certification key ID, the card reading unit 301 outputs the received certification key ID and the generated detection information to the user terminal 20 via the input/output unit 302.

Further, upon receiving the random number “N” from the user terminal 20 via the input/output unit 302, the card reading unit 301 outputs the received random number “N” to the authentication card 10. Upon receiving the encrypted information Enc(SK1,N) from the authentication card 10, the card reading unit 301 outputs the received encrypted information Enc(SK1, N) to the user terminal 20 via the input/output unit 302.

(2) Lock Status Detection Unit 300

The lock status detection unit 300 is connected to a key mechanism of locking the entrance door, and detects the lock status of the entrance door.

Upon receiving the lock status detection instruction from the card reading unit 301, the lock status detection unit 300 judges whether the entrance door is locked or unlocked.

If it judges that the entrance door is locked, that is to say, if it detects a locked status in which the entrance door is locked, the lock status detection unit 300 outputs the lock detection information to the card reading unit 301.

If it judges that the entrance door is unlocked, that is to say, if it does not detect the locked status, the lock status detection unit 300 outputs the door lock message that urges the user to lock the entrance door, to the user terminal 20 via the input/output unit 302. The lock status detection unit 300 continues to output the door lock message to the user terminal 20 until it detects the locked status in which the entrance door is locked.

(3) Input/Output Unit 302

The input/output unit 302 receives information from the user terminal 20 and outputs the information to the card reading unit 301. Also, the input/output unit 302 receives information from the card reading unit 301 and outputs the information to the user terminal 20.

The input/output unit 302 receives the door lock message from the lock status detection unit 300 and outputs the received message to the user terminal 20.

1.5 Operation of Identity Authentication Process

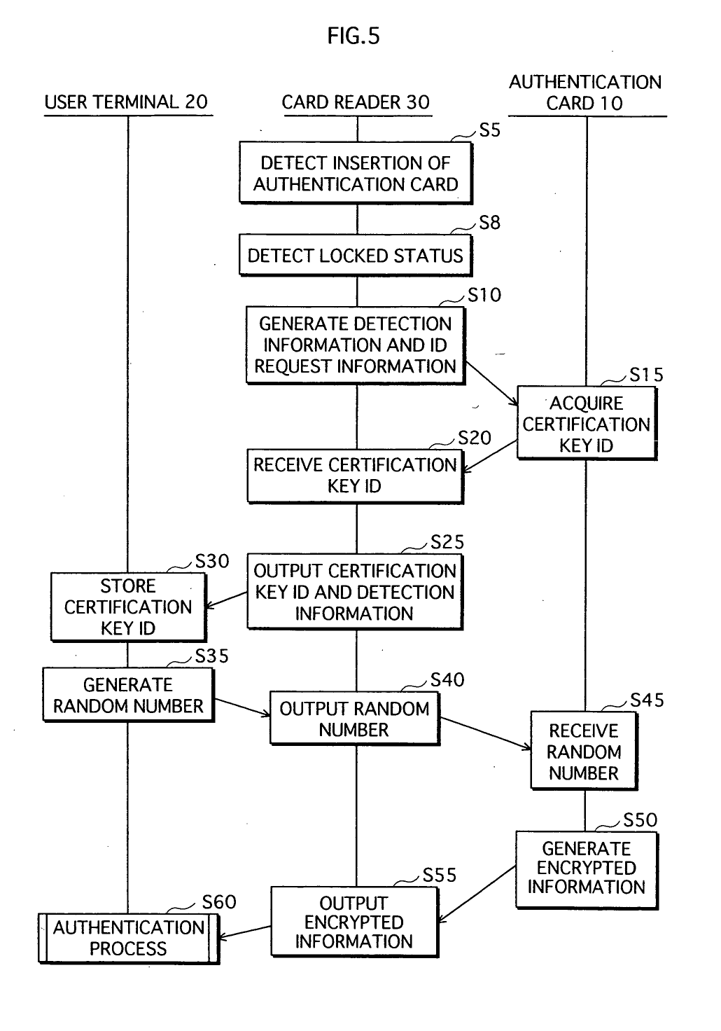

The identity authentication process is a process in which after the authentication card 10 is inserted into the card reader 30, the user terminal 20 authenticates the identity. The identity authentication process will be described with reference to the flowchart shown in FIG. 5.

When the card reader 30 detects an insertion of the authentication card 10 (step S5), the card reader 30 detects the locked status in which the entrance door is locked (step S8).

If it does not detect the locked status, the card reader 30 enters the wait status and continues to wait until it detects the locked status. When this happens, the user terminal 20 continues to display the door lock message until the entrance door is locked, as described earlier.

If, in step S8, it detects the locked status in which the entrance door is locked, the card reader 30 generates the detection information and the ID request information, and outputs the generated ID request information to the authentication card 10 (step S10).

Upon receiving the ID request information, the authentication card 10 acquires a certification key ID from the certification key storage unit 101, and outputs the acquired certification key ID to the card reader 30 (step S15).

Upon receiving the certification key ID from the authentication card 10 (step S20), the card reader 30 outputs the received certification key ID and the detection information generated in step S10 to the user terminal 20 (step S25).

Upon receiving the certification key ID and the detection information from the card reader 30, the user terminal 20 stores the received certification key ID in the ID storage area 251 (step S30) The user terminal 20 then generates the random number “N”, outputs the generated random number “N” to the card reader 30, and stores the generated random number “N” in the random number storage area 250 (step S35).

Upon receiving the random number “N” from the user terminal 20, the card reader 30 outputs the received random number “N” to the authentication card 10 (step S40).

Upon receiving the random number “N” from the card reader 30(step S45), the authentication card 10 generates encrypted information by encrypting the received random number “N” using the identity certification key stored in the certification key storage unit 101, and outputs the generated encrypted information to the card reader 30 (step S50).

Upon receiving the encrypted information from the authentication card 10, the card reader 30 outputs the received encrypted information to the user terminal 20 (step S55).

Upon receiving the encrypted information from the card reader 30, the user terminal 20 performs an authentication process using the received encrypted information and the identity authentication key stored in the authentication key storage unit 201 (step S60).

1.6 Authentication Process

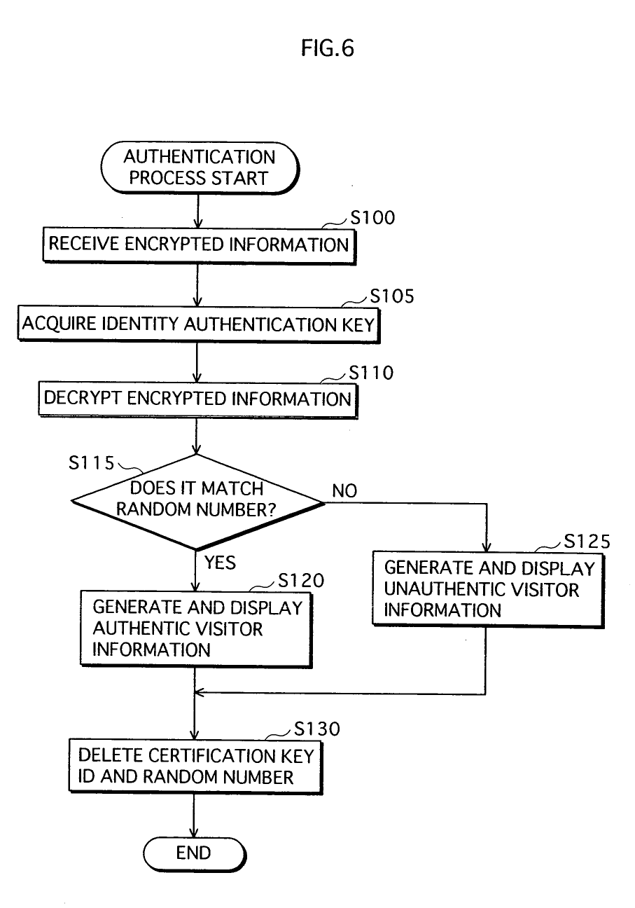

Here, the authentication process that is executed in step S60 of the identity authentication process will be described with reference to the flowchart shown in FIG. 6.

The user terminal 20 receives the encrypted information from the authentication card 10 via the card reader 30 (step S100). The user terminal 20 then acquires, from the key information table T100, an identity authentication key that corresponds to an authentication key ID that matches the certification key ID stored in the ID storage area 251 in step S30 of the identity authentication process (step S105). The user terminal 20 then decrypts the encrypted information received in step S100 using the acquired identity authentication key (step S110).

The user terminal 20 then judges whether or not the decrypting result matches the random number “N” stored in the random number storage area 250 in step S35 of the identity authentication process (step S115).

If it judges that the decrypting result matches the random number “N” (YES in step S115), the user terminal 20 generates authentic visitor information and displays the generated authentic visitor information (step S120), deletes the random number “N” from the random number storage area 250 and deletes the certification key ID from the ID storage area 251 (step S130), and ends the process.

If it judges that the decrypting result does not match the random number “N” (NO instep S115), the user terminal 20 generates unauthentic visitor information and displays the generated unauthentic visitor information (step S125), deletes the random number “N” from the random number storage area 250 and deletes the certification key ID from the ID storage area 251 (step S130), and ends the process.

### 2. Embodiment 2

The following describes an identity authentication system 1A in Embodiment 2 of the present invention.

In the identity authentication system 1, the identity authentication key is stored in the authentication key storage unit 201 of the user terminal 20 in advance. In the identity authentication system 1A, after the user terminal is distributed to the user, the identity authentication key is distributed from the home-visit company.

2.1 Outline of Identity Authentication System 1A

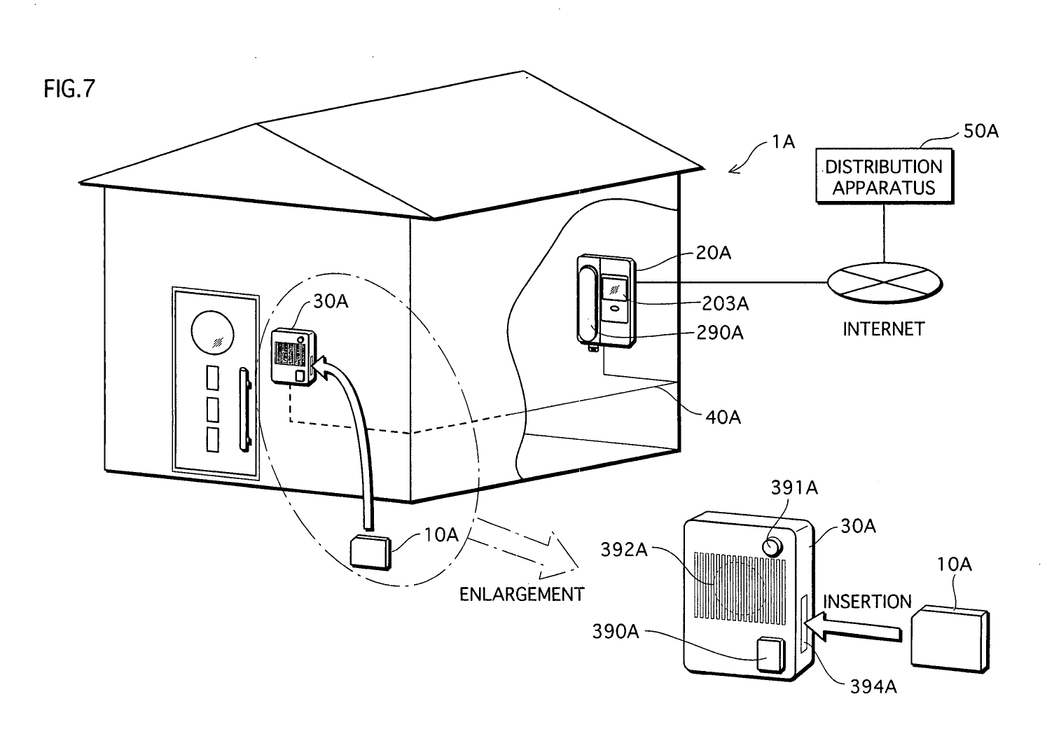

The identity authentication system 1A, as shown in FIG. 7, is composed of an authentication card 10A, a user terminal 20A, a card reader 30A, and a distribution apparatus 50A. The user terminal 20A and the card reader 30A are connected to each other via a cable 40A.

The user terminal 20A is provided in a residence of a user. More specifically, the user terminal 20A is a base unit of an intercommunication system. The card reader 30A, to/from which the authentication card 10A is attachable and detachable, is provided outside the residence of the user (for example, at an entrance of the residence). More specifically, the card reader 30A is a sub-unit of the intercommunication system that has the function of a card reader/writer that performs input/output of information with the authentication card 10A attached thereto. The user terminal 20A is provided with a receiver 290A and functions and operates as the base unit of the intercommunication system. The card reader 30A is provided with a call button 390A, a microphone 391A, and a speaker 392A and functions and operates as a sub-unit of the intercommunication system. For example, a visitor depresses the call button 390A of the card reader 30A to call the user inside the residence, and the user uses the receiver 290A to, over the intercommunication system, speak to the visitor, who uses the microphone 391A and the speaker 392A to speak with the user.

The authentication card 10A is assigned to a visitor who visits the residence of the user from the home-visit company, and prestores an identity certification key. The identity certification key stored in the authentication card is different for each visitor. That is to say, a visitor who is different from the visitor holding the authentication card 10A holds an authentication card 11A (not illustrated) which prestores an identity certification key that is different from the one stored in the authentication card 10A. This enables a visitor, who visits the residence of the user, to be correlated with an identity certification key.

Although not shown in FIG. 7, user terminals 21A, . . . 22A, each of which has the same construction as the user terminal 20A, are connected to the distribution apparatus 50A via the Internet. Also, the user terminals 21A, . . . 22A are respectively connected to card readers 31A, . . . 32A each of which has the same construction as the card reader 30A.

Now, the outline of the identity authentication system 1A will be described using the authentication card 10A, the user terminal 20A, and the card reader 30A. The description of the user terminals 21A, . . . 22A and the card readers 31A, . . . 32A is omitted since they are the same as the user terminal 20A and the card reader 30A, respectively.

In the identity authentication system 1A, before a visitor visits the residence of the user, an identity authentication key corresponding to the visitor is transmitted to the user terminal 20A via the Internet. Upon insertion of the authentication card 10A into an insertion slot 394A of the card reader 30A, the user terminal 20A performs an authentication by a challenge-response system, based on the identity certification key stored in the authentication card 10A and the identity authentication key, which is received from the distribution apparatus 50A in advance and is stored therein, and displays the authentication result on a display unit 203A.

The user can keep the entrance door locked while the visitor inserts the authentication card 10A into the card reader 30A. Also, the user can determine whether or not to unlock the door depending on the authentication result of the user terminal 20A. That is to say, the user can open the door if the authentication result is affirmative, and can keep the door closed if the authentication result is negative.

The encryption process used here is, as is the case with the identity authentication system 1, an encryption process using secret key. Also, as is the case with the identity authentication system 1, it is needless to say that the same key is used as the identity certification key and the identity authentication key.

Since the authentication card 11A (not illustrated) inserted in the card reader 30A of the identity authentication system 1A operates in a similar manner to the authentication card 10A, the authentication card 10A is used in the following description.

2.2 Distribution Apparatus 50A

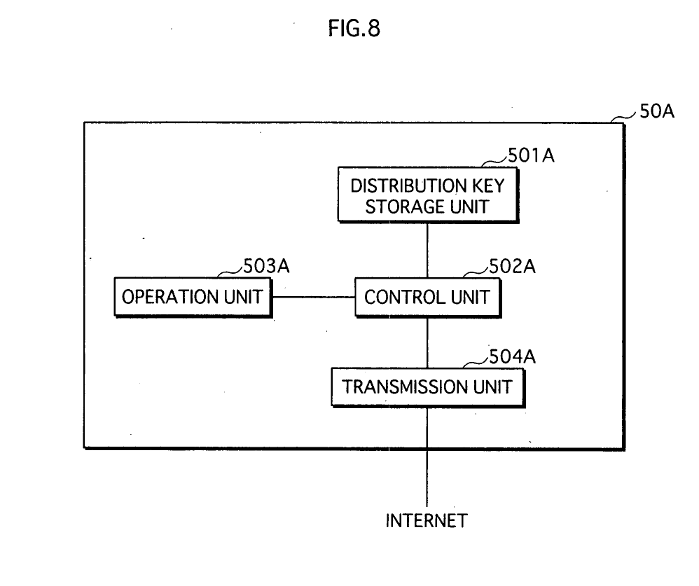

The distribution apparatus 50A is an apparatus that, before a visitor visits the residence of the user, transmits an identity authentication key corresponding to the visitor to the user terminal 20A. As shown in FIG. 8, the distribution apparatus 50A includes a distribution key storage unit 501A, a control unit 502A, an operation unit 503A, and a transmission unit 504A.

The distribution apparatus 50A is specifically a computer system that includes a microprocessor, ROM, RAM, a hard disk unit, a display unit, a keyboard, a modem and the like. A computer program is stored in the ROM or the hard disk unit. The microprocessor operates in accordance with the computer program and causes the distribution apparatus 50A to achieve the functions.

(1) Distribution Key Storage Unit 501A

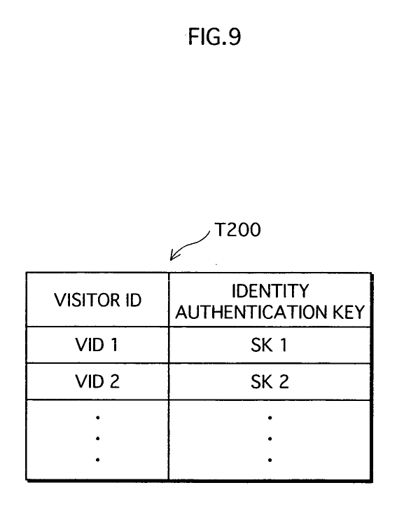

The distribution key storage unit 501A includes a distribution key information table T200, on example of which is shown in FIG. 9.

The distribution key information table T200 has an area for storing a plurality of pairs of a visitor ID and an identity authentication key.

The visitor ID is an identifier for identifying the visitor. The identity authentication key is the same as the identity certification key, and is correlated with the visitor ID.

The number of identity authentication keys stored in the distribution key information table T200 is the same as the number of visitors, namely, as the number of authentication cards.

Also, it is possible to assign a visitor with an authentication card that stores an identity authentication key that corresponds to a visitor ID the visitor, by correlating the identity authentication keys with the visitor IDs.

(2) Control Unit 502A

When the control unit 502A receives information indicating a registration of an identity authentication key, a visitor ID, and an identity authentication key from the operation unit 503A, the control unit 502A writes the received visitor ID and the received identity authentication key onto the distribution key storage unit 501A by correlating them with each other.

Upon receiving, from the operation unit 503A, distribution information that is composed of a visitor ID and information indicating a distribution of an identity authentication key to the user terminal 20A, the control unit 502A acquires an identity authentication key that corresponds to the visitor ID contained in the received distribution information, from the distribution key information table T200. The control unit 502A transmits the acquired identity authentication key to the user terminal 20A via the transmission unit 504A.

(3) Operation Unit 503A

When the operation unit 503A receives information indicating a registration of an identity authentication key, a visitor ID, and an identity authentication key, through an operation of an operator of the distribution apparatus 50A, the operation unit 503A transmits the information indicating a registration of an identity authentication key, the visitor ID, and the identity authentication key to the control unit 502A.

Also, upon receiving the distribution information through an operation of the operator, the operation unit 503A outputs the received distribution information to the control unit 502A.

It should be noted here that the operator is not limited to the visitor himself/herself who visits the residence of the user, but may be any person who belongs to the home-visit company.

(4) Transmission Unit 504A

The transmission unit 504A receives information from the control unit 502A, and outputs the received information to the user terminal 20A via the Internet.

2.3 Authentication Card 10A

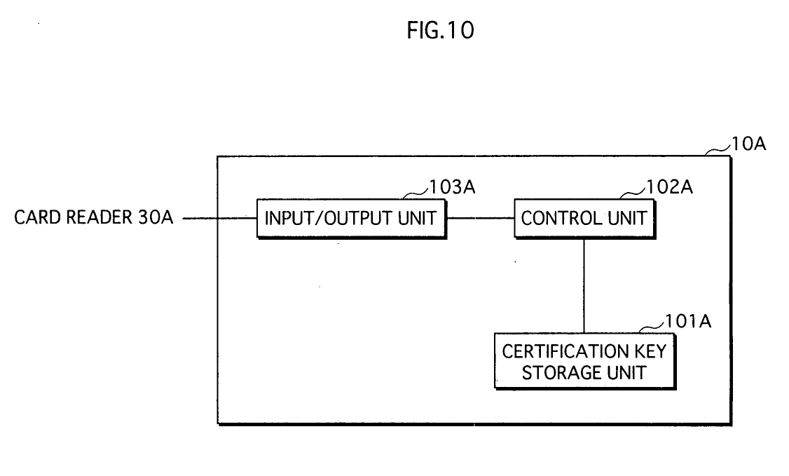

The construction of the authentication card 10A will be described. The authentication card 10A is a portable recording medium in which an IC is embedded. One specific example of the authentication card 10A is a memory card having an IC card function. As shown in FIG. 10, the authentication card 10A is composed of a certification key storage unit 101A, a control unit 102A, and an input/output unit 103A.

The authentication card 10A is specifically a computer system that includes a microprocessor, ROM, RAM and the like. A computer program is stored in the ROM. The microprocessor operates in accordance with the computer program and causes the authentication card 10A to achieve the functions.

(1) Certification Key Storage Unit 101A

The certification key storage unit 101A is tamper-resistant, and stores an identity certification key that corresponds to a visitor.

In the following description, an identity certification key “SK1” is used as necessary.

(2) Control Unit 102A

The control unit 102A, upon receiving a random number “N” from the card reader 30A, acquires the identity certification key “SK1” from the certification key storage unit 101A, and generates encrypted information Enc(SK1,N) by encrypting the random number “N”, which was received from the card reader 30A, using the acquired identity certification key “SK1”. The control unit 102A outputs the generated encrypted information Enc(SK1,N) to the card reader 30A via the input/output unit 103A.

(3) Input/Output Unit 103A

The description of the input/output unit 103A is omitted since it is the same as the input/output unit 103.

2.4 Construction of User Terminal 20A

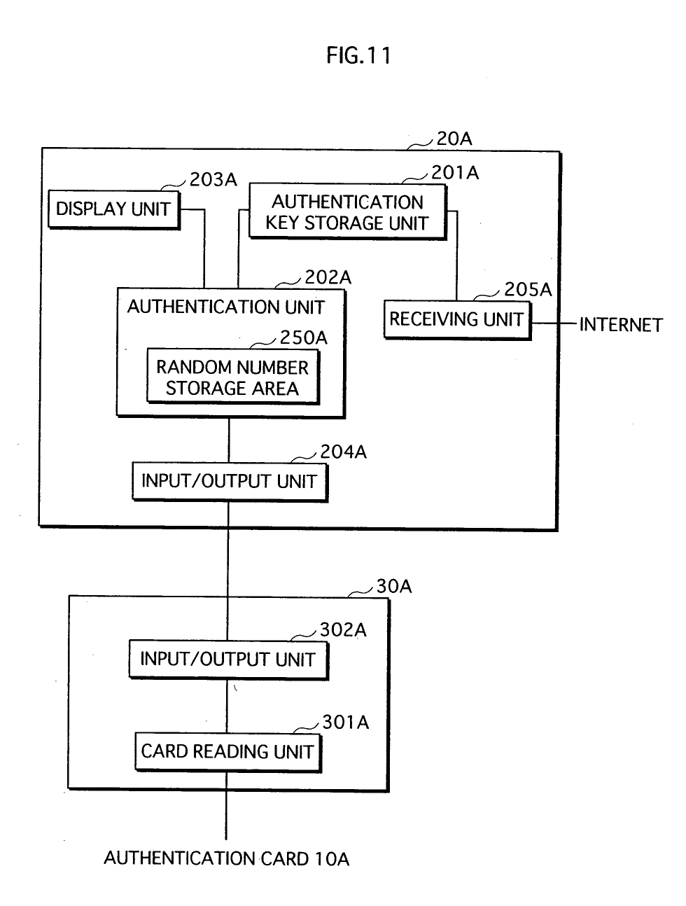

The construction of the user terminal 20A will be described. As shown in FIG. 11, the user terminal 20A includes an authentication key storage unit 201A, an authentication unit 202A, a display unit 203A, an input/output unit 204A, and a receiving unit 205A.

The user terminal 20A is specifically a computer system that includes a microprocessor, ROM, RAM, a hard disk unit, a display unit and the like. A computer program is stored in the ROM or the hard disk unit. The microprocessor operates in accordance with the computer program and causes the user terminal 20A to achieve the functions.

The description of the user terminals 21A, . . . 22A is omitted since they have the same construction as the user terminal 20A as described earlier in the description of the outline of the identity authentication system 1A.

Also, since the function of the user terminal 20A as the base unit of the intercommunication system is well known, the illustration of the construction and description of it as the base unit are omitted.

(1) Authentication Key Storage Unit 201A

The authentication key storage unit 201A is tamper-resistant, and includes an area for storing an identity authentication key that is received from the distribution apparatus 50A via the Internet.

(2) Receiving Unit 205A

When the receiving unit 205A receives an identity authentication key from the distribution apparatus 50A via the Internet, the receiving unit 205A writes the received identity authentication key into the authentication key storage unit 201A.

This enables the user terminal 20A to store, in advance, an identity authentication key that corresponds to a visitor.

(3) Authentication Unit 202A

The authentication unit 202A includes a random number storage area 250A for storing random numbers.

Upon receiving, from the card reader 30A via the input/output unit 204A, detection information that indicates detection of an insertion of the authentication card 10A into the card reader 30A, the authentication unit 202A generates a random number “N”, outputs the generated random number “N” to the card reader 30A via the input/output unit 204A, and stores the generated random number “N” in the random number storage area 250A.

Further, the authentication unit 202A receives the encrypted information Enc(SK1,N) from the card reader 30A via the input/output unit 204A. The authentication unit 202A then acquires, from the authentication key storage unit 201A, an identity authentication key that has been stored in the authentication key storage unit 201A in advance, and decrypts the encrypted information Enc(SK1,N) using the acquired identity authentication key, and judges whether or not the decrypting result matches the random number “N” stored in the random number storage area 250A.

If the decrypting result matches the random number “N”, the authentication unit 202A verifies the authenticity of the authentication card inserted in the card reader 30A, that is to say, determines that the authentication card inserted in the card reader 30A is authentic. And as the authentication result, the authentication unit 202A generates authentic visitor information that indicates that the visitor is an authentic visitor, and outputs the generated authentic visitor information to the display unit 203A. If the decrypting result does not match the random number “N”, the authentication unit 202A determines that the authentication card inserted in the card reader 30A is unauthentic, and as the authentication result, generates unauthentic visitor information that indicates that the visitor is an unauthentic visitor, and outputs the generated unauthentic visitor information to the display unit 203A. Further, the authentication unit 202A deletes the identity authentication key from the authentication key storage unit 201A, and deletes the random number “N” from the random number storage area 250A.

(4) Display Unit 203A

The description of the display unit 203A is omitted since it is the same as the display unit 203.

(5) Input/Output Unit 204A

The description of the input/output unit 204A is omitted since it is the same as the input/output unit 204.

2.5 Card Reader 30A

The card reader 30A, as shown in FIG. 11, includes a card reading unit 301A and an input/output unit 302A.

The card reader 30A is specifically a computer system that includes a microprocessor, ROM, RAM and the like. A computer program is stored in the ROM. The microprocessor operates in accordance with the computer program and causes the card reader 30A to achieve the functions.

The description of the card readers 31A, . . . 32A is omitted since they have the same construction as the card reader 30A as described earlier in the description of the outline of the identity authentication system 1A.

Also, since the function of the card reader 30A as the sub-unit of the intercommunication system is well known, the illustration of the construction and description of it as the sub-unit are omitted.

(1) Card Reading Unit 301A

The card reading unit 301A detects an insertion of the authentication card 10A. Upon detecting the insertion of the authentication card 10A, the card reading unit 301A generates the detection information and outputs the generated detection information to the user terminal 20A via the input/output unit 302A.

Further, upon receiving the random number “N” from the user terminal 20A via the input/output unit 302A, the card reading unit 301A outputs the received random number “N” to the authentication card 10A. Upon receiving the encrypted information Enc(SK1,N) from the authentication card 10A, the card reading unit 301A outputs the received encrypted information Enc(SK1,N) to the user terminal 20A via the input/output unit 302A.

(2) Input/Output Unit 302A

The description of the input/output unit 302A is omitted since it is the same as the input/output unit 302.

2.6 Operation of Distribution Process

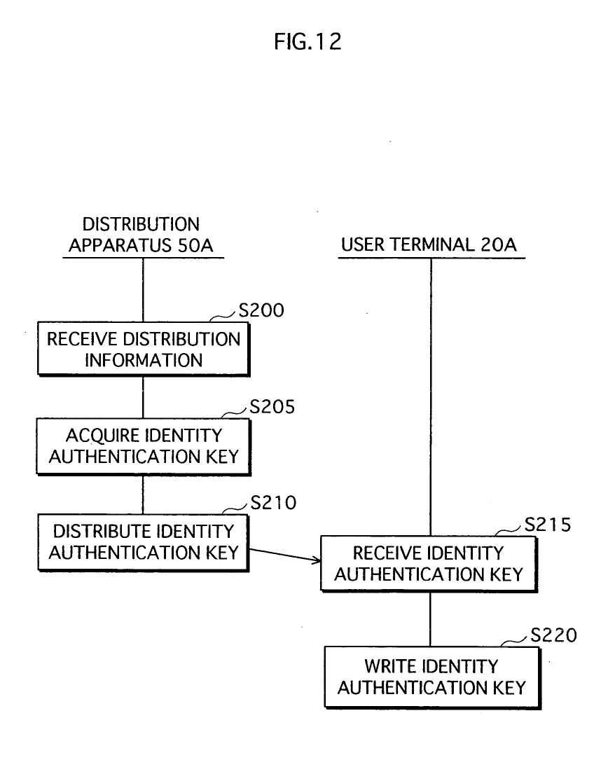

The distribution process in which the identity authentication key is distributed beforehand will be described with reference to the flowchart shown in FIG. 12.

The distribution apparatus 50A receives the distribution information in response to a user operation (step S200). The distribution apparatus 50A then acquires an identity authentication key from the distribution key storage unit 501A (step S205), and distributes the acquired identity authentication key to the user terminal 20A via the Internet (step S210).

Upon receiving the identity authentication key (step S215), the user terminal 20A writes the received identity authentication key into the authentication key storage unit 201A (step S220).

2.7 Operation of Identity Authentication Process

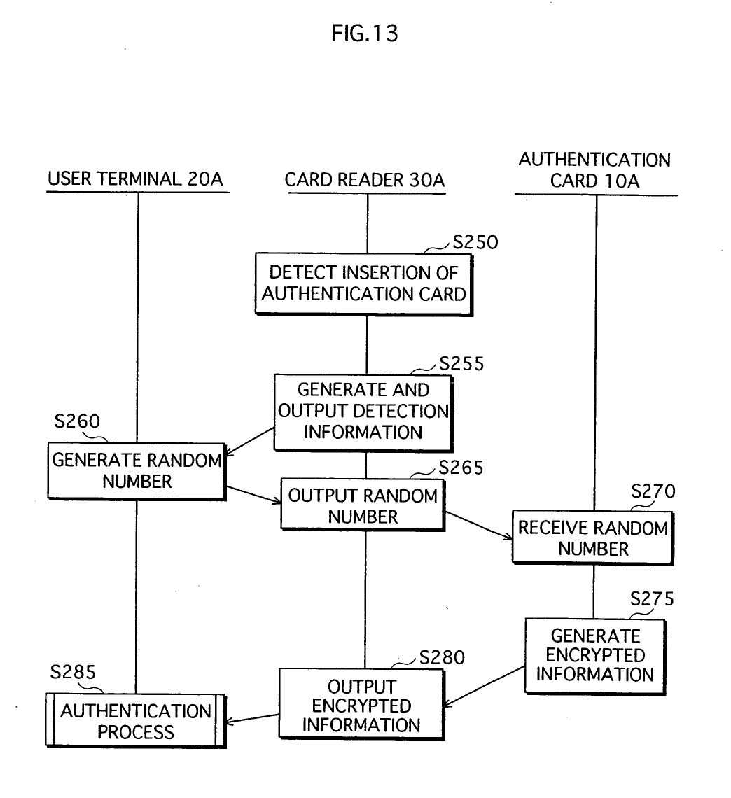

The identity authentication process is a process in which after the authentication card 10A is inserted into the card reader 30A, the user terminal 20A authenticates the identity. The identity authentication process will be described with reference to the flowchart shown in FIG. 13.

When the card reader 30A detects an insertion of the authentication card 10A (step S250), the card reader 30A generates the detection information and outputs the generated detection information to the user terminal 20A (step S255).

Upon receiving the detection information from the card reader 30A, the user terminal 20A generates the random number “N”, outputs the generated random number “N” to the card reader 30A, and stores the generated random number “N” into the random number storage area 250A (step S260).

Upon receiving the random number “N” from the user terminal 20A, the card reader 30A outputs the received random number “N” to the authentication card 10A (step S265).

Upon receiving the random number “N” from the card reader 30A (step S270), the authentication card 10A generates encrypted information by encrypting the received random number “N” using the identity certification key stored in the certification key storage unit 101A, and outputs the generated encrypted information to the card reader 30A (step S275).

Upon receiving the encrypted information from the authentication card 10A, the card reader 30A outputs the received encrypted information to the user terminal 20A (step S280).

Upon receiving the encrypted information from the card reader 30A, the user terminal 20A performs an authentication process using the received encrypted information and the identity authentication key stored in the authentication key storage unit 201A (step S285).

2.8 Authentication Process

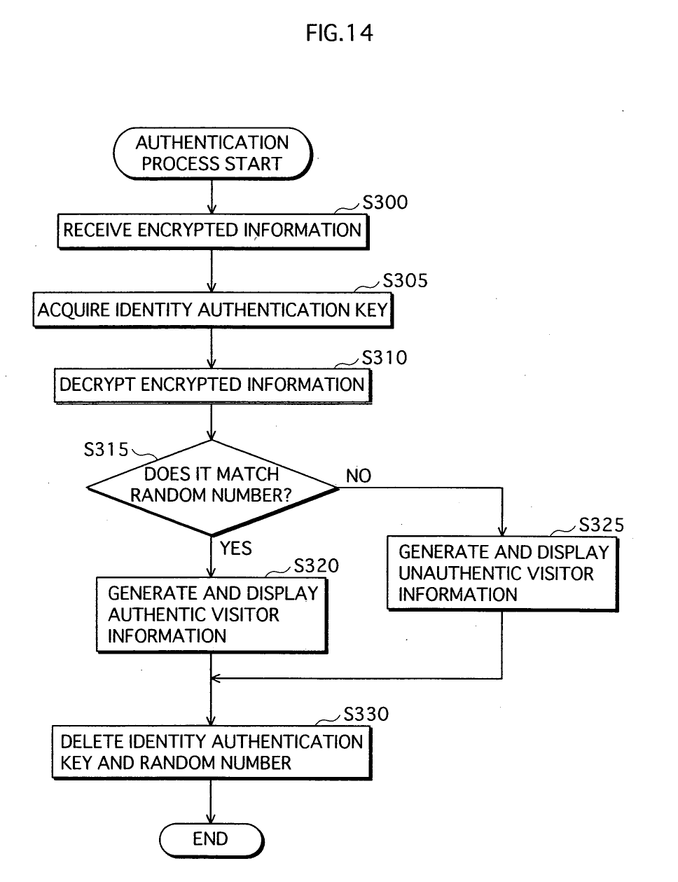

Here, the authentication process that is executed in step S285 of the identity authentication process will be described with reference to the flowchart shown in FIG. 14.

The user terminal 20A receives the encrypted information from the authentication card 10A via the card reader 30A (step S300). The user terminal 20A then acquires, from the authentication key storage unit 201A, an identity authentication key that has been distributed from the distribution apparatus 50A in advance (step S305), and decrypts the encrypted information received in step S300 using the acquired identity authentication key (step S310).

The user terminal 20A then judges whether or not the decrypting result matches the random number “N” that was stored in the random number storage area 250A in step S260 of the identity authentication process (step S315).

If it judges that the decrypting result matches the random number “N” (YES in step S315), the user terminal 20A generates authentic visitor information and displays the generated authentic visitor information (step S320), deletes the identity authentication key from the authentication key storage unit 201A, and deletes the random number “N” from the random number storage area 250A (step S330), and ends the process.

If it judges that the decrypting result does not match the random number “N” (NO in step S315), the user terminal 20A generates unauthentic visitor information and displays the generated unauthentic visitor information (step S325), deletes the identity authentication key from the authentication key storage unit 201A, and deletes the random number “N” from the random number storage area 250A (step S330), and ends the process.

### 3. Embodiment 3

The following describes an identity authentication system 1B in Embodiment 3 of the present invention.

In the identity authentication system 1B, when a visitor visits the residence of the user, the biometrics information, which shows biometric characteristics of the visitor, is used as the identity authentication key to determine whether or not the authentication card is authentic.

3.1 Outline of Identity Authentication System 1B

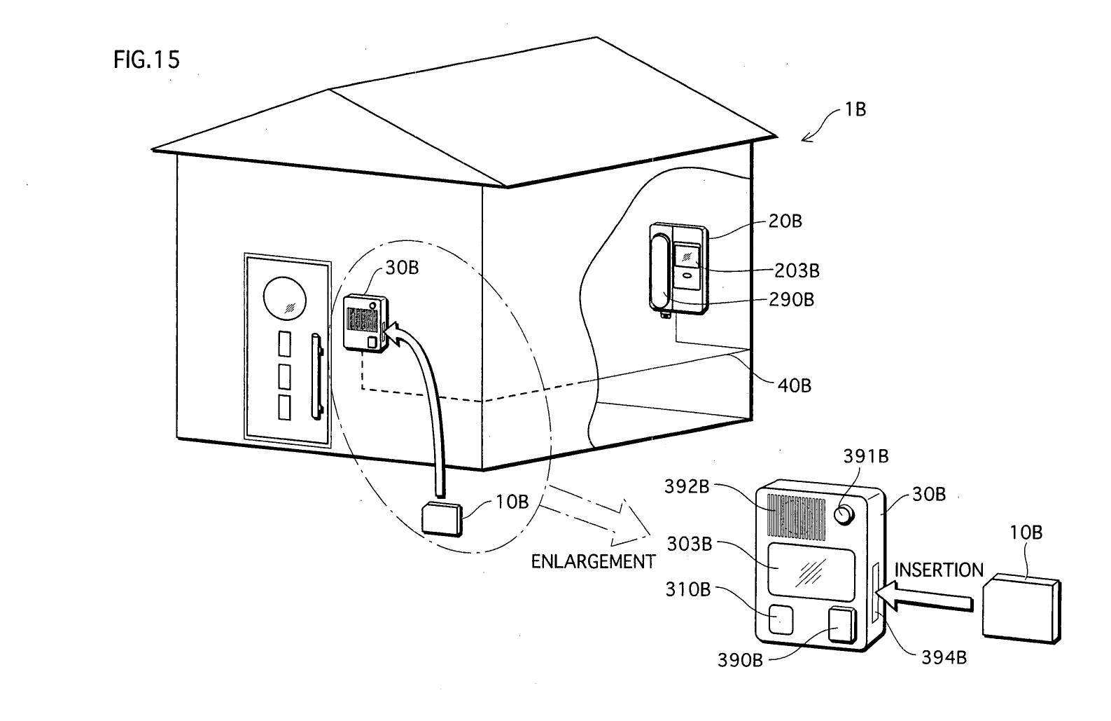

The identity authentication system 1B, as shown in FIG. 15, is composed of an authentication card 10B, a user terminal 20B, and a card reader 30B. The user terminal 20B and the card reader 30B are connected to each other via a cable 40B.

The user terminal 20B is provided in a residence of a user. More specifically, the user terminal 20B is a base unit of an intercommunication system. The card reader 30B, to/from which the authentication card 10B is attachable and detachable, is provided outside the residence of the user (for example, at an entrance of the residence). More specifically, the card reader 30B is a sub-unit of the intercommunication system that has the function of a card reader/writer that performs input/output of information with the authentication card 10B attached thereto. The user terminal 20B is provided with a receiver 290B and functions and operates as the base unit of the intercommunication system. The card reader 30B is provided with a call button 390B, a microphone 391B, and a speaker 392B and functions and operates as a sub-unit of the intercommunication system. For example, a visitor depresses the call button 390B of the card reader 30B to call the user inside the residence, and the user uses the receiver 290B to, over the intercommunication system, speak to the visitor, who uses the microphone 391B and the speaker 392B to speak with the user.

The authentication card 10B is assigned to a visitor who visits the residence of the user from the home-visit company, and prestores, as an identity certification key, biometrics information of the visitor to whom the authentication card 10B is assigned. It is presumed here that the biometrics information is identity certification fingerprint information that is composed of characteristic points of the fingerprint pattern of the visitor. The identity certification key stored in the authentication card is different for each visitor. That is to say, a visitor who is different from the visitor holding the authentication card 10B holds an authentication card 11B (not illustrated) which prestores an identity certification key that is different from the one stored in the authentication card 10B.

The card reader 30B is provided with a fingerprint reading unit 310B that receives a fingerprint that is input by the visitor.

Now, the outline of the identity authentication system 1B will be described using the authentication card 10B, the user terminal 20B, and the card reader 30B.

Upon insertion of the authentication card 10B into an insertion slot 394B of the card reader 30B, the user terminal 20B requests the visitor to input a fingerprint. Upon receiving an input fingerprint through the fingerprint reading unit 310B of the card reader 30B, the identity authentication system 1B generates, from the received fingerprint, identity authentication fingerprint information that is composed of characteristic points of the fingerprint pattern of the received fingerprint. The identity authentication system 1B then performs an authentication by a challenge-response system, based on the generated identity authentication fingerprint information and the identity certification key stored in the authentication card 10B, and displays the authentication result on a display unit 203B of the user terminal 20B.

The user can keep the entrance door locked while the visitor inserts the authentication card 10B into the card reader 30B. Also, the user can determine whether or not to unlock the door depending on the authentication result of the user terminal 20B. That is to say, the user can open the door if the authentication result is affirmative, and can keep the door closed if the authentication result is negative.

The encryption process used here is, as is the case with the identity authentication system 1, an encryption process using a secret key. Also, as is the case with the identity authentication system 1, it is needless to say that the same key is used as the identity certification key and the identity authentication fingerprint information.

Since the authentication card 11B (not illustrated) inserted in the card reader 30B of the identity authentication system 1B operates in a similar manner to the authentication card 10B, the authentication card 10B is used in the following description.

It is required that each time an authentic visitor inserts the authentication card 10B, the identity certification key stored in the authentication card 10B completely match the identity authentication fingerprint information generated by the card reader 30B. A method for always converting a fingerprint into a piece of unique fingerprint information has been disclosed. The description of the technology is omitted here since it is a well known technology. For details of such a conversion method, refer to Yoichi SHIBATA and others, “Mechanism PKI” (Computer Security Symposium 2003, pp181-186, 2003).

3.2 Authentication Card 10B

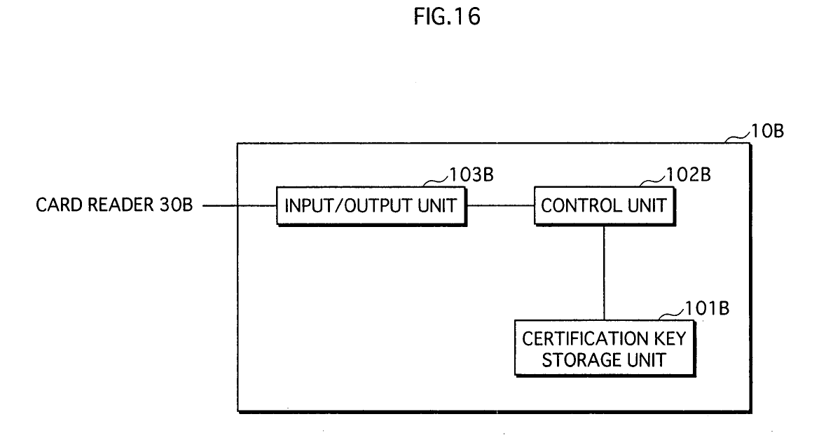

The construction of the authentication card 10B will be described. The authentication card 10B is a portable recording medium in which an IC is embedded. One specific example of the authentication card 10B is a memory card having an IC card function. As shown in FIG. 16, the authentication card 10B is composed of a certification key storage unit 101B, a control unit 102B, and an input/output unit 103B.

The authentication card 10B is specifically a computer system that includes a microprocessor, ROM, RAM and the like. A computer program is stored in the ROM. The microprocessor operates in accordance with the computer program and causes the authentication card 10B to achieve the functions.

(1) Certification Key Storage Unit 101B

The certification key storage unit 101B is tamper-resistant, and stores, as an identity certification key, a piece of identity certification fingerprint information that corresponds to a visitor.

In the following description, an identity certification key “SK1” is used as necessary.

(2) Control Unit 102B

The description of the control unit 102B is omitted since it is the same as the control unit 102A of the authentication card 10A described in Embodiment 2.

(3) Input/Output Unit 103B

The description of the input/output unit 103B is omitted since it is the same as the input/output unit 103A of the authentication card 10A described in Embodiment 2. That is to say, the input/output unit 103B is also the same as the input/output unit 103 of the authentication card 10 described in Embodiment 1.

3.3 Construction of User Terminal 20B

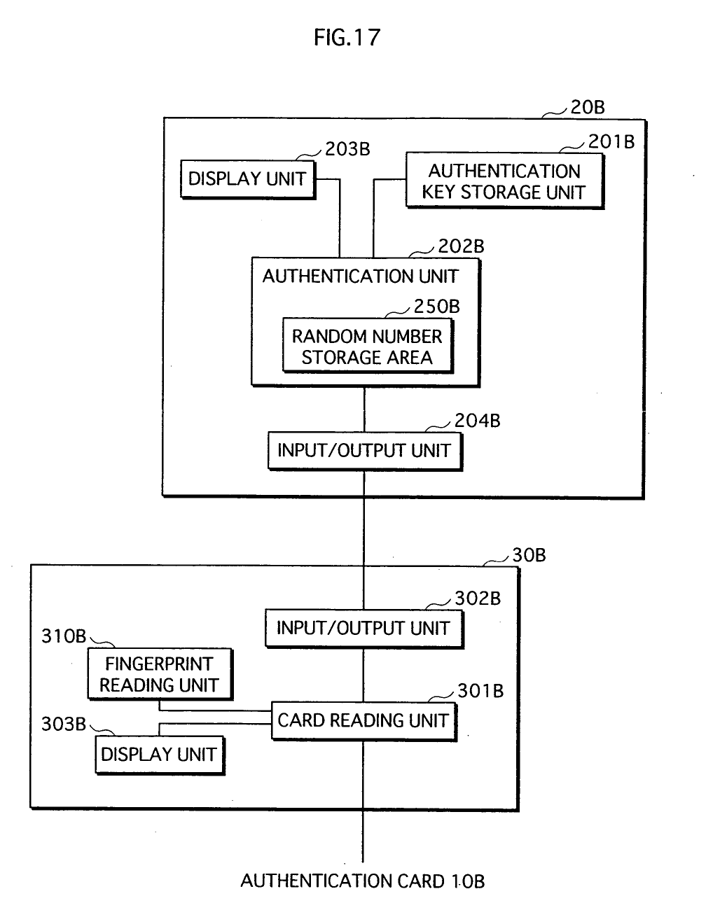

The construction of the user terminal 20B will be described. As shown in FIG. 17, the user terminal 20B includes an authentication key storage unit 201B, an authentication unit 202B, a display unit 203B, and an input/output unit 204B.

The user terminal 20B is specifically a computer system that includes a microprocessor, ROM, RAM, a hard disk unit, a display unit and the like. A computer program is stored in the ROM or the hard disk unit. The microprocessor operates in accordance with the computer program and causes the user terminal 20B to achieve the functions.

Since the function of the user terminal 20B as the base unit of the intercommunication system is well known, the illustration of the construction and description of it as the base unit are omitted.

(1) Authentication Key Storage Unit 201B

The authentication key storage unit 201B is tamper-resistant, and includes an area for storing the identity authentication fingerprint information.

(2) Authentication Unit 202B

The authentication unit 202B includes a random number storage area 250B for storing random numbers.

Upon receiving, from the card reader 30B via the input/output unit 204B, the identity authentication fingerprint information that was generated from the fingerprint input by the visitor, and receiving detection information that indicates detection of an insertion of the authentication card 10B into the card reader 30B, the authentication unit 202B writes the received identity authentication fingerprint information into the authentication key storage unit 201B, generates a random number “N”, outputs the generated random number “N” to the card reader 30B via the input/output unit 204B, and stores the generated random number “N” in the random number storage area 250B.

Further, the authentication unit 202B receives the encrypted information Enc(SK1,N) from the card reader 30B via the input/output unit 204B. The authentication unit 202B then acquires the identity authentication fingerprint information from the authentication key storage unit 201B, and decrypts the encrypted information Enc(SK1,N) using the acquired identity authentication fingerprint information, and judges whether or not the decrypting result matches the random number “N” stored in the random number storage area 250B.

If the decrypting result matches the random number “N”, the authentication unit 202B verifies the authenticity of the authentication card inserted in the card reader 30B, that is to say, determines that the authentication card inserted in the card reader 30B is authentic. And as the authentication result, the authentication unit 202B generates authentic visitor information that indicates that the visitor is an authentic visitor, and outputs the generated authentic visitor information to the display unit 203B. If the decrypting result does not match the random number “N”, the authentication unit 202B determines that the authentication card inserted in the card reader 30B is unauthentic, and as the authentication result, generates unauthentic visitor information that indicates that the visitor is an unauthentic visitor, and outputs the generated unauthentic visitor information to the display unit 203B. Further, the authentication unit 202B deletes the identity authentication key from the authentication key storage unit 201B, and deletes the random number “N” from the random number storage area 250B.

(3) Display Unit 203B

The description of the display unit 203B is omitted since it is the same as the display unit 203A of the user terminal 20A described in Embodiment 2. That is to say, the display unit 203B is also the same as the display unit 203 of the user terminal 20 described in Embodiment 1.

(4) Input/Output Unit 204B

The description of the input/output unit 204B is omitted since it is the same as the input/output unit 204A of the user terminal 20A described in Embodiment 2. That is to say, the input/output unit 204B is also the same as the input/output unit 204 of the user terminal 20 described in Embodiment 1.

3.4 Card Reader 30B

The card reader 30B, as shown in FIG. 17, includes a card reading unit 301B, an input/output unit 302B, a display unit 303B, and a fingerprint reading unit 310B.

The card reader 30B is specifically a computer system that includes a microprocessor, ROM, RAM and the like. A computer program is stored in the ROM. The microprocessor operates in accordance with the computer program and causes the card reader 30B to achieve the functions.

Since the function of the card reader 30B as the sub-unit of the intercommunication system is well known, the illustration of the construction and description of it as the sub-unit are omitted.

(1) Card Reading Unit 301B

The card reading unit 301B detects an insertion of the authentication card 10B. Upon detecting the insertion of the authentication card 10B, the card reading unit 301B generates request information that requests an input of a fingerprint and outputs the generated request information to the display unit 303B. Next, upon receiving the identity authentication fingerprint information from the fingerprint reading unit 310B, the card reading unit 301B generates the detection information, and outputs the generated detection information and the received identity authentication fingerprint information to the user terminal 20B via the input/output unit 302B.

Further, upon receiving the random number “N” from the user terminal 20B via the input/output unit 302B, the card reading unit 301B outputs the received random number “N” to the authentication card 10B. Upon receiving the encrypted information Enc(SK1,N) from the authentication card 10B, the card reading unit 301B outputs the received encrypted information Enc(SK1,N) to the user terminal 20B via the input/output unit 302B.

(2) Display Unit 303B

The display unit 303B is provided with, for example, a display, and displays the request information received from the card reading unit 301B, upon reception of it. This urges the visitor to input a fingerprint.

(3) Fingerprint Reading Unit 310B

The fingerprint reading unit 310B includes a fingerprint sensor. The fingerprint reading unit 310B reads a fingerprint pattern of the visitor using the fingerprint sensor, uses the read fingerprint pattern to generate identity authentication fingerprint information that is composed of characteristic points of the fingerprint pattern of the visitor, and outputs the generated identity authentication fingerprint information to the card reading unit 301B.

It should be noted here that the characteristic points of the fingerprint pattern are, for example, an end point of a ridge, a direction of a branch point, and a positional relationship.

(4) Input/Output Unit 302B

The description of the input/output unit 302B is omitted since it is the same as the input/output unit 302A of the card reader 30A described in Embodiment 2. That is to say, the input/output unit 302B is also the same as the input/output unit 302 of the card reader 30 described in Embodiment 1.

3.5 Operation of Identity Authentication Process

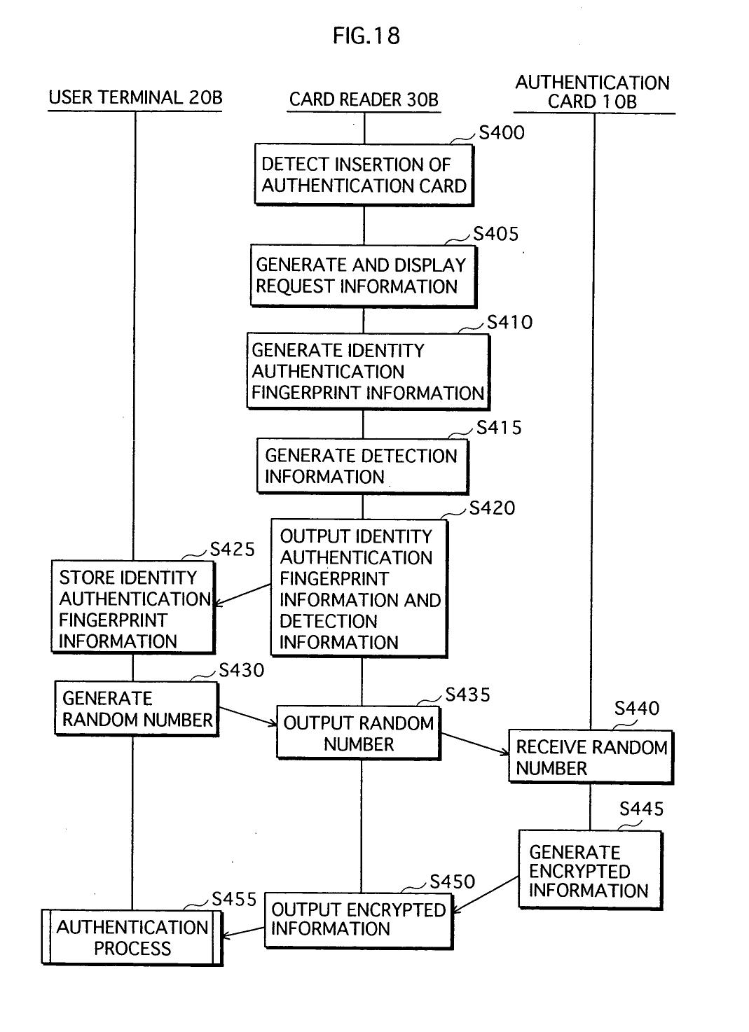

The identity authentication process is a process in which after the authentication card 10B is inserted into the card reader 30B, the user terminal 20B authenticates the identity. The identity authentication process will be described with reference to the flowchart shown in FIG. 18.

When the card reader 30B detects an insertion of the authentication card 10B (step S400), the card reader 30B generates request information and displays the generated request information (step S405). Next, the card reader 30B generates identity authentication fingerprint information from the fingerprint input by the visitor (step S410), generates detection information (step S415), and outputs, to the user terminal 20B, the identity authentication fingerprint information generated in step S410 and the detection information generated in step S415 (step S420).

Upon receiving the identity authentication fingerprint information and the detection information from the card reader 30B, the user terminal 20B writes the received identity authentication fingerprint information into the authentication key storage unit 201B (step S425). Next, the user terminal 20B generates a random number “N”, outputs the generated random number “N” to the card reader 30B, and stores the generated random number “N” in the random number storage area 250B (step S430).

Upon receiving the random number “N” from the user terminal 20B, the card reader 30B outputs the received random number “N” to the authentication card 10B (step S435).

Upon receiving the random number “N” from the card reader 30B(step S440), the authentication card 10B generates encrypted information by encrypting the received random number “N” using the identity certification key stored in the certification key storage unit 10B, and outputs the generated encrypted information to the card reader 30B (step S445).

Upon receiving the encrypted information from the authentication card 10B, the card reader 30B outputs the received encrypted information to the user terminal 20B (step S450).

Upon receiving the encrypted information from the card reader 30B, the user terminal 20B performs an authentication process using the received encrypted information and the identity authentication fingerprint information stored in the authentication key storage unit 201B (step S455).

3.6 Operation of Authentication Process

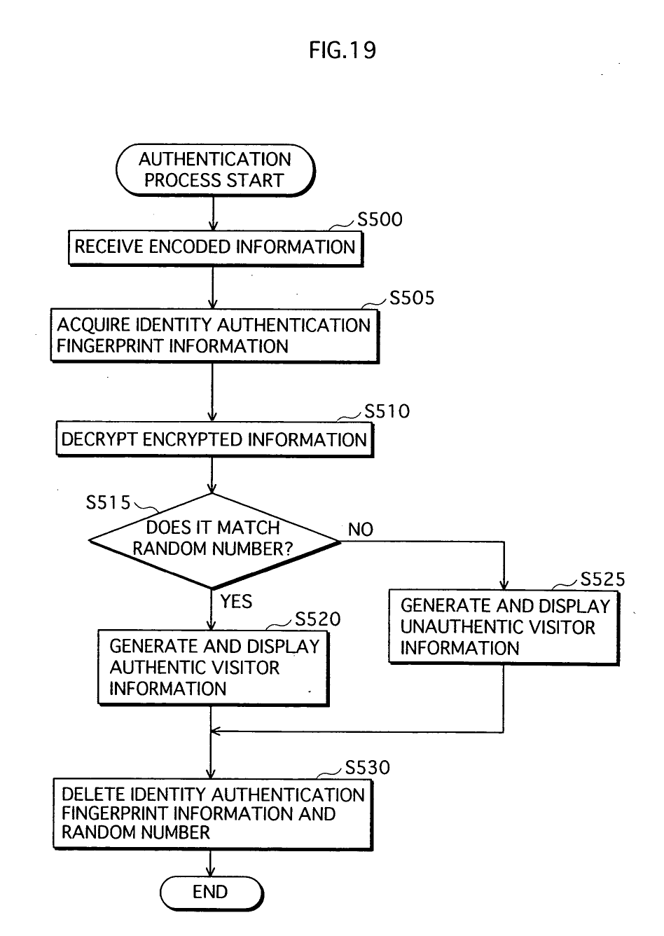

Here, the authentication process that is executed in step S455 of the identity authentication process will be described with reference to the flowchart shown in FIG. 19.

The user terminal 20B receives the encrypted information from the authentication card 10B via the card reader 30B (step S500). The user terminal 20B then acquires the identity authentication fingerprint information from the authentication key storage unit 201B (step S505). The user terminal 20B then decrypts the encrypted information received in step S500 using the acquired identity authentication fingerprint information (step S510).

The user terminal 20B then judges whether or not the decrypting result matches the random number “N” stored in the random number storage area 250B in step S430 of the identity authentication process (step S515).

If it judges that the decrypting result matches the random number “N” (YES in step S515), the user terminal 20B generates authentic visitor information and displays the generated authentic visitor information (step S520), deletes the identity authentication fingerprint information from the authentication key storage unit 201B and deletes the random number “N” from the random number storage area 250B (step S530), and ends the process.

If it judges that the decrypting result does not match the random number “N” (NO in step S515), the user terminal 20B generates unauthentic visitor information and displays the generated unauthentic visitor information (step S525), deletes the identity authentication fingerprint information from the authentication key storage unit 201B and deletes the random number “N” from the random number storage area 250B (step S530), and ends the process.

### 4. Embodiment 4

The following describes an identity authentication system 1C in Embodiment 4 of the present invention.

The identity authentication system 1C operates as follows.

Before a visitor visits the residence of the user, information regarding the visit is transmitted to a user terminal provided inside the residence of the user. The same information as the transmitted one is stored in an authentication card. When the visitor visits the residence of the user, first biometrics information, which shows biometric characteristics of the visitor, is used as the identity authentication key to determine whether or not the authentication card is authentic. If it is judged that the authentication card is authentic, it is then judged whether or not the information regarding the visit stored in the authentication card is identical with the information that was transmitted in advance.

4.1 Outline of Identity Authentication System 1C

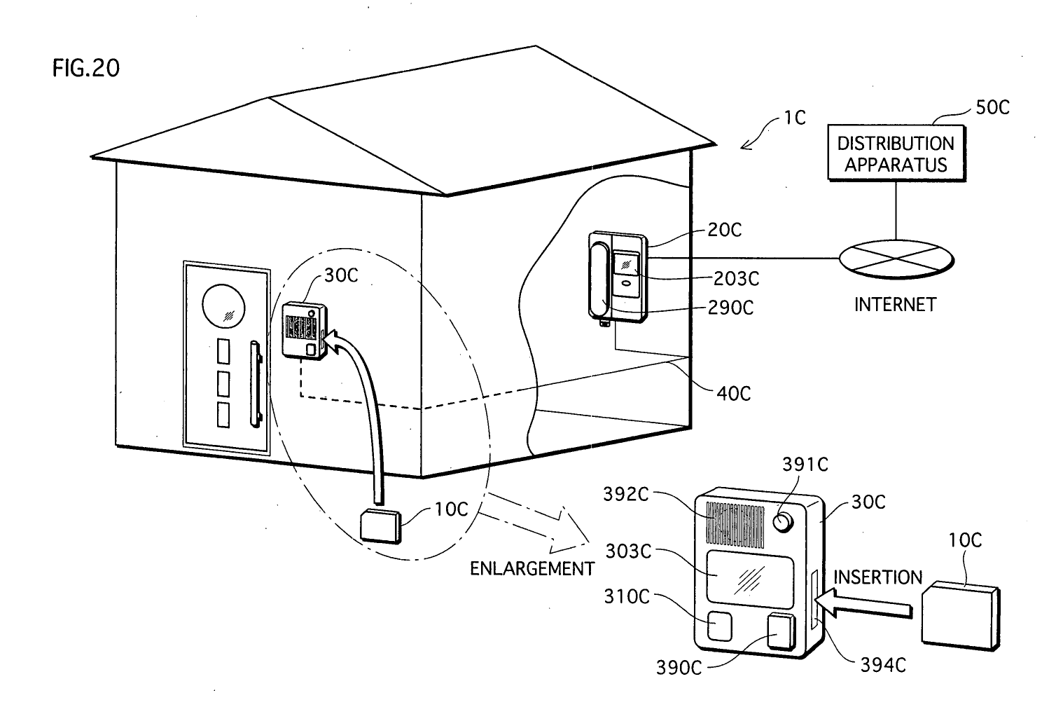

The identity authentication system 1C, as shown in FIG. 20, is composed of an authentication card 10C, a user terminal 20C, a card reader 30C, and a distribution apparatus 50C. The user terminal 20C and the card reader 30C are connected to each other via a cable 40C.

The user terminal 20C is provided in a residence of a user. More specifically, the user terminal 20C is a base unit of an intercommunication system. The card reader 30C, to/from which the authentication card 10C is attachable and detachable, is provided outside the residence of the user (for example, at an entrance of the residence). More specifically, the card reader 30C is a sub-unit of the intercommunication system that has the function of a card reader/writer that performs input/output of information with the authentication card 10C attached thereto. The user terminal 20C is provided with a receiver 290C and functions and operates as the base unit of the intercommunication system. The card reader 30C is provided with a call button 390C, a microphone 391C, and a speaker 392C and functions and operates as a sub-unit of the intercommunication system. For example, a visitor depresses the call button 390C of the card reader 30C to call the user inside the residence, and the user uses the receiver 290C to, over the intercommunication system, speak to the visitor, who uses the microphone 391C and the speaker 392C to speak with the user.

The authentication card 10C is assigned to a visitor who visits the residence of the user from the home-visit company, and prestores, as an identity certification key, biometrics information of the visitor to whom the authentication card 10B is assigned. It is presumed here that the biometrics information is identity certification fingerprint information that is composed of characteristic points of the fingerprint pattern of the visitor. The identity certification key stored in the authentication card is different for each visitor. That is to say, a visitor who is different from the visitor holding the authentication card 10C holds an authentication card 11C (not illustrated) which prestores an identity certification key that is different from the one stored in the authentication card 10C.

The card reader 30C is provided with a fingerprint reading unit 310C that receives a fingerprint that is input by the visitor.

Although not shown in FIG. 20, user terminals 21C, . . . 22C, each of which has the same construction as the user terminal 20C, are connected to the distribution apparatus 50C via the Internet. Also, the user terminals 21C, . . . 22C are respectively connected to card readers 31C, . . . 32C each of which has the same construction as the card reader 30C.

Now, the outline of the identity authentication system 1C will be described using the authentication card 10C, the user terminal 20C, and the card reader 30C. The description of the user terminals 21C, . . . 22C and the card readers 31C, . . . 32C is omitted since they are the same as the user terminal 20C and the card reader 30C, respectively.

In the identity authentication system 1C, before a visitor visits the residence of the user, the distribution apparatus 50C generates an authentication visit key and a certification visit key that are used to verify the authenticity of the visit by the visitor, and also generates authentication visit information that is composed of: time information indicating a time period for the visit; and business information indicating the business of the visit. The distribution apparatus 50C transmits the generated authentication visit key and authentication visit information to the user terminal 20C via the Internet. Further, the distribution apparatus 50C stores the certification visit key and the certification visit information that is identical with the transmitted authentication visit information, into the authentication card 10C by correlating them with a terminal ID that identifies the user terminal to which the authentication visit key and authentication visit information were transmitted. The certification visit information is composed of: certification time information indicating a time period for the visit; and certification business information indicating the business of the visit.

Upon insertion of the authentication card 10C into an insertion slot 394C of the card reader 30C, the user terminal 20C requests the visitor to input a fingerprint. Upon receiving an input fingerprint through the fingerprint reading unit 310C of the card reader 30C, the identity authentication system 1C generates, from the received fingerprint, identity authentication fingerprint information that is composed of characteristic points of the fingerprint pattern of the received fingerprint. The identity authentication system 1C then performs an authentication by a challenge-response system, based on the generated identity authentication fingerprint information and the identity certification key stored in the authentication card 10C. The encryption process used here is, as is the case with the identity authentication system 1, an encryption process using a secret key. Also, as is the case with the identity authentication system 1, it is needless to say that the same key is used as the identity certification key and the identity authentication fingerprint information.

Next, if it judges that the authentication card inserted in the card reader 30C is authentic, the identity authentication system 1C performs an authentication by a challenge-response system based on the authentication visit key and the certification visit key to judge whether or not the certification visit key is authentic. The encryption process used here is an encryption process using a secret key. Also, it is needless to say that the same key is used as the authentication visit key and the certification visit key.

Next, if it judges that the certification visit key is authentic in the above-described authentication, the identity authentication system 1C judges whether or not the visit time period and the business of the visit contained in the certification visit information match the visit time period and the business of the visit contained in the authentication visit information that was transmitted in advance, and displays the judgment result with the display unit 203C of the user terminal 20C.

The user can keep the entrance door locked while the visitor inserts the authentication card 10C into the card reader 30C. Also, the user can determine whether or not to unlock the door depending on the authentication result of the user terminal 20C. That is to say, the user can open the door if the authentication result is affirmative, and can keep the door closed if the authentication result is negative.

Since the authentication card 11C (not illustrated) inserted in the card reader 30C of the identity authentication system 1C operates in a similar manner to the authentication card 10C, the authentication card 10C is used in the following description.

It is required that each time an authentic visitor inserts the authentication card 10C, the identity certification key stored in the authentication card 10C completely match the identity authentication fingerprint information generated by the card reader 30C. A method for always converting a fingerprint into a piece of unique fingerprint information has been disclosed. The description of the technology is omitted here since it is a well known technology.

4.2 Distribution Apparatus 50C

The distribution apparatus 50C is an apparatus that, before a visitor visits the residence of the user, transmits authentication visit information to the user terminal 20C. When the distribution apparatus 50C transmits the authentication visit information to the user terminal 20C, the authentication card 10C corresponding to the visitor is attached to the distribution apparatus 50C.

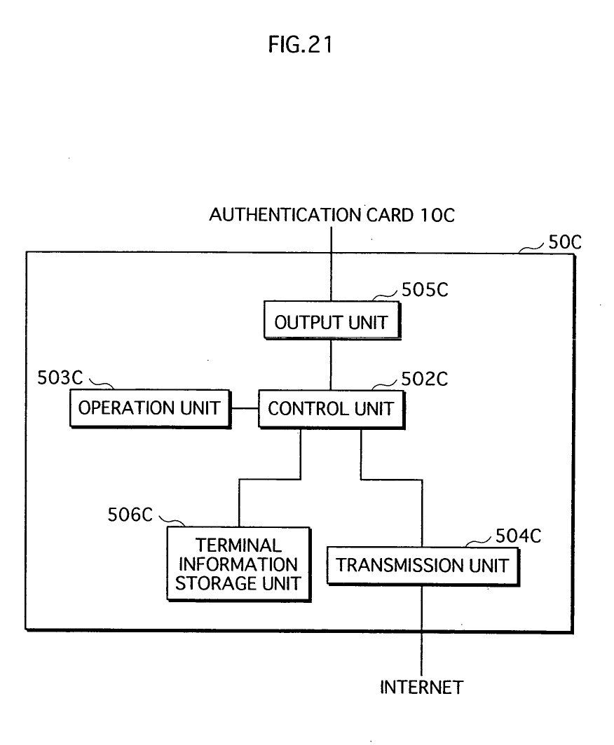

As shown in FIG. 21, the distribution apparatus 50C includes a terminal information storage unit 506C, a control unit 502C, an operation unit 503C, a transmission unit 504C, and an output unit 505C.

The distribution apparatus 50C is specifically a computer system that includes a microprocessor, ROM, RAM, a hard disk unit, a display unit, a keyboard, a modem and the like. A computer program is stored in the ROM or the hard disk unit. The microprocessor operates in accordance with the computer program and causes the distribution apparatus 50C to achieve the functions.

(1) Terminal Information Storage Unit 506C

The terminal information storage unit 506C is tamper-resistant, and stores therein terminal IDs that uniquely identify user terminals that were distributed to the residences of the users.

It should be noted here that the number of the terminal IDs stored in the terminal information storage unit 506C is identical with the number of distributed user terminals.

(2) Control Unit 502C

When the control unit 502C receives visit distribution information that indicates that the authentication visit information is distributed to the user terminal 20C, from the operation unit 503C together with the visit time period and the business of the visit, the control unit 502C generates an authentication visit key and a certification visit key.

The control unit 502C generates authentication visit information using the received visit time period and business of the visit, and transmits the generated authentication visit information and authentication visit key to the user terminal 20C.

The control unit 502C generates certification visit information using the received visit time period and business of the visit. The control unit 502C further acquires, from the terminal information storage unit 506C, a terminal ID for identifying the user terminal 20C, and outputs the acquired terminal ID and the generated certification visit information and certification visit key to the authentication card 10C via the output unit 505C, by correlating them with each other.

(3) Operation Unit 503C

When the operation unit 503C receives, through an operation of an operator, the visit distribution information together with the visit time period and the business of the visit, the operation unit 503C outputs the visit distribution information, visit time period, and business of the visit to the control unit 502C.

It should be noted here that the operator is not limited to the visitor himself/herself who visits the residence of the user, but may be any person who belongs to the home-visit company.

(4) Transmission Unit 504C

The transmission unit 504C receives information from the control unit 502C, and outputs the received information to the user terminal 20C via the Internet.

(5) Output Unit 505C

The output unit 505C receives information from the control unit 502C, and outputs the received information to the authentication card 10C.

4.3 Authentication Card 10C

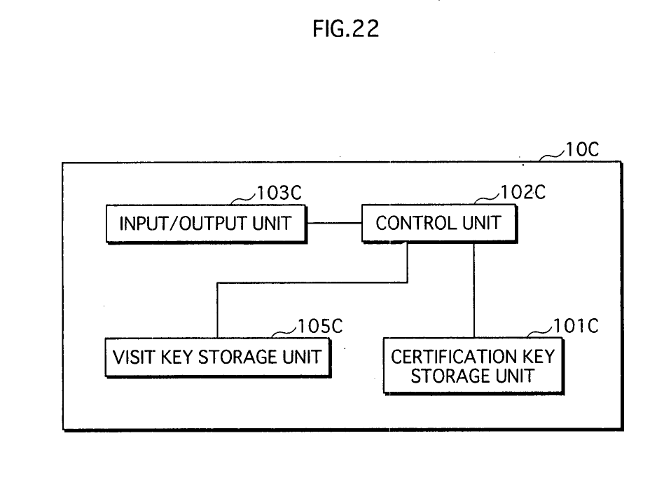

The construction of the authentication card 10C will be described. The authentication card 10C is a portable recording medium in which an IC is embedded. One specific example of the authentication card 10C is a memory card having an IC card function. As shown in FIG. 22, the authentication card 10C is composed of a certification key storage unit 101C, a visit key storage unit 105C, a control unit 102C, and an input/output unit 103C.

The authentication card 10C is specifically a computer system that includes a microprocessor, ROM, RAM and the like. A computer program is stored in the ROM. The microprocessor operates in accordance with the computer program and causes the authentication card 10C to achieve the functions.

(1) Certification Key Storage Unit 101C

The certification key storage unit 101A is tamper-resistant, and stores, as an identity certification key, a piece of identity certification fingerprint information that corresponds to a visitor.

In the following description, an identity certification key “SK1” is used as necessary.

(2) Visit Key Storage Unit 105C

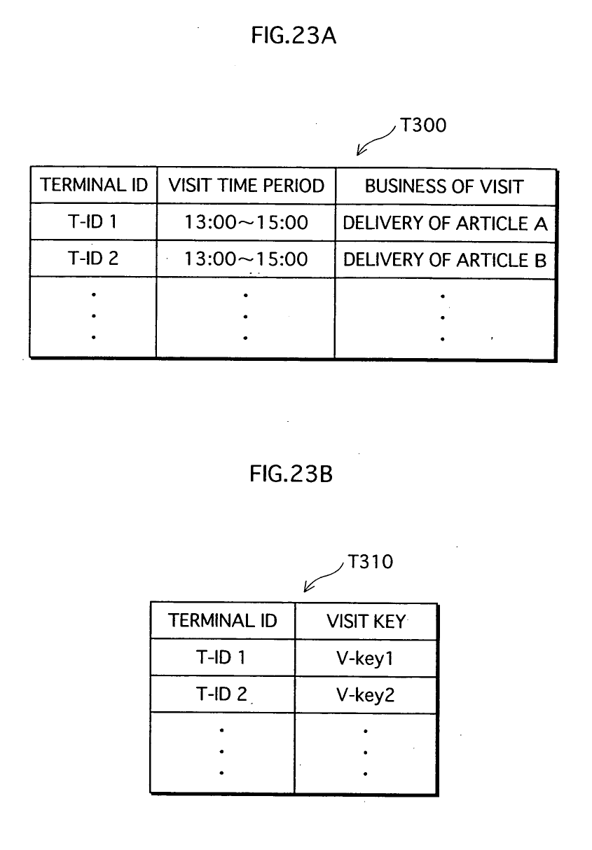

The visit key storage unit 105C is tamper-resistant, and includes a certification visit information table T300 and a certification visit key table T310, examples of which are respectively shown in FIGS. 23A and 23B.

The certification visit information table T300 has an area for storing one or more sets of a terminal ID, a piece of certification time information, and a piece of certification business information. The terminal ID is an identifier for identifying a user terminal distributed to a residence of a user. For example, terminal ID “T-ID1” indicates the user terminal 20C, and terminal ID “T-ID2” indicates user terminal 21C (not shown in FIG. 20). The certification time information indicates a time period for a visit by a visitor. The certification business information indicates the business of the visit.

The certification visit key table T310 has an area for storing one or more pairs of a terminal ID and a certification visit key. In regards with the terminal ID, an explanation was given earlier. The certification visit key is used to judge whether or not a visit by a visitor is authentic.

(3) Control Unit 102C

The control unit 102C, upon receiving a terminal ID, a piece of certification visit information, and a certification visit key from the distribution apparatus 50C via the input/output unit 103C, writes the received terminal ID and certification visit information into the certification visit information table T300.

The control unit 102C writes the received terminal ID and certification visit key into the certification visit key table T310.

Also, upon receiving a first random number “N1” from the card reader 30C via the input/output unit 103C, the control unit 102C acquires the identity certification key “SK1” from the certification key storage unit 101C, and generates first encrypted information Enc(SK1,N1) by encrypting the first random number “N1”, which was received from the card reader 30C, using the acquired identity certification key “SK1”. The control unit 102C outputs the generated encrypted information to the card reader 30C via the input/output unit 103C.

Also, upon receiving a terminal ID (for example, “T-ID1”) and a second random number “N2” from the card reader 30C via the input/output unit 103C, the control unit 102C acquires a certification visit key “V-key1” that corresponds to the received terminal ID, and generates second encrypted information Enc(V-key1,N2) by encrypting the second random number “N2”, which was received from the card reader 30C, using the acquired certification visit key “V-key1”. The control unit 102C outputs the generated second encrypted information to the card reader 30C via the input/output unit 103C. Also, the control unit 102C temporarily stores the received terminal ID.

Further, upon receiving, from the card reader 30C, output indication information that indicates outputting the certification visit information to the user terminal 20C, the control unit 102C acquires, from the certification visit information table T300, a piece of certification visit information that corresponds to the temporarily stored terminal ID, and outputs the acquired piece of certification visit information to the card reader 30C via the input/output unit 103C.

(4) Input/Output Unit 103C

The description of the input/output unit 103C is omitted since it is the same as the input/output unit 103B of the authentication card 10B described in Embodiment 3. That is to say, the input/output unit 103C is also the same as the input/output unit 103 of the authentication card 10 described in Embodiment 1 and as the input/output unit 103A of the authentication card 10A described in Embodiment 2.

4.4 Construction of User Terminal 20C

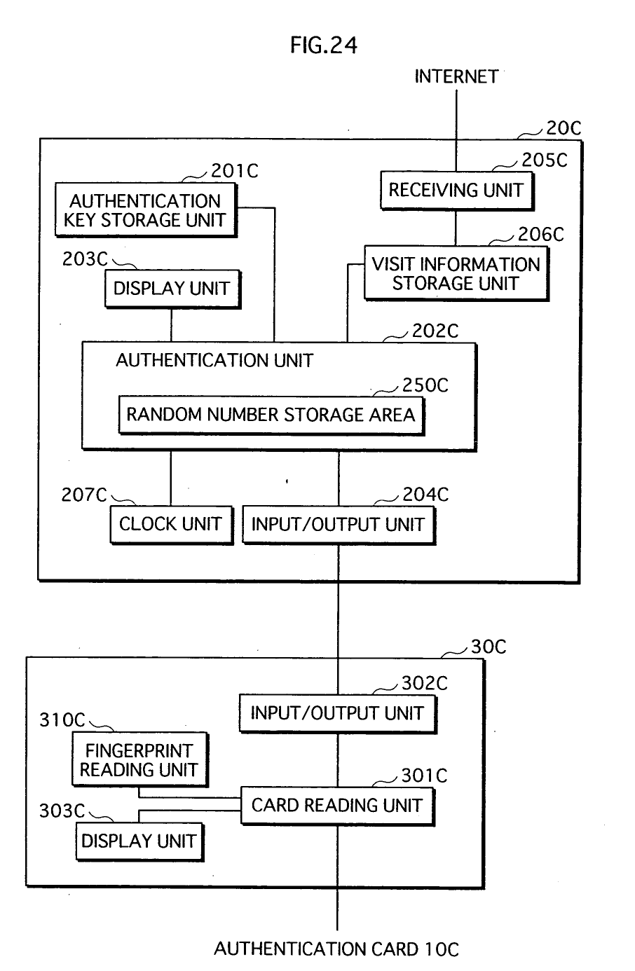

The construction of the user terminal 20C will be described. As shown in FIG. 24, the user terminal 20C includes an authentication key storage unit 201C, an authentication unit 202C, a display unit 203C, an input/output unit 204C, a receiving unit 205C, a visit information storage unit 206C, and a clock unit 207C.

The user terminal 20C is specifically a computer system that includes a microprocessor, ROM, RAM, a hard disk unit, a display unit and the like. A computer program is stored in the ROM or the hard disk unit. The microprocessor operates in accordance with the computer program and causes the user terminal 20C to achieve the functions.

The description of the user terminals 21C, . . . 22C is omitted since they have the same construction as the user terminal 20C as described earlier in the description of the outline of the identity authentication system 1C.

Also, since the function of the user terminal 20C as the base unit of the intercommunication system is well known, the illustration of the construction and description of it as the base unit are omitted.

(1) Authentication Key Storage Unit 201C

The description of the authentication key storage unit 201C is omitted since it is the same as the authentication key storage unit 201B of the user terminal 20B described in Embodiment 3.

(2) Visit Information Storage Unit 206C

The visit information storage unit 206C is tamper-resistant, and includes an area for storing the authentication visit information and authentication visit key transmitted from the distribution apparatus 50C.

(3) Receiving Unit 205C

The receiving unit 205C, upon receiving the authentication visit information and authentication visit key from the distribution apparatus 50C via the Internet, writes the received authentication visit information and authentication visit key into the visit information storage unit 206C.

With such an arrangement, the user terminal 20C can prestore information concerning a visit by a person in the home-visit company.

(4) Clock Unit 207C

The clock unit 207C measures time.

(5) Authentication Unit 202C

The authentication unit 202C includes a random number storage area 250C for storing random numbers, and prestores a terminal ID (in this example, “T-ID1”) of the user terminal 20C.

Upon receiving, from the card reader 30C via the input/output unit 204C, the identity authentication fingerprint information that was generated from the fingerprint input by the visitor, and receiving detection information that indicates detection of an insertion of the authentication card 10C into the card reader 30C, the authentication unit 202C writes the received identity authentication fingerprint information into the authentication key storage unit 201C, generates the first random number “N1”, outputs the generated first random number “N1” to the card reader 30C via the input/output unit 204C, and stores the generated first random number “N1” in the random number storage area 250C.

Further, the authentication unit 202C receives the first encrypted information Enc(SK1,N1) from the card reader 30C via the input/output unit 204C. The authentication unit 202C then acquires the identity authentication fingerprint information from the authentication key storage unit 201C, and decrypts the first encrypted information Enc(SK1,N1) using the acquired identity authentication fingerprint information, and judges whether or not the decrypting result matches the first random number “N1” stored in the random number storage area 250C.

If the decrypting result does not match the first random number “N1”, the authentication unit 202C determines that the authentication card inserted in the card reader 30C is unauthentic, and as the authentication result, generates unauthentic visitor information that indicates that the visitor is an unauthentic visitor, and outputs the generated unauthentic visitor information to the display unit 203C. Further, the authentication unit 202C deletes the identity authentication fingerprint information from the authentication key storage unit 201C, and deletes the first random number “N1” from the random number storage area 250C.

If the decrypting result matches the first random number “N1”, the authentication unit 202C verifies the authenticity of the authentication card inserted in the card reader 30C, that is to say, determines that the authentication card inserted in the card reader 30C is authentic. When this happens, the authentication unit 202C acquires the prestored terminal ID, generates the second random number “N2”, and updates the random number storage area 250C from the first random number “N1” to the second random number “N2”. The authentication unit 202C then outputs the generated second random number “N2” and the acquired terminal ID to the card reader 30C via the input/output unit 204C. Further, upon receiving the second encrypted information Enc(V-key1,N2) from the card reader 30C via the input/output unit 204C, the authentication unit 202C acquires the authentication visit key from the visit information storage unit 206C.

The authentication unit 202C decrypts the received second encrypted information Enc(V-key1,N2) using the acquired authentication visit key, and judges whether or not the decrypting result matches the second random number “N2” stored in the random number storage area 250C.

If the decrypting result does not match the second random number “N2”, the authentication unit 202C determines that the authentication card inserted in the card reader 30C is unauthentic, and as the authentication result, generates unauthentic visitor information that indicates that the visitor is an unauthentic visitor, and outputs the generated unauthentic visitor information to the display unit 203C. Further, the authentication unit 202C deletes the second random number “N2” from the random number storage area 250C.

If the decrypting result matches the second random number “N2”, the authentication unit 202C verifies the authenticity of the authentication visit key stored in the authentication card inserted in the card reader 30C, that is to say, determines that the visit key is authentic. When this happens, the authentication unit 202C generates the output indication information and outputs the generated output indication information to the card reader 30C via the input/output unit 204C. Further, upon receiving the authentication visit information from the card reader 30C via the input/output unit 204C, the authentication unit 202C operates as follows. The authentication unit 202C acquires the authentication visit information from the visit information storage unit 206C. The authentication unit 202C then judges whether or not the certification time information and the certification business information contained in the received certification visit information respectively match the time information and the business information contained in the acquired authentication visit information.

If at least one of them does not match, the authentication unit 202C determines that the authentication card inserted in the card reader 30C is unauthentic, and as the authentication result, generates the unauthentic visitor information, and outputs the generated unauthentic visitor information to the display unit 203C.

If both of them match, the authentication unit 202C verifies the authenticity of the certification visit information stored in the authentication card inserted in the card reader 30C, that is to say, determines that the certification visit information stored is authentic. When this happens, the authentication unit 202C acquires a current time from the clock unit 207C, and judges whether or not the acquired current time falls into the visit time period indicated by the visit time information. If it judges that the acquired current time does not fall into the visit time period, the authentication unit 202C determines that the authentication card inserted in the card reader 30C is unauthentic, generates the unauthentic visitor information, outputs the generated unauthentic visitor information to the display unit 203C, deletes the authentication visit information and the authentication visit key from the visit information storage unit 206C, and deletes the second random number “N2” from the random number storage area 250C.

If it judges that the acquired current time falls into the visit time period, the authentication unit 202C generates the authentic visitor information, outputs the generated authentic visitor information to the display unit 203C, deletes the authentication visit information from the visit information storage unit 206C, and deletes the second random number “N2” from the random number storage area 250C.

(6) Display Unit 203C

The description of the display unit 203C is omitted since it is the same as the display unit 203B of the user terminal 20B described in Embodiment 3. That is to say, the display unit 203C is also the same as the display unit 203 of the user terminal 20 described in Embodiment 1 and as the display unit 203A of the user terminal 20A described in Embodiment 2.

(7) Input/Output Unit 204C

The description of the input/output unit 204C is omitted since it is the same as the input/output unit 204B of the user terminal 20B described in Embodiment 3. That is to say, the input/output unit 204C is also the same as the input/output unit 204 of the user terminal 20 described in Embodiment 1 and as the input/output unit 204A of the user terminal 20A described in Embodiment 2.

4.5 Card Reader 30C

The card reader 30C, as shown in FIG. 24, includes a card reading unit 301C, an input/output unit 302C, a display unit 303C, and a fingerprint reading unit 310C.

The card reader 30C is specifically a computer system that includes a microprocessor, ROM, RAM and the like. A computer program is stored in the ROM. The microprocessor operates in accordance with the computer program and causes the card reader 30C to achieve the functions.

The description of the card readers 31C, . . . 32C is omitted since they have the same construction as the card reader 30C as described earlier in the description of the outline of the identity authentication system 1C.

Also, since the function of the card reader 30C as the base unit of the intercommunication system is well known, the illustration of the construction and description of it as the base unit are omitted.

(1) Card Reading Unit 301C

The card reading unit 301C detects an insertion of the authentication card 10C. Upon detecting the insertion of the authentication card 10C, the card reading unit 301C generates request information that requests an input of a fingerprint and outputs the generated request information to the card reader 303C. Next, upon receiving the identity authentication fingerprint information from the fingerprint reading unit 310C, the card reading unit 301C generates the detection information, and outputs the generated detection information and the received identity authentication fingerprint information to the user terminal 20C via the input/output unit 302C.

Further, upon receiving the first random number “N1” from the user terminal 20C via the input/output unit 302C, the card reading unit 301C outputs the received first random number “N1” to the authentication card 10C. Upon receiving the first encrypted information Enc(SK1,N1) from the authentication card 10C, the card reading unit 301C outputs the received first encrypted information Enc(SK1,N1) to the user terminal 20C via the input/output unit 302C.

The card reading unit 301C, upon receiving a terminal ID and a second random number “N2” from the user terminal 20C via the input/output unit 302C, outputs the received terminal ID and second random number “N2” to the authentication card 10C. Further, upon receiving the second encrypted information Enc(V-key1,N2) from the authentication card 10C, the card reading unit 301C outputs the received second encrypted information Enc(V-key1,N2) to the user terminal 20C via the input/output unit 302C.

Further, upon receiving the output indication information from the user terminal 20C via the input/output unit 302C, the card reading unit 301C outputs the received output indication information to the authentication card 10C. Further, upon receiving the certification visit information from the authentication card 10C, the card reading unit 301C outputs the received certification visit information to the user terminal 20C via the input/output unit 302C.

(2) Display Unit 303C

The description of the card reader 303C is omitted since it is the same as the display unit 303B of the card reader 30B described in Embodiment 3.

(3) Fingerprint Reading Unit 310C

The description of the fingerprint reading unit 310C is omitted since it is the same as the fingerprint reading unit 310B of the card reader 30B described in Embodiment 3.

(4) Input/Output Unit 302C

The description of the input/output unit 302C is omitted since it is the same as the input/output unit 302B of the card reader 30B described in Embodiment 3. That is to say, the input/output unit 302C is also the same as the input/output unit 302 of the card reader 30 described in Embodiment 1 and as the input/output unit 302A of the card reader 30A described in Embodiment 2.

4.6 Operation of Visit Information Distribution Process

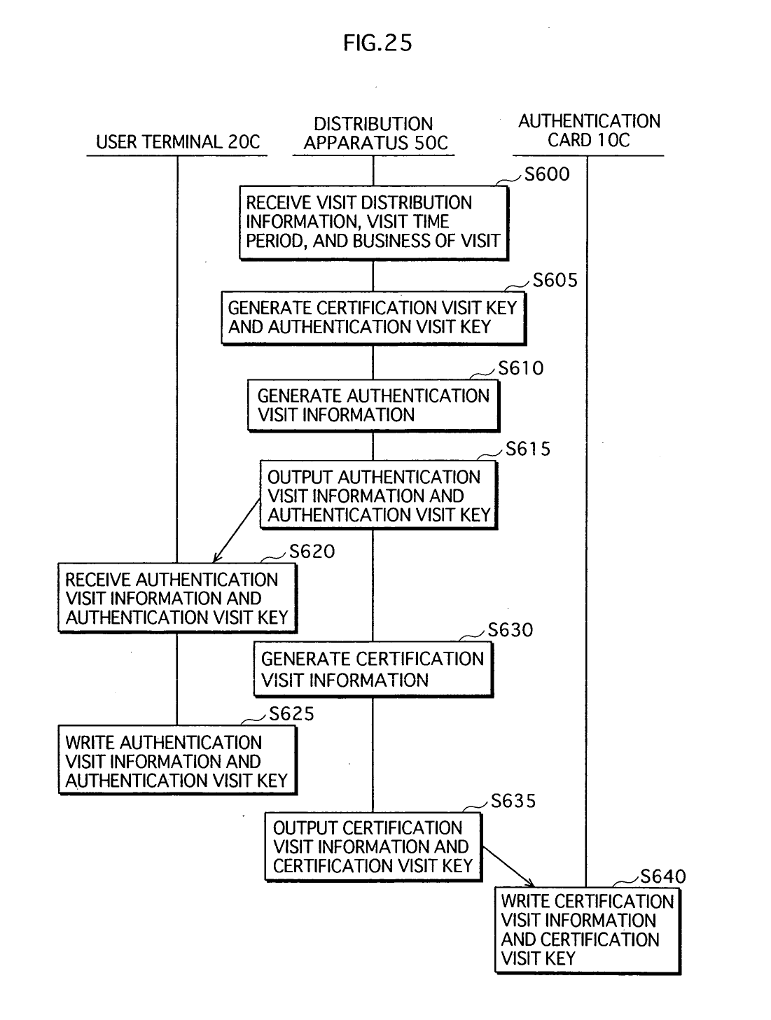

The visit information distribution process in which the authentication visit information is distributed beforehand will be described with reference to the flowchart shown in FIG. 25.

When the distribution apparatus 50C receives, through an operation of the user, visit distribution information that indicates that the authentication visit information is distributed to the user terminal 20C, together with the visit time period and the business of the visit (step S600), the distribution apparatus 50C generates an authentication visit key and a certification visit key (step S605). Next, the distribution apparatus 50C generates authentication visit information using the generated authentication visit key and the visit time period and business of the visit received in step S600 (step S610). The distribution apparatus 50C then transmits the generated authentication visit information and authentication visit key to the user terminal 20C (step S615). Upon receiving the authentication visit information and authentication visit key from the distribution apparatus 50C (step S620), the user terminal 20C writes the received authentication visit information and authentication visit key into the visit information storage unit 206C (step S625).

The distribution apparatus 50C further generates certification visit information using the visit time period and business of the visit received in step S600 (step S630), and outputs the generated certification visit information and the certification visit key generated in step S605 to the authentication card 10C (step S635).

Upon receiving the certification visit information, the authentication card 10C writes the received certification visit information into the visit key storage unit 105C (step S640).

4.7 Operation of Identity Authentication Process

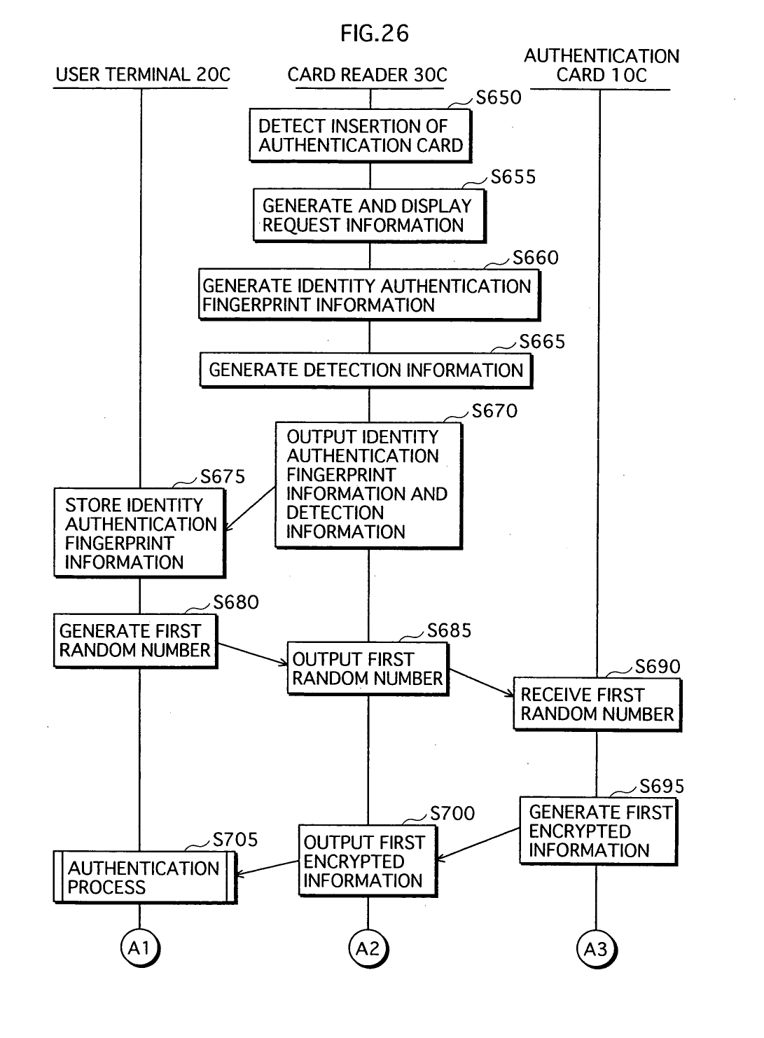

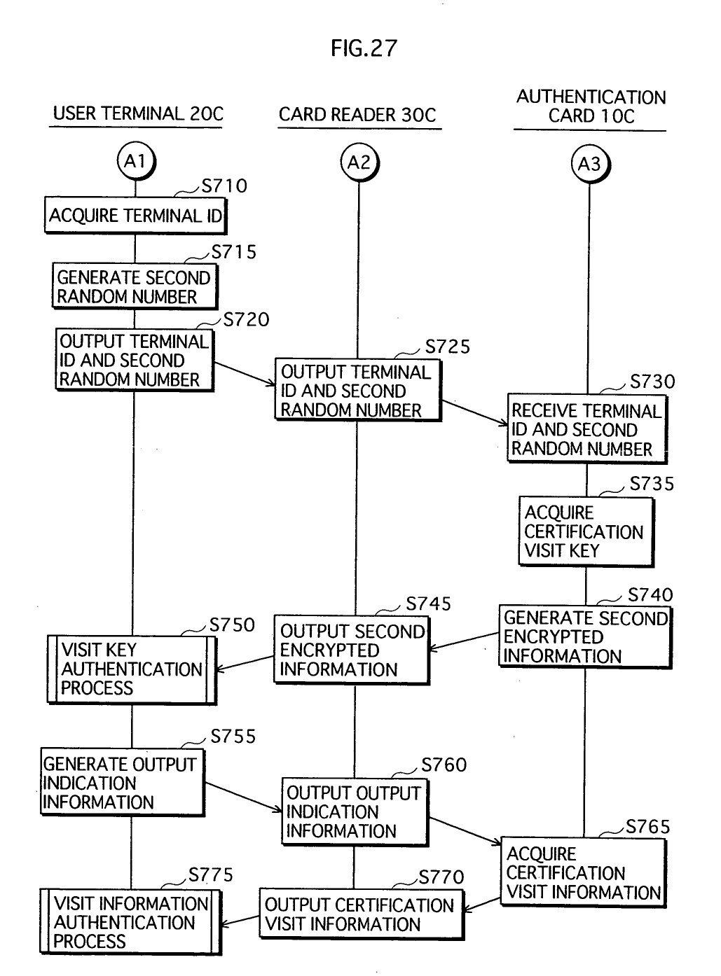

The identity authentication process, in which an authentication of the authentication card 10C inserted in the card reader 30C is performed, will be described with reference to the flowcharts shown in FIGS. 26 and 27.

When the card reader 30C detects an insertion of the authentication card 10C (step S650), the card reader 30C generates request information and displays the generated request information (step S655). Next, the card reader 30C generates identity authentication fingerprint information from the fingerprint input by the visitor (step S660), generates detection information (step S665), and outputs, to the user terminal 20C, the identity authentication fingerprint information generated in step S660 and the detection information generated in step S665 (step S670).

Upon receiving the identity authentication fingerprint information and the detection information from the card reader 30C, the user terminal 20C writes the received identity authentication fingerprint information into the authentication key storage unit 201C (step S675). Next, the user terminal 20C generates a first random number “N1”, outputs the generated first random number “N1” to the card reader 30C, and stores the generated first random number “N1” in the random number storage area 250C (step S680).

Upon receiving the first random number “N1” from the user terminal 20C, the card reader 30C outputs the received first random number “N1” to the authentication card 10C (step S685).

Upon receiving the first random number “N1” from the card reader 30C (step S690), the authentication card 10C generates first encrypted information by encrypting the received first random number “N1” using the identity certification key stored in the certification key storage unit 101C, and outputs the generated first encrypted information to the card reader 30C (step S695).

Upon receiving the first encrypted information from the authentication card 10C, the card reader 30C outputs the received first encrypted information to the user terminal 20C (step S700).

Upon receiving the first encrypted information from the card reader 30C, the user terminal 20C performs an authentication process using the received first encrypted information and the identity authentication fingerprint information stored in the authentication key storage unit 201C (step S705).

If it is judged in the authentication process that the authentication card inserted in the card reader is authentic, the user terminal 20C acquires a terminal ID (step S710), generates a second random number “N2”, and updates the random number storage area 250C from the first random number “N1” to the second random number “N2” (step S715) The user terminal 20C then outputs the acquired terminal ID and the generated second random number “N2” to the card reader 30C (step S720).

Upon receiving the terminal ID and the second random number “N2” from the user terminal 20C, the card reader 30C outputs the received terminal ID and second random number “N2” to the authentication card 10C (step S725).

Upon receiving the terminal ID and the second random number “N2” from the card reader 30C (step S730), the authentication card 10C acquires a certification visit key corresponding to the received terminal ID from the certification visit key table T310 (step S735). The authentication card 10C then generates second encrypted information by encrypting the second random number “N2” using the acquired certification visit key, and outputs the generated second encrypted information to the card reader 30C (step S740).

Upon receiving the second encrypted information from the authentication card 10C, the card reader 30C outputs the received second encrypted information to the user terminal 20 C(step S745).

Upon receiving the second encrypted information from the card reader 30C, the user terminal 20C performs a visit key authentication process using the received second encrypted information and the authentication visit key that is contained in the authentication visit information stored in the visit information storage unit 206C (step S750).

If it judges in the visit key authentication process that the certification visit information stored in the authentication card 10C is authentic, the user terminal 20C generates output indication information, and outputs the generated output indication information to the card reader 30C (step S755).

Upon receiving the output indication information from the user terminal 20C, the card reader 30C outputs the received output indication information to the authentication card (step S760).

Upon receiving the output indication information from the card reader 30C, the authentication card 10C acquires certification visit information from the certification visit information table T300, and outputs the acquired certification visit information to the card reader 30C (step S765).

Upon receiving the certification visit information from the authentication card 10C, the card reader 30C outputs the received certification visit information to the user terminal 20C (step S770).

Upon receiving the certification visit information from the card reader 30C, the user terminal 20C performs a visit information authentication process using the received certification visit information and the authentication visit information that is stored in the visit information storage unit 206C (step S775).

4.8 Authentication Process

Here, the authentication process that is executed in step S705 of the identity authentication process shown in FIG. 26 will be described centering on changes from the authentication process shown in FIG. 19.

If it is judged that the decrypting result matches the random number“N” (YES in step S515), step S520 and after are not performed, but instead step S710 and after shown in FIG. 27 are performed. If it is judged that the decrypting result does not match the random number “N” (NO in step S515), the steps are performed as shown in FIG. 19. It should be noted here that in the authentication process shown in FIG. 27, the steps are performed as shown in FIG. 19 by replacing the random number and the encrypted information with the first random number and the first encrypted information, respectively.

4.9 Visit Key Authentication Process

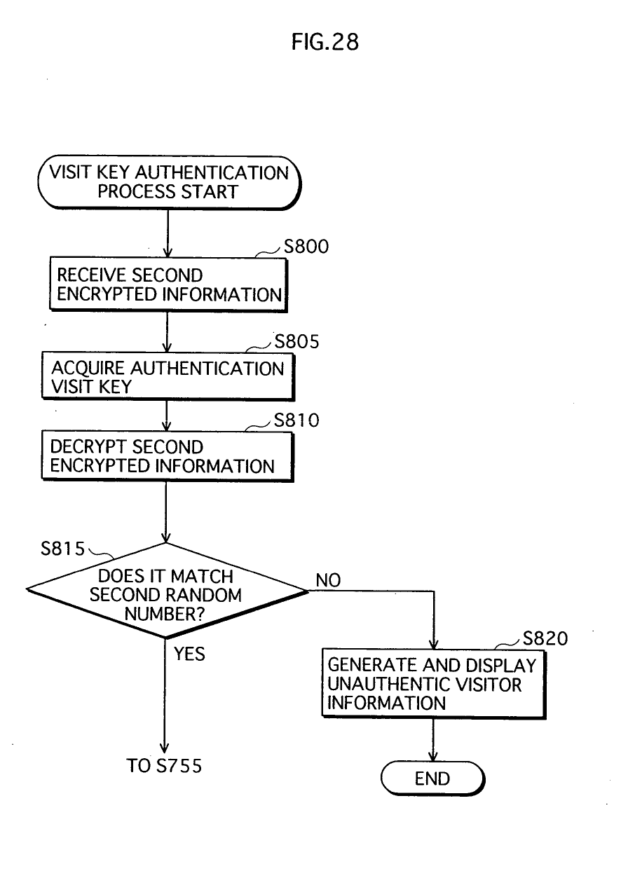

Here, the visit key authentication process that is executed in step S750 of the identity authentication process shown in FIG. 27 will be described with reference to the flowchart shown in FIG. 28.

The user terminal 20C receives the second encrypted information from the authentication card 10C via the card reader 30C (step S800). The user terminal 20C then acquires, from the visit information storage unit 206C, an authentication visit key (step S805), decrypts the second encrypted information using the acquired authentication visit key (step S810), and judges whether or not the decrypting result matches the second random number “N2” stored in the random number storage area 250C (step S815).

If it is judged that the decrypting result matches the second random number “N2” (YES in step S815), step S755 and after shown in FIG. 27 are performed.

If the user terminal 20C judges that the decrypting result does not match the second random number “N2” (NO in step S815), the user terminal 20C generates unauthentic visitor information, outputs the generated unauthentic visitor information to the display unit 203C, and deletes the second random number “N2” from the random number storage area 250C (step S820).

4.10 Visit Information Authentication Process

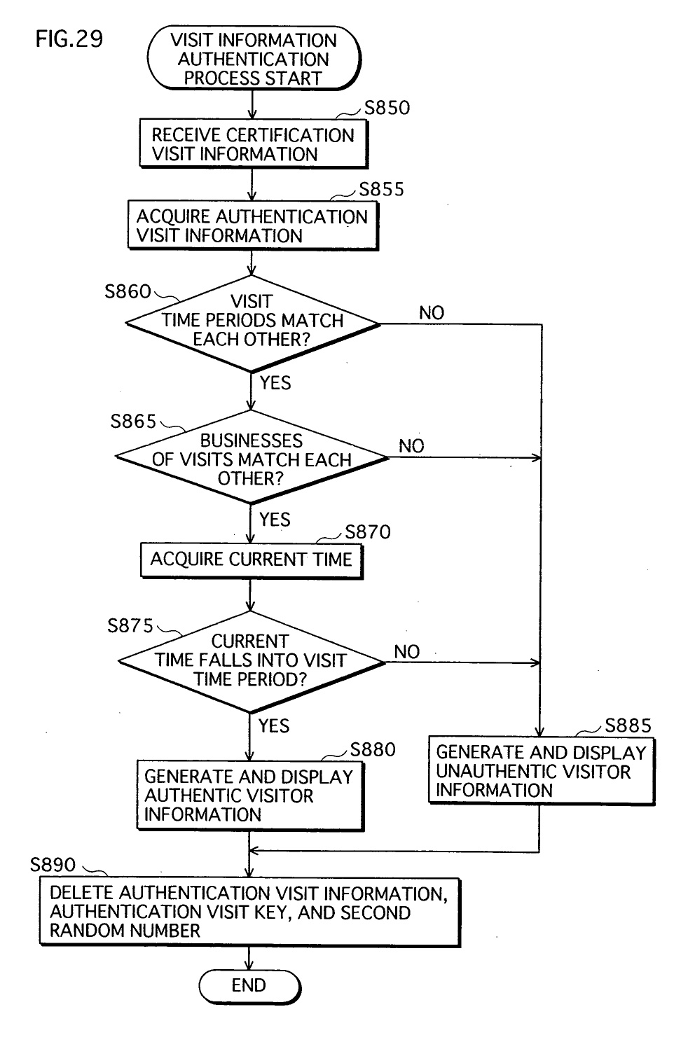

Here, the visit information authentication process that is executed in step S775 of the identity authentication process shown in FIG. 27 will be described with reference to the flowchart shown in FIG. 29.

The user terminal 20C receives the certification visit information from the authentication card 10C via the card reader 30C (step S850). The user terminal 20C then acquires the authentication visit information from the visit information storage unit 206C (step S855).

The user terminal 20C judges whether or not the authentication time information contained in the acquired authentication visit information matches the certification time information contained in the received certification visit information, that is to say, judges whether or not the visit time period received beforehand matches the visit time period stored in the authentication card 10C (step S860).

If it judges that the visit time period received beforehand matches the visit time period stored in the authentication card 10C (YES in step S860), the user terminal 20C judges whether or not the authentication business information contained in the acquired authentication visit information matches the certification business information contained in the received certification visit information, that is to say, judges whether or not the business of the visit received beforehand matches the business of the visit stored in the authentication card 10C (step S865).

If it judges that the business of the visit received beforehand matches the business of the visit stored in the authentication card 10C (YES in step S865), the user terminal 20C acquires a current time from the clock unit 207C (step S870), and judges whether or not the acquired current time falls into the visit time period indicated by the authentication time information (step S875).

If it judges that the acquired current time falls into the visit time period indicated by the authentication time information (YES in step S875), the user terminal 20C generates authentic visitor information, displays the generated authentic visitor information (step S880), and deletes the authentication visit information and the authentication visit key from the visit information storage unit 206C and the second random number “N2” from the random number storage area 250C (step S890).

If it judges that the visit time period received beforehand does not match the visit time period stored in the authentication card 10C (NO in step S860), or if it judges that the business of the visit received beforehand does not match the business of the visit stored in the authentication card 10C (NO in step S865), or if it judges that that the acquired current time does not fall into the visit time period indicated by the authentication time information (NO in step S875), the user terminal 20C generates unauthentic visitor information, displays the generated unauthentic visitor information, and deletes the authentication visit information and the authentication visit key from the visit information storage unit 206C and the second random number “N2” from the random number storage area 250C (step S890).

### 5. Summary of Embodiments

As described above, in the identity authentication system of the present invention, an authentication is performed between the authentication card and the user terminal. This construction eliminates the need to perform an authentication using a server that is connected to a network, which is a conventional method. This solves, for example, a problem that an identity of a visitor is not available due to a communication failure between the user terminal and the server.

Also, the identity authentication system of the present invention generates a random number each time an authentication is performed. This enables the encrypted information generated by the authentication card to have different contents each time an authentication is performed. This enhances the resistance characteristics against the spoofing attack that is carried out by wiretapping a communication path.

Also, in the identity authentication system of the present invention, an identity authentication key can be distributed with given timing prior to a visit to a residence of a user. This makes it possible to avoid a network loading that is caused by the distribution of an identity authentication key. That is to say, it is possible to distribute a plurality of identity authentication keys to a plurality of residences of users with different timing.

6. Modifications

The above-described Embodiments 1, 2, 3, and 4 are provided as specific examples of the present invention. The present invention is not limited to the above-described embodiments, but may be achieved in various manners within the scope of the present invention. The following, for example, should be construed as the present invention.

6.1 Modification of Communication Method

The method of performing communications between the user terminal and the authentication card is not limited to those shown in the above-described Embodiments 1, 2, 3, and 4. Another communication method may be used.

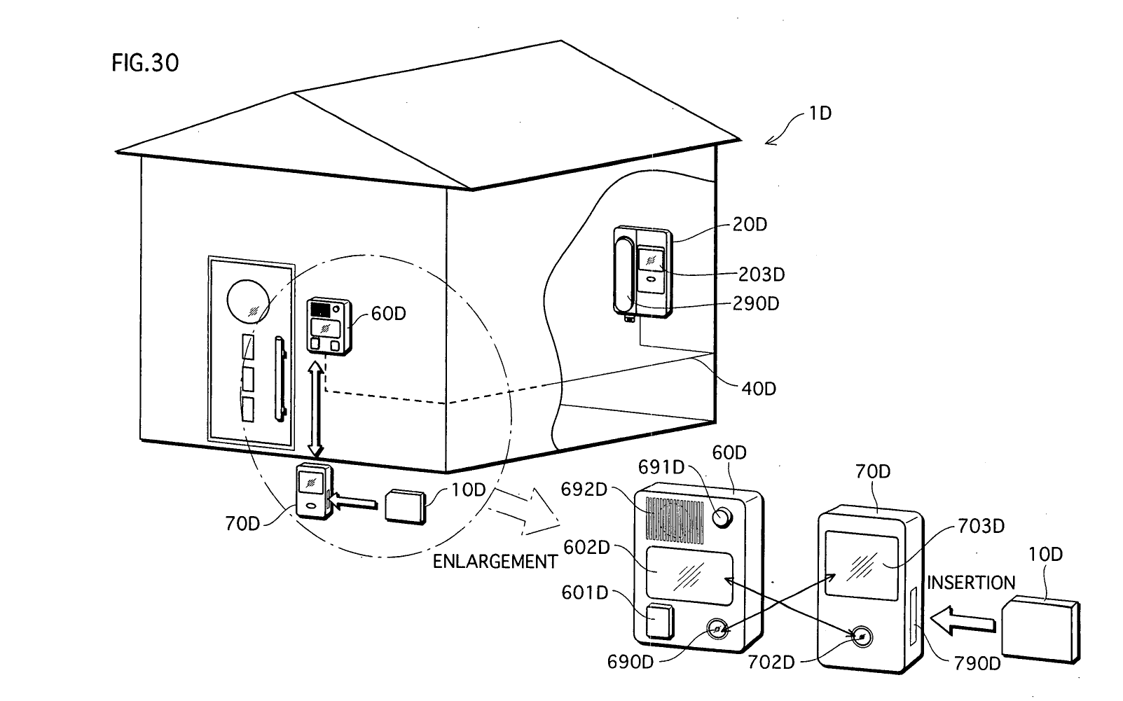

The construction of an identity authentication system 1D shown in FIG. 30, for example, may be used.

The identity authentication system 1D will be described, centering on the differences from Embodiment 1.

(A) Outline of Identity Authentication System 1D

The identity authentication system 1D is composed of an authentication card 10D, a user terminal 20D, a first input/output apparatus 60D, and a second input/output apparatus 70D to/from which the authentication card 10D is attachable and detachable. The following will describe an outline of the identity authentication system 1D, using the authentication card 10D, the user terminal 20D, the first input/output apparatus 60D, and the second input/output apparatus 70D.

The user terminal 20D is provided in a residence of a user. More specifically, the user terminal 20D is a base unit of an intercommunication system. The first input/output apparatus 60D is provided outside the residence of the user (for example, at an entrance of the residence). More specifically, the first input/output apparatus 60D is a sub-unit of the intercommunication system. The user terminal 20D and the first input/output apparatus 60D are connected to each other via a cable 40D. The user terminal 20D is provided with a receiver 290D and functions and operates as the base unit of the intercommunication system. The first input/output apparatus 60D is provided with a call button 690D, a microphone 691D, and a speaker 692D and functions and operates as a sub-unit of the intercommunication system. For example, a visitor depresses the call button 690D of the first input/output apparatus 60D to call the user inside the residence, and the user uses the receiver 290D to, over the intercommunication system, speak to the visitor, who uses the microphone 691D and the speaker 692D to speak with the user.

The first input/output apparatus 60D is provided with an image receiving unit 601D and a display unit 602D. The second input/output apparatus 70D is provided with an image receiving unit 702D and a display unit 703D. Data is input and output between the first input/output apparatus 60D and the second input/output apparatus 70D.

The identity authentication system 1D, upon insertion of the authentication card 10D into an insertion slot 790D of the second input/output apparatus 70D, performs the authentication process shown in Embodiment 1 by performing information input/output between the first input/output apparatus 60D and the second input/output apparatus 70D. It is presumed here that the information input/output between the first input/output apparatus 60D and the second input/output apparatus 70D is performed using the image information that is composed of QR code. The transfer of the image information is performed as follows. When the user terminal 20D receives the image information, the user terminal 20D receives image information displayed on the display unit 703D of the second input/output apparatus 70D, using the image receiving unit 601D of the first input/output apparatus 60D. When the authentication card 10D receives the image information, the authentication card 10D receives image information displayed on the display unit 602D of the first input/output apparatus 60D, using the image receiving unit 702D of the second input/output apparatus 70D.

(B) Construction of Authentication Card 10D

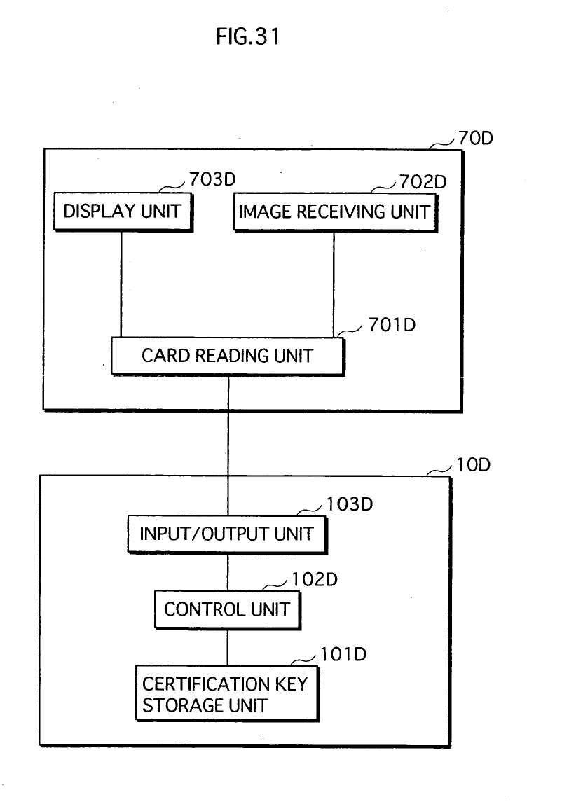

The construction of the authentication card 10D will be described. The authentication card 10D is a portable recording medium in which an IC is embedded. One specific example of the authentication card 10D is a memory card having an IC card function. As shown in FIG. 31, the authentication card 10D is composed of a certification key storage unit-101D, a control unit 102D, and an input/output unit 103D.

The authentication card 10D is specifically a computer system that includes a microprocessor, ROM, RAM and the like. A computer program is stored in the ROM. The microprocessor operates in accordance with the computer program and causes the authentication card 10D to achieve the functions.

(a) Certification Key Storage Unit 10D, Input/Output Unit 103D

The description of the certification key storage unit 101D and the input/output unit 103D is omitted since they are respectively identical with the certification key storage unit 101 and the input/output unit 103.

(b) Control Unit 102D

The control unit 102D, upon receiving, from the second input/output apparatus 70D via the input/output unit 103D, ID request information that requests a certification key ID, acquires a certification key ID from the certification key storage unit 101D. The control unit 102D generates an ID QR code using the acquired certification key ID, and outputs the generated ID QR code to the second input/output apparatus 70D via the input/output unit 103D.

Further, upon receiving, from the second input/output apparatus 70D, a random number QR code that indicates a random number “N”, the control unit 102D generates the random number “N” from the received random number QR code. The control unit 102D then acquires the identity certification key “SK1” from the certification key storage unit 101D, and generates encrypted information Enc(SK1,N) by encrypting the random number “N” generated from the received random number QR code, using the acquired identity certification key “SK1”. The control unit 102D generates an encryption QR code using the generated encrypted information, and outputs the generated encryption QR code to the second input/output apparatus 70D via the input/output unit 103D.

(C) Second Input/Output Unit 70D

The construction of the second input/output apparatus 70D will be described. As shown in FIG. 31, the second input/output apparatus 70D includes a card reading unit 701D, an image receiving unit 702D, and a display unit 703D.

The second input/output apparatus 70D is specifically a computer system that includes a microprocessor, ROM, RAM and the like. A computer program is stored in the ROM. The microprocessor operates in accordance with the computer program and causes the second input/output apparatus 70D to achieve the functions.

(a) Card Reading Unit 701D

The card reading unit 701D detects an insertion of the authentication card 10D. Upon detecting the insertion of the authentication card 10D, the card reading unit 701D generates the ID request information and outputs the generated ID request information to the authentication card 10D. Next, upon receiving the ID QR code from the authentication card 10D, the card reading unit 701D outputs the received ID QR code to the display unit 703D.

Further, upon receiving the random number QR code from the first input/output apparatus 60D via the image receiving unit 702D, the card reading unit 701D outputs the received random number QR code to the authentication card 10D. Upon receiving the encryption QR code from the authentication card 10D, the card reading unit 701D outputs the received encryption QR code to the display unit 703D.

(b) Image Receiving Unit 702D

The image receiving unit 702D is, for example, a camera, and takes an image that is displayed on the first input/output apparatus 60D, and outputs the taken image to the card reading unit 701D.

(c) Display Unit 703D

The display unit 703D is, for example, a display, and displays an image received from the card reading unit 701D.

(D) Construction of User Terminal 20D

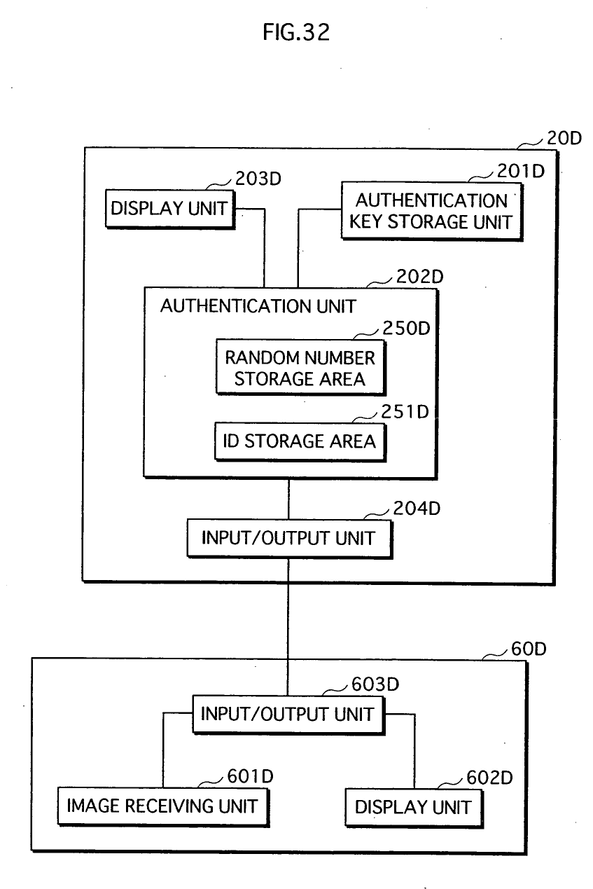

The construction of the user terminal 20D will be described. The user terminal 20D authenticates the authentication card 10D. As shown in FIG. 32, the user terminal 20D includes an authentication key storage unit 201D, an authentication unit 202D, a display unit 203D, and an input/output unit 204D.

The user terminal 20D is specifically a computer system that includes a microprocessor, ROM, RAM, a hard disk unit, a display unit and the like. A computer program is stored in the ROM or the hard disk unit. The microprocessor operates in accordance with the computer program and causes the user terminal 20D to achieve the functions.

It should be noted here that since the function of the user terminal 20D as the base unit of the intercommunication system is well known, the illustration of the construction and description of it as the base unit are omitted.

(a) Authentication Key Storage Unit 201D, Display Unit 203D

The description of the authentication key storage unit 201D and the display unit 203D is omitted since they have the same construction as the authentication key storage unit 201 and the display unit 203.

(b) Authentication Unit 202D

The authentication unit 202D includes: a random number storage area 250D for storing random numbers; and an ID storage area 251 for storing certification key IDs.

The authentication unit 202D receives an ID QR code from the first input/output apparatus 60D via the input/output unit 204D. The authentication unit 202D then generates a certification key ID from the received ID QR code, and stores the generated certification key ID into the ID storage area 251D. The authentication unit 202D then generates a random number “N” and stores the generated random number “N” into the random number storage area 250D. The authentication unit 202D also generates a random number QR code using the generated random number “N”, and outputs the generated random number QR code to the first input/output apparatus 60D via the input/output unit 204D. Further, upon receiving an encryption QR code from the first input/output apparatus 60D via the input/output unit 204D, the authentication unit 202D generates encrypted information Enc(SK1,N) using the received encryption QR code. Next, the authentication unit 202D acquires, from the authentication key storage unit 201D, an identity authentication key that corresponds to an authentication key ID that matches the certification key ID stored in the ID storage area 251D. The authentication unit 202D then decrypts the encrypted information Enc(SK1,N) using the acquired identity authentication key, and judges whether or not the decrypting result matches the random number “N” stored in the random number storage area 250D. If the decrypting result matches the random number “N”, the authentication unit 202D verifies the authenticity of the authentication card inserted in the second input/output apparatus 70D, that is to say, determines that the authentication card inserted in the second input/output apparatus 70D is authentic. And as the authentication result, the authentication unit 202D generates the authentic visitor information and outputs the generated authentic visitor information to the display unit 203D. If the decrypting result does not match the random number “N”, the authentication unit 202D determines that the authentication card inserted in the second input/output apparatus 70D is unauthentic, and as the authentication result, generates the unauthentic visitor information and outputs the generated unauthentic visitor information to the display unit 203D.

Further, the authentication unit 202D deletes the random number “N” from the random number storage area 250D, and deletes the certification key ID from the ID storage area 251D.

(c) Input/Output Unit 204D

The input/output unit 204D receives information from the first input/output apparatus 60D and outputs the information to the authentication unit 202D. Also, the input/output unit 204D receives information from the authentication unit 202D and outputs the information to the first input/output apparatus 60D.

(E) First Input/Output Apparatus 60D

The construction of the first input/output apparatus 60D will be described. The first input/output apparatus 60D, as shown in FIG. 32, includes an image receiving unit 601D, a display unit 602D, and an input/output unit 603D.

The first input/output apparatus 60D is specifically a computer system that includes a microprocessor, ROM, RAM and the like. A computer program is stored in the ROM. The microprocessor operates in accordance with the computer program and causes the first input/output apparatus 60D to achieve the functions.

It should be noted here that since the function of the first input/output apparatus 60D as the sub-unit of the intercommunication system is well known, the illustration of the construction and description of it as the sub-unit are omitted.

(a) Image Receiving Unit 601D

The image receiving unit 601D is, for example, a camera, and takes an image that is displayed on the second input/output apparatus 70D, and outputs the taken image to the user terminal 20D via the input/output unit 603D.

(b) Display Unit 602D

The display unit 602D is, for example, a display, and displays an image received from the user terminal 20D via the input/output unit 603D.

(F) Operation of Identity Authentication Process

In regards with the operation of the identity authentication process, only differences from Embodiment 1 will be described. In this modification, the operation of the card reader 30 is performed by the first input/output apparatus 60D and the second input/output apparatus 70D. Information is transferred between the first input/output apparatus 60D and the second input/output apparatus 70D as either apparatus uses its image receiving unit to take an image of the information displayed on the other apparatus.

The user terminal 20D converts information into QR code, and outputs the QR code to the authentication card 10D. Also, the user terminal 20D receives information from the authentication card 10D in the form of QR code, and acquires the original information from the received QR code.

Similarly, the authentication card 10D converts information into QR code, and outputs the QR code to the user terminal 20D. Also, the authentication card 10D receives information from the user terminal 20D in the form of QR code, and acquires the original information from the received QR code.

(G) Operation of Authentication Process

In regards with the operation of the identity authentication process, only differences from Embodiment 1 will be described. In this modification, in step S100, an encryption QR code is received from the authentication card 10D, encrypted information is generated and acquired from the received encryption QR code.

### (H) Application to Other Embodiments

Up to now, the identity authentication system 1D has been described centering on the differences from Embodiment 1. The transfer of information in the form of QR code used in the identity authentication system 1D can be applied to Embodiments 2, 3, and 4, as modifications thereof.

More specifically, the identity authentication systems may convert the information that is transferred when a visitor visits a residence of a user, and transfer the information in the form of QR code.

The application of this technology to Embodiment 3 as a modification thereof can be achieved by providing the second input/output apparatus with a fingerprint reading unit having the same construction as the fingerprint reading unit 310B. Similarly, the application of this technology to Embodiment 4 as a modification thereof can be achieved by providing the second input/output apparatus with such a fingerprint reading unit.

6.2 Modification of Authentication Method

The above-described Embodiments perform an authentication by a challenge-response system using a secret key encryption process. The following will describe an authentication by a challenge-response system using another encryption process.

(1) Using Public Key Encryption Process

Here, modifications to each Embodiment using a public key encryption process will be described.

### Modification of Embodiment 1

An identity authentication system using a public key encryption process will be described centering on differences from Embodiment 1. One example of the public key encryption process is RSA. The description of RSA is omitted here since it is well known.

The authentication card 10 stores, as a secret key, an identity certification key “SK1” in correspondence with a certification key ID.

The user terminal 20 stores a plurality of pairs of an identity authentication key, which is a public key, and an authentication key ID that identifies the identity authentication key. In the following description, it is presumed that the identity certification key “SK1” corresponds to an identity authentication key “PK1”, which is a public key.

Upon receiving the detection information and a certification key ID from the card reader 30, the user terminal 20 acquires the identity authentication key “PK1” that has been correlated with an authentication key ID that matches the received certification key ID. Then, the user terminal 20 generates a random number “N”, stores the generated random number “N” into the random number storage area 250, generates an encrypted information Enc(PK1,N) by encrypting the random number “N” using the acquired identity authentication key “PK1”, and outputs the generated encrypted information Enc(PK1,N) to the authentication card 10 via the card reader 30.

Upon receiving the encrypted information Enc(PK1,N) from the user terminal 20, the authentication card 10 decrypts the received encrypted information Enc(PK1,N) using the stored identity certification key “SK1”, and outputs the decrypting result to the user terminal 20 via the card reader 30.

Upon receiving the decrypting result from the authentication card 10, the user terminal 20 judges whether or not the received decrypting result matches the stored random number “N”. If it judges that the decrypting result matches the random number “N”, the user terminal 20 verifies the authenticity of the authentication card inserted in the card reader 30, generates the authentic visitor information, and displays the generated authentic visitor information. If it judges that the decrypting result does not match the random number “N”, the user terminal 20 determines that the authentication card inserted in the card reader 30 is unauthentic, generates the unauthentic visitor information, and displays the generated unauthentic visitor information. The user terminal 20 then deletes the random number “N” from the random number storage area 250, and deletes information and data from the random number storage area 250.

### Modification of Embodiment 2

The following description will be provided centering on differences from Embodiment 2. The authentication card 10A stores in the authentication key storage unit 201A an identity certification key “SK1” as a secret key. The user terminal 20A stores an identity authentication key “PK1” that is a public key having been distributed from the distribution apparatus 50A in advance. The operation in the authentication process is as follows. Upon receiving the detection information from the card reader 30A, the user terminal 20A acquires the identity authentication key “PK1” from the authentication key storage unit 201A. The user terminal 20A then generates the random number “N”, stores the generated random number “N” into the random number storage area 250A, generates an encrypted information Enc(PK1,N) by encrypting the generated random number “N” using the acquired identity authentication key “PK1”, and outputs the generated encrypted information Enc(PK1,N) to the authentication card 10A via the card reader 30A. The description of the operation succeeding to this is omitted here since it is the same as has been described earlier. It should be noted here that after the authentication process is completed, the random number “N” is deleted from the random number storage area 250A, and the identity authentication key “PK1” is deleted from the authentication key storage unit 201A.

### Modification of Embodiment 3

The following description will be provided centering on differences from Embodiment 3. In this modification, the ID encryption, which allows the public key to be set freely, is used. The ID encryption used here is a public key encryption process based on the ID information. The following provides a specific example of such a case. It is presumed here that the ID information is information composed of characteristic points of the fingerprint pattern. The description of the public key encryption process based on the ID information is omitted here since it is well known. For details of the public key encryption process based on the ID information, refer to A. Shamir, “Identity-Based cryptosystems and signature schemes” (In Advances in Cryptology-CRYPTO'84, Springer-Verlag LNCS 196, 47-53, 1984).

The identity authentication system 1B further includes a server apparatus to/from which the authentication card 10B is attachable and detachable. The server apparatus includes a server fingerprint reading unit that operates in the same manner as the fingerprint reading unit 310B. The server apparatus, while the authentication card 10B is attached to it, uses the server fingerprint reading unit to read a fingerprint pattern of a visitor who holds the authentication card 10B, and generates fingerprint information that is composed of characteristic points of the read fingerprint pattern. The server apparatus then generates, using the generated fingerprint information and an algorithm for generating a secret key, an identity certification key “SK” as a secret key that corresponds to the generated fingerprint information, and writes the generated identity certification key “SK” into the certification key storage unit 101B of the authentication card 10B.

Upon detection of an insertion of the authentication card 10B, the card reader 30B displays the request information, receives a fingerprint of the visitor via the fingerprint reading unit 310B, generates identity authentication fingerprint information that is composed of characteristic points of the fingerprint pattern of the received fingerprint, and outputs the generated identity authentication fingerprint information and the detection information to the user terminal 20B.

Upon receiving the identity authentication fingerprint information and the detection information from the card reader 30B, the user terminal 20B generates, using the received identity authentication fingerprint information and an algorithm for generating a public key, a public key “PK” that corresponds to the identity authentication fingerprint information, and stores the generated public key “PK” into the authentication key storage unit 201B. Further, the user terminal 20B generates the random number “N”, stores the generated random number “N” into the random number storage area 250B, generates an encrypted information Enc(PK,N) by encrypting the generated random number “N” using the generated public key “PK”, and outputs the generated encrypted information Enc(PK,N) to the authentication card 10B via the card reader 30B. The description of the operation succeeding to this is omitted here since it is the same as has been described earlier. It should be noted here that after the authentication process is completed, the random number “N” is deleted from the random number storage area 250B.

As described above, it is possible to achieve an authentication method that uses biometrics information and a public key encryption process.

### Modification of Embodiment 4

The description of this modification is omitted here since it is similar to the above-described modification of Embodiment 3. It should be noted here that if an authentication card inserted in the card reader 30C is determined to be authentic, the identity authentication system 1C performs the visit key authentication process and after.

(2) Using Different Digital Signature for Each Authentication

Here, modifications to each Embodiment using a different digital signature for each authentication will be described.

### Modification of Embodiment 1

An identity authentication system using a different digital signature for each authentication will be described centering on differences from Embodiment 1. One example of the digital signature is the El Gamal signature on a finite field. The description of the El Gamal signature on a finite field is omitted here since it is well known.

The authentication card 10 stores, as a secret key, an identity certification key “SK1” in correspondence with a certification key ID.

The user terminal 20 stores, in the authentication key storage unit 201, a plurality of pairs of an identity authentication key, which is a public key, and an authentication key ID that identifies the identity authentication key. In the following description, it is presumed that the identity certification key “SK1” corresponds to an identity authentication key “PK1”, which is a public key.

Upon receiving the detection information and a certification key ID from the card reader 30, the user terminal 20 stores the received certification key ID into the ID storage area 251. The user terminal 20 then generates a random number “N”, stores the generated random number “N” into the random number storage area 250, and outputs the generated random number “N” to the authentication card 10 via the card reader 30.

Upon receiving the random number “N” from the user terminal 20, the authentication card 10 generates a digital signature of the received random number “N” using the stored identity certification key “SK1”, and outputs the generated digital signature to the user terminal 20 via the card reader 30.

Upon receiving the digital signature from the authentication card 10, the user terminal 20 acquires, from the authentication key storage unit 201, an identity authentication key “PK1” that corresponds to an authentication key ID that matches the certification key ID stored in the ID storage area 251. The user terminal 20 then performs a signature verification on the received digital signature using the acquired identity authentication key “PK1” and the random number “N”. Here, the signature verification is an algorithm for verifying whether or not a digital signature is authentic. If it judges that the digital signature is authentic, the user terminal 20 verifies the authenticity of the authentication card inserted in the card reader 30, generates the authentic visitor information, and displays the generated authentic visitor information. If it judges that the digital signature is not authentic, the user terminal 20 determines that the authentication card inserted in the card reader 30 is unauthentic, generates the unauthentic visitor information, and displays the generated unauthentic visitor information. The user terminal 20 then deletes the random number “N” from the random number storage area 250, and deletes the certification key ID from the ID storage area 251.

### Modification of Embodiment 2

The following description will be provided centering on differences from Embodiment 2. The authentication card 10A stores in the authentication key storage unit 201A an identity certification key “SK1” as a secret key. The user terminal 20A stores an identity authentication key “PK1” that is a public key having been distributed from the distribution apparatus 50A in advance. The operation in the authentication process is as follows. Upon receiving the detection information from the card reader 30A, the user terminal 20A generates a random number “N”, stores the generated random number “N” into the random number storage area 250A, and outputs the generated random number “N” to the authentication card 10A via the card reader 30A.

Then, similarly to the above-described operation, the authentication card 10A generates a digital signature of the received random number “N”, and outputs the generated digital signature to the user terminal 20A. The user terminal 20A performs a signature verification on the received digital signature using an identity authentication key “PK1”, which has been distributed in advance, and the random number “N”. The description of the operation succeeding to this is omitted here since it is the same as has been described earlier. It should be noted here that after the authentication process is completed, the random number “N” is deleted from the random number storage area 250A, and the identity authentication key “PK1” is deleted from the authentication key storage unit 201A.

### Modification of Embodiment 3

The following description will be provided centering on differences from Embodiment 3. In this modification, the ID signature, which allows the public key to be set freely, is used. The ID signature used here is a digital signature method based on the ID information. It is presumed here that the ID information is information composed of characteristic points of the fingerprint pattern. The description of the ID signature is omitted here since it is well known. For details of the ID signature, refer to A. Shamir, “Identity-Based cryptosystems and signature schemes” (In Advances in Cryptology-CRYPTO'84, Springer-Verlag LNCS 196, 47-53, 1984).

The following provides a specific example of a case where the ID signature is used.

The identity authentication system 1B further includes a server apparatus to/from which the authentication card 10B is attachable and detachable. The server apparatus includes a server fingerprint reading unit that operates in the same manner as the fingerprint reading unit 310B. The server apparatus, while the authentication card 10B is attached to it, uses the server fingerprint reading unit to read a fingerprint pattern of a visitor who holds the authentication card 10B, and generates fingerprint information that is composed of characteristic points of the read fingerprint pattern. The server apparatus then generates, using the generated fingerprint information and an algorithm for generating a secret key, an identity certification key “SK” as a secret key that corresponds to the generated fingerprint information, and writes the generated identity certification key “SK” into the certification key storage unit 101B of the authentication card 10B.

Upon detection of an insertion of the authentication card 10B, the card reader 30B displays the request information, receives a fingerprint of the visitor via the fingerprint reading unit 310B, generates identity authentication fingerprint information that is composed of characteristic points of the fingerprint pattern of the received fingerprint, and outputs the generated identity authentication fingerprint information and the detection information to the user terminal 20B.

Upon receiving the identity authentication fingerprint information and the detection information from the card reader 30B, the user terminal 20B writes the received identity authentication fingerprint information into the authentication key storage unit 201B. The user terminal 20B then generates a random number “N”, outputs the generated random number “N” to the authentication card 10B via the card reader 30B, and stores the generated random number “N” into the random number storage area 250B.

Upon receiving the random number “N” from the user terminal 20, the authentication card 10 generates a digital signature of the received random number “N” using the stored identity certification key “SK1”, and outputs the generated digital signature to the user terminal 20 via the card reader 30.

Upon receiving the digital signature from the authentication card 10B, the user terminal 20B acquires, from the authentication key storage unit 201B, the identity authentication fingerprint information, and generates, using the acquired identity authentication fingerprint information and an algorithm for generating a public key, a public key “PK” that corresponds to the identity authentication fingerprint information. The user terminal 20B then performs a signature verification on the received digital signature using the generated identity authentication key “PK” and the random number “N”.

The description of the operation succeeding to this is omitted here since it is the same as has been described earlier.

### Modification of Embodiment 4

The description of this modification is omitted here since it is similar to the above-described modification of Embodiment 3. It should be noted here that if an authentication card inserted in the card reader 30C is determined to be authentic, the identity authentication system 1C performs the visit key authentication process and after.

(3) Using Fixed Digital Signature

Here, modifications to each Embodiment using a fixed digital signature will be described.

### Modification of Embodiment 12

An identity authentication system using a fixed digital signature will be described centering on differences from Embodiment 1. One example of the digital signature is the El Gamal signature on a finite field. The description of the El Gamal signature on a finite field is omitted here since it is well known.

The identity authentication system 1 further includes a server apparatus to/from which the authentication card 10 is attachable and detachable. The server apparatus stores, in correspondence with a certification key ID, a secret key “SK” that is used to generate a digital signature as an identity certification key. The authentication card 10 stores an identifier “ID” for identifying the authentication card 10, instead of storing a certification key ID and an identity certification key.

The user terminal 20 stores, in the authentication key storage unit 201, a public key “PK” as an identity authentication key in correspondence with an authentication key ID, instead of storing an authentication key ID and an identity authentication key.

The server apparatus, while the authentication card 10 is attached to it, acquires the identifier “ID” stored in the authentication card 10, generates a digital signature of the acquired identifier “ID” using the stored secret key “SK”, and writes into the authentication card 10 the generated digital signature and a certification key ID that corresponds to the secret key “SK”.

Upon detection of an insertion of the authentication card 10, the card reader 30 reads the digital signature, the certification key ID, and the identifier “ID” from the authentication card 10, and outputs the read digital signature, certification key ID, and identifier “ID” to the user terminal 20.

Upon receiving the digital signature, certification key ID, and identifier “ID”, the user terminal 20 acquires, from the authentication key storage unit 201, a public key “PK” that corresponds to an authentication key ID that matches the received certification key ID, and performs a signature verification on the received digital signature using the acquired public key “PK” and the received identifier “ID”. Here, the signature verification is an algorithm for verifying whether or not a digital signature is authentic. If it judges that the digital signature is authentic, the user terminal 20 verifies the authenticity of the authentication card inserted in the card reader 30, generates the authentic visitor information, and displays the generated authentic visitor information. If it judges that the digital signature is not authentic, the user terminal 20 determines that the authentication card inserted in the card reader 30 is unauthentic, generates the unauthentic visitor information, and displays the generated unauthentic visitor information.

### Modification of Embodiment 2

The following description will be provided centering on differences from Embodiment 2. The identity authentication system 1A further includes a server apparatus that operates in the same manner as described above. The distribution apparatus 50A stores a public key “PK” and distributes it to the user terminal 20A, instead of storing an identity authentication key and distributing it to the user terminal 20A. The authentication card 10A stores an identifier “ID” for identifying the authentication card 10A, instead of storing an identity certification key. The user terminal 20A stores the public key “PK” that is distributed from the distribution apparatus 50A in advance, instead of storing the identity authentication key that is distributed from the distribution apparatus 50A in advance.

The description of the operation is omitted here since it is the same as described above. It should be noted here that the distribution apparatus 50A and the server apparatus may be a same apparatus.

### Modification of Embodiment 3

The following description will be provided centering on differences from Embodiment 3. In this modification, the ID signature, which allows the public key to be set freely, is used. The ID signature used here is a digital signature method based on the ID information. It is presumed here that the ID information is information composed of characteristic points of the fingerprint pattern. The following provides a specific example of a case where the ID signature is used.

The identity authentication system 1B further includes a server apparatus to/from which the authentication card 10B is attachable and detachable. The server apparatus includes a server fingerprint reading unit that operates in the same manner as the fingerprint reading unit 310B. The authentication card 10B stores an identifier “ID” for identifying the authentication card 10B, instead of storing a certification key ID and an identity certification key.

The server apparatus, while the authentication card 10B is attached to it, uses the server fingerprint reading unit to read a fingerprint pattern of a visitor who holds the authentication card 10B, and generates fingerprint information that is composed of characteristic points of the read fingerprint pattern. The server apparatus then generates, using the generated fingerprint information and an algorithm for generating a secret key, a secret key “SK” that corresponds to the generated fingerprint information. The server apparatus further acquires the identifier “ID” from the authentication card 10B, generates a digital signature of the acquired identifier “ID” using the generated secret key “SK”, and writes the generated digital signature into the authentication card 10B.

Upon detection of an insertion of the authentication card 10B, the card reader 30B displays the request information, receives a fingerprint of the visitor via the fingerprint reading unit 310B, and generates identity authentication fingerprint information that is composed of characteristic points of the fingerprint pattern of the received fingerprint. The card reader 30B further reads the digital signature and the identifier “ID” from the authentication card 10B, and outputs the read digital signature and identifier “ID”, and the generated identity authentication fingerprint information to the user terminal 20B.

Upon receiving the digital signature, identifier “ID”, and identity authentication fingerprint information from the card reader 30B, the user terminal 20B generates a public key “PK” that corresponds to the identity authentication fingerprint information, using the received identity authentication fingerprint information and an algorithm for generating a public key. The user terminal 20B then performs a signature verification on the received digital signature using the generated public key “PK” and the received identifier “ID”. The description of the operation succeeding to this is omitted here since it is the same as described above.

### Modification of Embodiment 4

The description of this modification is omitted here since it is similar to the above-described modification of Embodiment 3. It should be noted here that if an authentication card inserted in the card reader 30C is determined to be authentic, the identity authentication system 1C performs the visit key authentication process and after.

(4) Using Secret Key and One-Way Function

First, the one-way function will be described. The one-way function is a function that outputs a secret key that is different from an input secret key, and does not generate the input secret key from the output secret key. The one-way function always outputs a same value in so far as a same value is input.

### Modification of Embodiment 1

An identity authentication system using a secret key and a one-way function will be described centering on differences from Embodiment 1.

The authentication card 10 stores, in correspondence with a certification key ID, a certification secret key “f_1(SK1)” that is generated by executing a one-way function “f_1” on an identity certification key “SK1”.

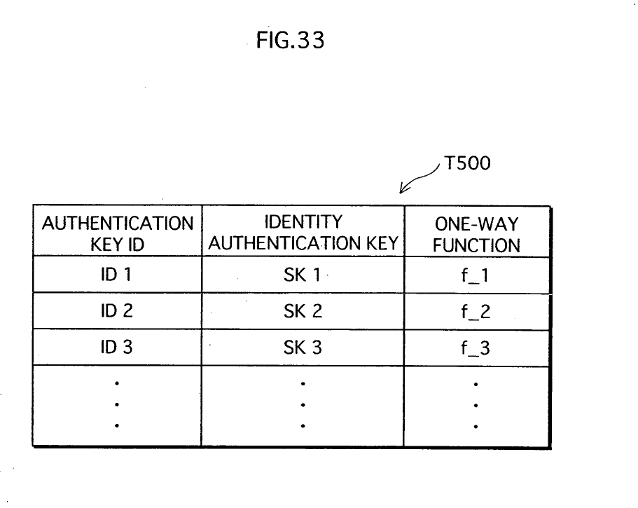

The user terminal 20 includes a key information table T500, on example of which is shown in FIG. 33. The key information table T500 stores a plurality of sets of an identity authentication key, an authentication key ID for identifying the identity authentication key, and a one-way function. The description of the identity authentication key and the authentication key ID is omitted here since they are the same as those described in Embodiment 1. The one-way function is a function that generates, from a corresponding identity authentication key, an authentication secret key that is required in an authentication of the authentication card 10.

Upon receiving the detection information and a certification key ID from the card reader 30, the user terminal 20 acquires a one-way function and an identity authentication key that corresponds to an authentication key ID that matches the certification key ID. The user terminal 20 then generates an authentication secret key by executing the acquired one-way function on the acquired identity authentication key, and temporarily stores the generated authentication secret key. The user terminal 20 then generates a random number “N”, stores the generated random number “N” into the random number storage area 250, and outputs the generated random number “N” to the authentication card 10 via the card reader 30.

Upon receiving the random number “N” from the user terminal 20, the authentication card 10 generates encrypted information Enc(f_1(SK1),N)by encrypting the received random number“N” using the stored certification secret key “f_1(SK1)”. The authentication card 10 outputs the generated encrypted information Enc(f_1(SK1),N) to the user terminal 20 via the card reader 30.

Upon receiving the encrypted information Enc(f_1(SK1),N) from the authentication card 10, the user terminal 20 decrypts the received encrypted information Enc(f_1(SK1),N) using the temporarily stored authentication secret key, and judges whether or not the decrypting result matches the random number “N” stored in the random number storage area 250.

The description of the operation succeeding to this is omitted here since it is the same as has been described in Embodiment 1.

In this modification, the user terminal 20 generates the authentication secret key before the random number is generated. However, not limited to this, the user terminal 20 may generate the authentication secret key after it receives the encrypted information.

### Modification of Embodiment 2

The following description will be provided centering on differences from Embodiment 2. The authentication card 10A stores a certification secret key “f_1(SK1)” in the authentication key storage unit 201A. The user terminal 20A stores a one-way function and a secret key that has been distributed from the distribution apparatus 50A in advance. The operation in the authentication process will be described. Upon receiving the detection information from the card reader 30A, the user terminal 20A generates an authentication secret key by executing the stored one-way function on the stored secret key, and temporarily stores the generated authentication secret key. The user terminal 20A then generates a random number “N”, outputs the generated random number “N” to the card reader 30A via the input/output unit 204A, and stores the generated random number “N” into the random number storage area 250A.

Upon receiving the random number “N” from the user terminal 20A, the authentication card 10A generates encrypted information Enc(f_1(SK1),N) by encrypting the received random number “N” using the stored certification secret key “f_1(SK1)”. The authentication card 10A outputs the generated encrypted information Enc(f_1(SK1),N) to the user terminal 20A via the card reader 30A.

Upon receiving the encrypted information Enc(f_1(SK1),N) from the card reader 30A, the user terminal 20A decrypts the received encrypted information Enc(f_1(SK),N) using the stored authentication secret key, and judges whether or not the decrypting result matches the random number “N” stored in the random number storage area 250A.

The description of the operation succeeding to this is omitted here since it is the same as has been described in Embodiment 2.

In this modification, the user terminal 20A generates the authentication secret key before the random number is generated. However, not limited to this, the user terminal 20A may generate the authentication secret key after it receives the encrypted information.

### Modification of Embodiment 3

The following description will be provided centering on differences from Embodiment 3.

The authentication card 10B stores a certification secret key “f_1(SK1)” that is generated by executing a one-way function “f_1” on a piece of identity certification fingerprint information (that is to say, an identity certification key “SK1”) that corresponds to a visitor. The authentication card 10B stores the certification secret key “f_1(SK1)” in correspondence with a certification function ID (for example, “ID_1”) for identifying a one-way function used to generate the certification secret key.

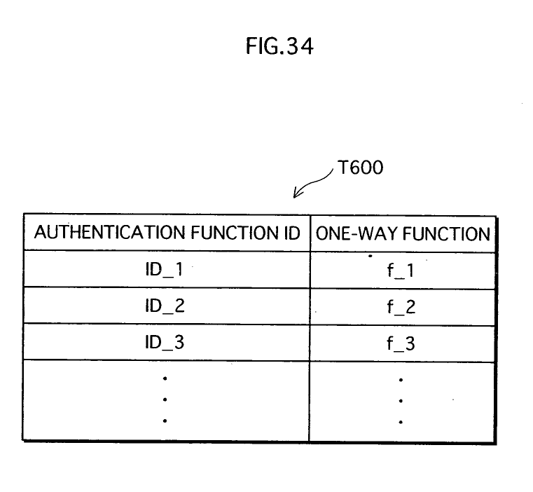

Also, the user terminal 20B includes an information table T600, on example of which is shown in FIG. 34. The information table T600 stores a plurality of pairs of a one-way function and an authentication function ID for identifying the one-way function. The one-way function is a function that generates an authentication secret key that is required in an authentication of the authentication card 10B. The authentication function ID is an identifier for identifying a one-way function, and is identical with a certification function ID. With this arrangement, it is possible to correlate a one-way function used to generate a certification function ID with a one-way function stored in the information table.

Upon detection of an insertion of the authentication card 10B, the card reader 30B displays the request information, receives a fingerprint of the visitor via the fingerprint reading unit 310B, generates identity authentication fingerprint information that is composed of characteristic points of the fingerprint pattern of the received fingerprint, and outputs the generated identity authentication fingerprint information and the detection information to the user terminal 20B.

Upon receiving the identity authentication fingerprint information and the detection information from the card reader 30B, the user terminal 20B writes the received identity authentication fingerprint information into the authentication key storage unit 201B. Then, the authentication unit 202B generates the random number “N”, outputs the generated random number “N” to the card reader 30B via the input/output unit 204B, and stores the generated random number “N” into the random number storage area 250B.

Upon receiving the random number “N” from the user terminal 20B, the authentication card 10B generates encrypted information Enc(f_1(SK),N) by encrypting the received random number “N” using the stored certification secret key “f_1(SK1)”. The authentication card 10B outputs the generated encrypted information Enc(f_1(SK1),N) and the certification key ID “ID_1” to the user terminal 20B via the card reader 30B.

Upon receiving the encrypted information Enc(f_1(SK1),N) and the certification key ID “ID_1” from the card reader 30B via the input/output unit 204B, the user terminal 20B acquires a one-way function that corresponds to an authentication ID that matches a certification key ID. The user terminal 20B generates an authentication secret key by executing the acquired one-way function on the stored identity authentication fingerprint information, decrypts the received encrypted information Enc(f_1(SK1),N) using the generated authentication secret key, and judges whether or not the decrypting result matches the random number “N” stored in the random number storage area 250B.

The description of the operation succeeding to this is omitted here since it is the same as has been described in Embodiment 3.

In this modification, the user terminal 20B generates the authentication secret key after it receives the encrypted information. However, not limited to this, the user terminal 20B may acquire a certification key ID from the authentication card 10B before generating a random number, and generate an authentication secret key using a one-way function that corresponds to an authentication key ID that matches the acquired certification key ID.

### Modification of Embodiment 4

The description of this modification is omitted here since it is similar to the above-described modification of Embodiment 3.

(5) Using Public Key Certificate

First, the public key certificate will be described. The public key certificate is a proof of validity for a public key generated by, for example, the home-visit company, and is issued by a Certificate Authority (CA), which is a third party.

The public key certificate includes a public key generated by the home-visit company, an ID of the public key certificate, and a certificate signature that is a signature of the CA for these items. Here, the certificate signature is signature data that is generated by performing a digital signing using a secret key (SK_CA) that is held only by the CA. One example of the digital signing is a digital signing that uses the Rivest Shamir Adleman (RSA) in which a hash function is used.

The following describes an identity authentication system 1000 that uses the public key certificate.

The identity authentication system 1000 is composed of an authentication card 1010, a user terminal 1020, and a card reader 1030.

(a) Authentication Card 1010

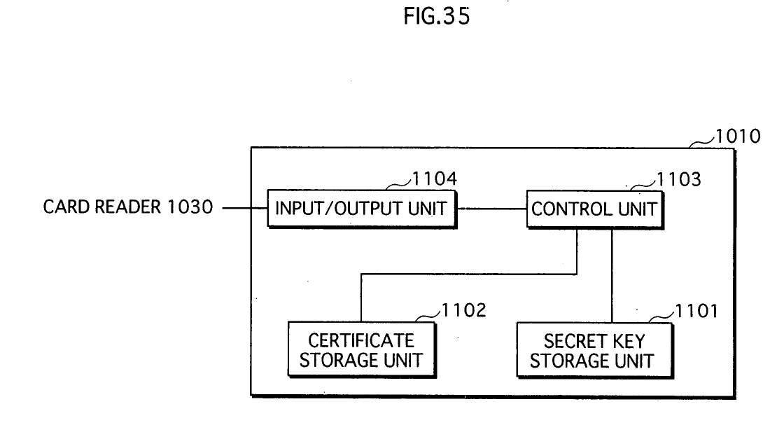

The construction of the authentication card 1010 will be described. The authentication card 1010 is a portable recording medium in which an IC is embedded. One specific example of the authentication card 1010 is a memory card having an IC card function. As shown in FIG. 35, the authentication card 1010 is composed of a secret key storage unit 1101, a certificate storage unit 1102, a control unit 1103, and an input/output unit 1104.

The authentication card 1010 is specifically a computer system that includes a microprocessor, ROM, RAM and the like. A computer program is stored in the ROM. The microprocessor operates in accordance with the computer program and causes the authentication card 1010 to achieve the functions.

(Secret Key Storage Unit 1101)

The secret key storage unit 1101 is tamper-resistant, and stores a secret key. The secret key stored here is a key that is unique to the home-visit company. The secret key is used to verify the authenticity of the authentication card 1010 itself, and is managed securely by the home-visit company.

In the following description, a secret key “SK1” is used as necessary.

(Certificate Storage Unit 1102)

The certificate storage unit 1102 stores a public key certificate that shows the authenticity of a public key “PK1” that corresponds to the secret key “SK1” stored in the secret key storage unit 1101.

(Control Unit 1103)

The control unit 1103, upon receiving, from the card reader 1030 via the input/output unit 1104, certificate request information that requests a public key certificate, acquires a public key certificate from the certificate storage unit 1102, and outputs the acquired public key certificate to the card reader 1030 via the input/output unit 1104.

Further, upon receiving encrypted information Enc(PK1,N) which has been generated by encrypting a random number “N” using the public key “PK1”, from the user terminal 1020 via the card reader 1030, the control unit 1103 acquires the secret key “SK1” from the secret key storage unit 1101, and decrypts the received encrypted information Enc(PK1,N) using the acquired secret key “SK1”. The control unit 1103 outputs the decrypting result to the card reader 1030 via the input/output unit 1104.

(Input/Output Unit 1104)

The input/output unit 1104 receives information from the card reader 1030 and outputs the information to the control unit 1103. Also, the input/output unit 1104 receives information from the control unit 1103 and outputs the information to the card reader 1030.

(b) Construction of User Terminal 1020

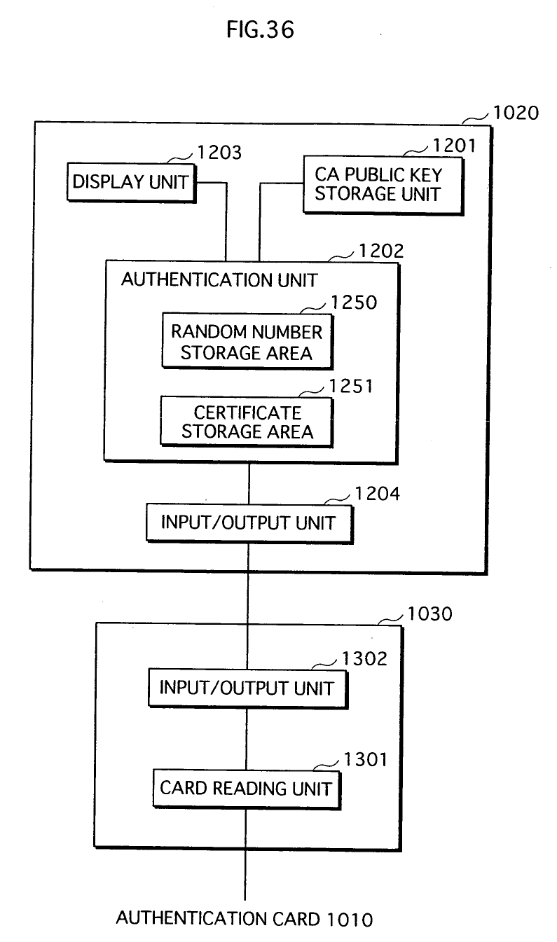

The construction of the user terminal 1020 will be described. The user terminal 1020 authenticates the authentication card 1010 inserted in the card reader 1030. As shown in FIG. 36, the user terminal 1020 includes a CA public key storage unit 1201, an authentication unit 1202, a display unit 1203, and an input/output unit 1204.

The user terminal 1020 is specifically a computer system that includes a microprocessor, ROM, RAM, a hard disk unit, a display unit and the like. A computer program is stored in the ROM or the hard disk unit. The microprocessor operates in accordance with the computer program and causes the user terminal 1020 to achieve the functions.

(CA Public Key Storage Unit 1201)

The CA public key storage unit 1201 is tamper-resistant, and stores a public key (PK_CA) that corresponds to the secret key (SK_CA) that is held only by the CA.

(Authentication Unit 1202)

The authentication unit 1202 includes: a random number storage area 1250 for storing random numbers; and a certificate storage area 1251 for storing public key certificates.

The authentication unit 1202 receives, from the card reader 1030 via the input/output unit 1204, (i) detection information that indicates detection of an insertion of the authentication card 1010 into the card reader 1030, and (ii) a public key certificate stored in the authentication card 1010.

The authentication unit 1202 reads the public key (PK_CA) from the CA public key storage unit 1201, and performs a signature verification on the certificate signature contained in the received public key certificate, using the read public key (PK_CA). If it judges, from the result of the signature verification, that the received public key certificate is authentic, the authentication unit 1202 stores the received public key certificate in the certificate storage area 1251.

The authentication unit 1202 generates a random number “N”, and stores the generated random number “N” in the random number storage area 1250.

The authentication unit 1202 acquires the public key “PK1” that is contained in the public key certificate stored in the certificate storage area 1251, generates encrypted information Enc(PK1,N) by encrypting the generated random number “N” using the acquired public key “PK1”,and outputs the generated encrypted information Enc(PK1,N) to the card reader 1030 via the input/output unit 1204.

Further, the authentication unit 1202 receives a decrypting result of encrypted information Enc(SK1,N) from the card reader 1030 via the input/output unit 1204, and judges whether or not the decrypting result matches the random number “N” stored in the random number storage area 1250.

If the decrypting result matches the random number “N”, the authentication unit 1202 verifies the authenticity of the authentication card inserted in the card reader 1030, and as the authentication result, the authentication unit 1202 generates authentic visitor information that indicates that the visitor is an authentic visitor, and outputs the generated authentic visitor information to the display unit 1203. If the decrypting result does not match the random number “N”, the authentication unit 1202 determines that the authentication card inserted in the card reader 1030 is unauthentic, and as the authentication result, generates unauthentic visitor information that indicates that the visitor is an unauthentic visitor, and outputs the generated unauthentic visitor information to the display unit 1203. Further, the authentication unit 1202 deletes the random number “N” from the random number storage area 1250, and deletes the public key certificate from the certificate storage area 1251.

Also, if it judges that the received public key certificate is not authentic, the authentication unit 1202 generates the unauthentic visitor information, outputs the generated unauthentic visitor information to the display unit 1203, and ends the operation.

(Display Unit 1203)

The display unit 1203 is provided with, for example, a display, and displays information of the authentication result received from the authentication unit 1202, toward outside.

(Input/Output Unit 1204)

The input/output unit 1204 receives information from the card reader 1030 and outputs the information to the authentication unit 1202. Also, the input/output unit 1204 receives information from the authentication unit 1202 and outputs the information to the card reader 1030.

(c) Card Reader 1030

The card reader 1030, as shown in FIG. 36, includes a card reading unit 1301 and an input/output unit 1302.

The card reader 1030 is specifically a computer system that includes a microprocessor, ROM, RAM and the like. A computer program is stored in the ROM. The microprocessor operates in accordance with the computer program and causes the card reader 1030 to achieve the functions.

(Card Reading Unit 1301)

The card reading unit 1301 detects an insertion of the authentication card 1010. Upon detecting the insertion of the authentication card 1010, the card reading unit 1301 generates the detection information and the certificate request information, and outputs the generated certificate request information to the authentication card 1010. Then, upon receiving a public key certificate from the authentication card 1010, the card reading unit 1301 outputs the received public key certificate and the generated detection information to the user terminal 1020 via the input/output unit 1302.

Further, upon receiving the random number “N” from the user terminal 1020 via the input/output unit 1302, the card reading unit 1301 outputs the received random number “N” to the authentication card 1010. Upon receiving the encrypted information Enc(SK1,N) from the authentication card 1010, the card reading unit 1301 outputs the received encrypted information Enc(SK1,N) to the user terminal 1020 via the input/output unit 1302.

(Input/Output Unit 1302)

The input/output unit 1302 receives information from the user terminal 1020 and outputs the information to the card reading unit 1301. Also, the input/output unit 1302 receives information from the card reading unit 1301 and outputs the information to the user terminal 1020.

(d) Operation of Identity Authentication Process

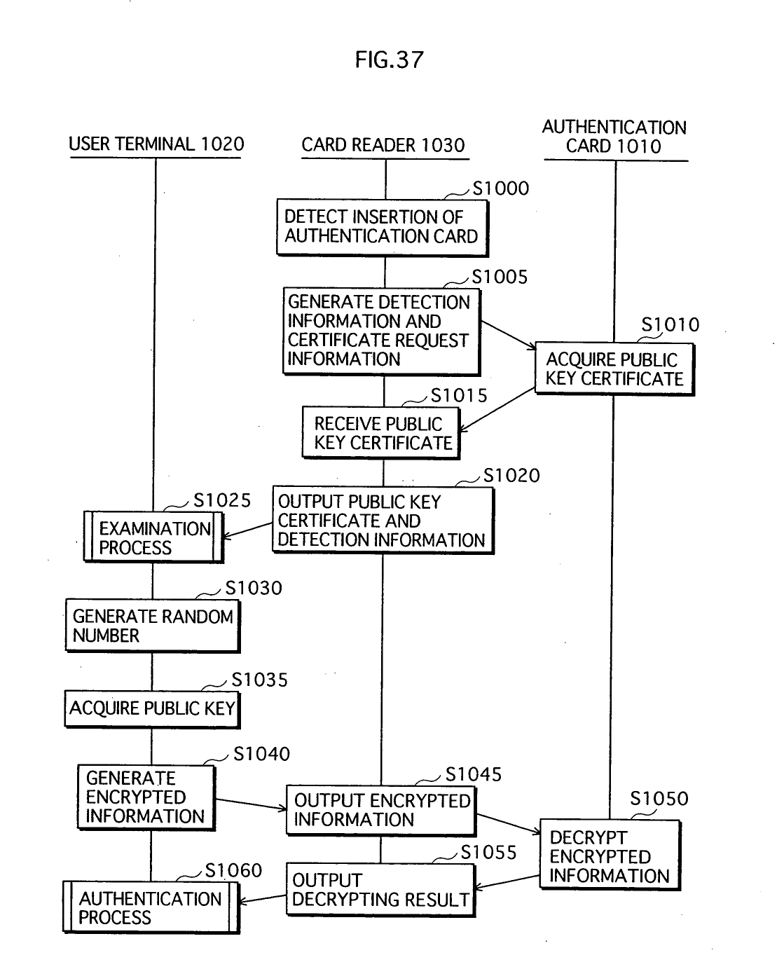

The identity authentication process is a process in which after the authentication card 1010 is inserted into the card reader 1030, the user terminal 1020 authenticates the identity. The identity authentication process will be described with reference to the flowchart shown in FIG. 37.

When the card reader 1030 detects an insertion of the authentication card 1010 (step S1000), the card reader 1030 generates the detection information and the certificate request information, and outputs the generated certificate request information to the authentication card 1010 (step S1005).

Upon receiving the certificate request information from the card reader 1030, the authentication card 1010 acquires the public key certificate stored in the certificate storage unit 1102, and outputs the acquired public key certificate to the card reader 1030 (step S1010).

Upon receiving the public key certificate from the authentication card 1010 (step S1015), the card reader 1030 outputs the received public key certificate and the detection information generated in step S1005 to the user terminal 1020 (step S1020).

Upon receiving the public key certificate and detection information from the card reader 1030, the user terminal 1020 performs an examination process to judge whether or not the received public key certificate is authentic (step S1025). Then, if the received public key certificate is authentic, the user terminal 1020 generates the random number “N” and stores the generated random number “N” in the random number storage area 1250 (step S1030). The user terminal 1020 then acquires the public key “PK1” that is contained in the public key certificate (step S1035), generates encrypted information Enc(PK1,N) by encrypting the generated random number “N”, and outputs the generated encrypted information Enc(PK1,N) to the card reader 1030 (step S1040).

Upon receiving the encrypted information Enc(PK1,N) from the user terminal 1020, the card reader 1030 outputs the received encrypted information Enc(PK1,N) to the authentication card 1010 (step S1045).

Upon receiving the encrypted information Enc(PK1,N) from the card reader 1030, the authentication card 1010 decrypts the received encrypted information Enc(PK1,N) using the secret key “SK1” stored in the secret key storage unit 1101, and outputs the decrypting result to the card reader 1030 (step S1050).

Upon receiving the decrypting result from the authentication card 1010, the card reader 1030 outputs the received decrypting result to the user terminal 1020 (step S1055).

Upon receiving the decrypting result from the card reader 1030, the user terminal 1020 performs an authentication process using the received decrypting result and the random number “N” stored in the random number storage area 1250 (step S1060).

(e) Examination Process

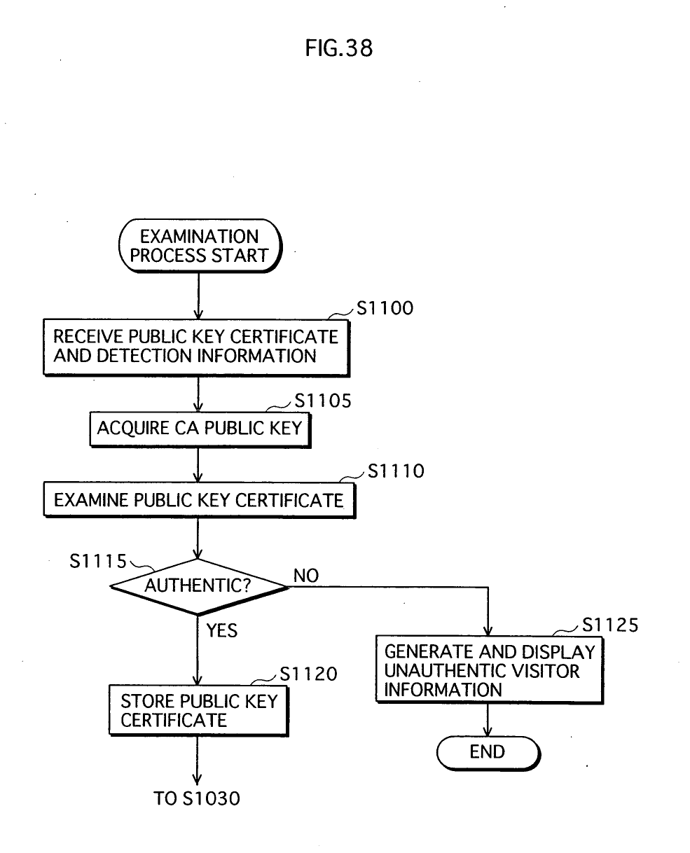

Here, the examination process that is executed in step S1025 of the identity authentication process will be described with reference to the flowchart shown in FIG. 38.

The authentication unit 1202 of the user terminal 1020 receives, from the card reader 1030, the detection information and the public key certificate stored in the authentication card 1010 (step S1100). The authentication unit 1202 then acquires the public key (PK_CA) from the CA public key storage unit 1201 (step S1105).

The authentication unit 1202 performs a signature verification on the certificate signature contained in the received public key certificate, using the acquired public key (PK_CA) (step S1110). The authentication unit 1202 judges, based on the result of the signature verification, whether or not the received public key certificate is authentic (step S1115).

If it judges that the received public key certificate is authentic (YES in step S1115), the authentication unit 1202 stores the received public key certificate in the certificate storage area 1251 (step S1120), and performs step S1030 and after shown in FIG. 37.

If it judges that the received public key certificate is not authentic (NO in step S1115), the authentication unit 1202 generates the unauthentic visitor information, displays the generated unauthentic visitor information (step S1125), and ends the process.

(f) Authentication Process

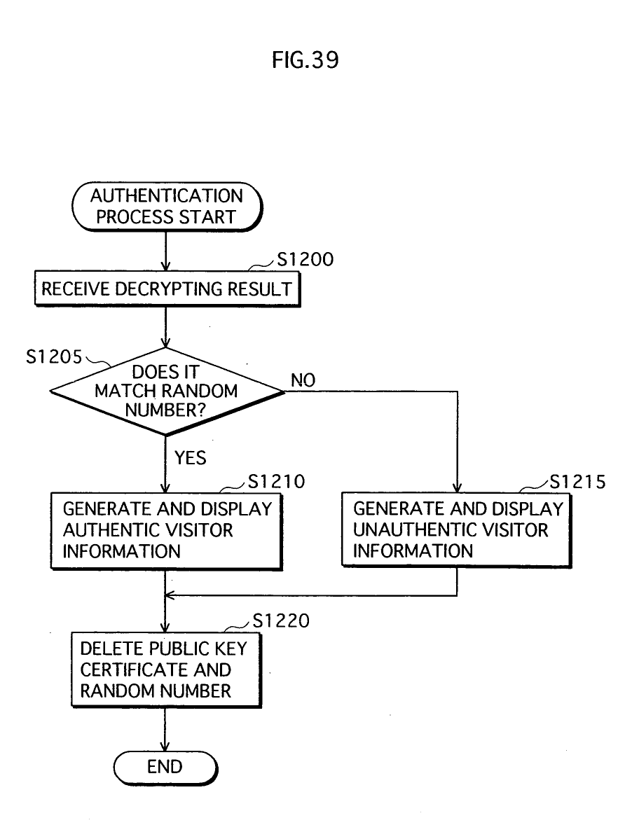

Here, the authentication process that is executed in step S1060 of the identity authentication process will be described with reference to the flowchart shown in FIG. 39.

The authentication unit 1202 of the user terminal 1020 receives, from the authentication card 1010 via the card reader 1030, the decrypting result of the encrypted information (step S1200).

The user terminal 1020 then judges whether or not the decrypting result matches the random number “N” stored in the random number storage area 1250 (step S1205).

If it judges that the decrypting result matches the random number “N” (YES in step S1205), the user terminal 1020 generates authentic visitor information and displays the generated authentic visitor information (step S1210), deletes the random number “N” from the random number storage area 1250 and deletes the public key certificate from the certificate storage area 1251 (step S1220), and ends the process.

If it judges that the decrypting result does not match the random number “N” (NO in step S1205), the user terminal 1020 generates unauthentic visitor information and displays the generated unauthentic visitor information (step S1215), deletes the random number “N” from the random number storage area 1250 and deletes the public key certificate from the certificate storage area 1251 (step S1220), and ends the process.

6.3 Modification of Identity Authentication System 1000

The above-described identity authentication system 1000 is an embodiment of the present invention. The present invention is not limited to the above-described identity authentication system 1000, but may be achieved in various manners within the scope of the present invention. The following, for example, should be construed as the present invention.

(1) In the above-described identity authentication system 1000, the user terminal 1020 stores a CA public key (PK_CA) in advance. However, as in Embodiment 2, the CA public key may be distributed from a distribution apparatus to the user terminal 1020 before a visitor visits the residence of the user.

(2) In the above-described identity authentication system 1000, the user terminal 1020 may perform the visit key authentication and the visit information authentication. Alternatively, the user terminal 1020 may perform either the visit key authentication or the visit information authentication.

6.4 Modification of Operation After Authentication

In the above-described Embodiments, the authentication result is displayed on the user terminal . However, the operation after the authentication is not limited to this.

For example, if the authentication is successful, the name and a facial photo of the visitor may be displayed on the user terminal. Alternatively, the name of the sender of an article, the name of the article, and a message may be displayed.

(a) Displaying Name and Facial Photo of Visitor

Here, a modification in which the name and facial photo of the visitor are displayed will be described using Embodiment 1.

The authentication card 10 includes, in addition to the construction shown in Embodiment 1, a visitor information storage unit for storing visitor information that includes data of the name and facial photo of the visitor.

When the authentication card 10 outputs the encrypted information to the user terminal 20, the authentication card 10 also outputs the visitor information stored in the visitor information storage unit.

Upon receiving the encrypted information and the visitor information from the authentication card 10, the authentication unit 202 of the user terminal 20 temporarily stores the received visitor information, and performs the authentication process using the received encrypted information.

If the authentication in the authentication process is successful, the authentication unit 202, instead of generating the authentic visitor information, acquires the temporarily stored visitor information, generates an image of the facial photo based on the data of the facial photo contained in the acquired visitor information, and outputs the generated image and the name of the visitor contained in the received visitor information to the display unit 203. Upon receiving the image of the facial photo and the name from the authentication unit 202, the display unit 203 displays the received image and name.

It should be noted here that displaying the name and facial photo of the visitor is applicable to the other embodiments. The function can be achieved in each embodiment by providing the authentication card with the above-described visitor information storage unit and allowing the above-described operation to be performed similarly.

Also, the function can be achieved in the identity authentication system 1000 in the modifications by providing the system with the above-described visitor information storage unit and allowing the above-described operation to be performed similarly.

It should be noted here that the items that are displayed when the authentication is successful may be either the name of the visitor or the facial photo of the visitor.

Also, in the above description, the authentication card 10 outputs the visitor information to the user terminal 20 with the timing when it outputs the encrypted information. However, not limited to this, the authentication card 10 may output the visitor information to the user terminal 20 if the user terminal 20 succeeds in the authentication, for example.

In this case, upon a success of an authentication, the user terminal 20 outputs request information, which requests the visitor information, to the authentication card 10 via the card reader 30, and upon receiving the request information, the authentication card 10 acquires the visitor information from the visitor information storage unit, and outputs the acquired visitor information to the user terminal 20 via the card reader 30.

With such a construction, if the authentication succeeds, the name or facial photo of the visitor is displayed. This enhances the security because the user can confirm the face of the visitor or the name written in the name tag of the visitor through a peephole of the entrance door.

(b) Displaying Sender's Name, Article's Name, and Message

Here, a modification in which the name of the sender of an article, the name of the article, and a message are displayed will be described using Embodiment 1.

The authentication card 10 includes, in addition to the construction shown in Embodiment 1, a sender information storage unit for storing sender information that includes the name of the sender, the name of the article, and a message from the sender.

When the authentication card 10 outputs the encrypted information to the user terminal 20, the authentication card 10 also outputs the sender information stored in the sender information storage unit.

Upon receiving the encrypted information and the sender information from the authentication card 10, the authentication unit 202 of the user terminal 20 temporarily stores the received sender information, and performs the authentication process using the received encrypted information.

If the authentication in the authentication process is successful, the authentication unit 202, instead of generating the authentic visitor information, acquires the temporarily stored sender information, and outputs, to the display unit 203, the name of the sender of an article, the name of the article, and a message contained in the received sender information. The display unit 203 displays the name of the sender of the article, the name of the article, and the message received from the authentication unit 202.

It should be noted here that displaying the name of the sender of an article, the name of the article, and a message is applicable to the other embodiments. The function can be achieved in each embodiment by providing the authentication card with the above-described sender information storage unit and allowing the above-described operation to be performed similarly.

Also, the function can be achieved in the identity authentication system 1000 in the modifications by providing the system with the above-described sender information storage unit and allowing the above-described operation to be performed similarly.

It should be noted here that the items that are displayed when the authentication is successful may be one or two out of the name of the sender of an article, the name of the article, and a message.

Also, in the above description, the authentication card 10 outputs the sender information to the user terminal 20 with the timing when it outputs the encrypted information. However, not limited to this, the authentication card 10 may output the sender information to the user terminal 20 if the user terminal 20 succeeds in the authentication, for example.

In this case, upon a success of an authentication, the user terminal 20 outputs request information, which requests the sender information, to the authentication card 10 via the card reader 30, and upon receiving the request information, the authentication card 10 acquires the sender information from the sender information storage unit, and outputs the acquired sender information to the user terminal 20 via the card reader 30.

With such a construction, it is possible to check if the article has been sent by a stranger or not.

Also, in addition to the name of the sender of an article, the name of the article, and a message, the above-described name and facial photo of the visitor may be displayed.

This can be achieved by providing the authentication card 10 with the visitor information storage unit and the sender information storage unit.

6.5 Other Modifications

The above-described Embodiments and modifications are only specific examples of the present invention. The present invention is not limited to the above-described embodiments and modifications, but may be achieved in various manners within the scope of the present invention. The following, for example, should be construed as the present invention.

(1) In the above-described Embodiments and modifications, the challenge-response system is used as the authentication method. However, not limited to this, other authentication methods may be used.

For example, one-way authentication may be used. The authentication method will be described using Embodiment 1.

When inserted in the card reader 30, the authentication card 10 generates a random number “N”, and generates encrypted information Enc(SK1,N) by encrypting the generated random number “N” using the stored identity certification key “SK1”. The authentication card 10 then outputs the generated random number “N” and encrypted information Enc(SK1,N) to the user terminal 20 via the card reader 30.

Upon receiving the random number “N” and encrypted information Enc(SK1,N) from the authentication card 10, the user terminal 20 decrypts the received encrypted information Enc(SK1,N) using the stored identity authentication key “SK1”. The user terminal 20 then judges whether or not the decrypting result matches the random number “N” received from the authentication card 10. If it judges that the decrypting result matches the random number “N”, the user terminal 20 verifies the authenticity of the authentication card inserted in the card reader 30, generates the authentic visitor information, and displays the generated authentic visitor information. If it judges that the decrypting result does not match the random number “N”, the user terminal 20 determines that the authentication card inserted in the card reader 30 is unauthentic, generates the unauthentic visitor information, and displays the generated unauthentic visitor information.

In the case of Embodiment 2, the authentication card 10A operates in the same manner as described above. The user terminal 20A receives an identity authentication key from the distribution apparatus 50A and stores it in advance, and using the stored identity authentication key and the random number “N” and encrypted information Enc(SK1,N) received from the authentication card 1A, the user terminal 20A operates in the same manner as described above. It should be noted here that the stored identity authentication key is deleted after the authentication is performed.

In the case of Embodiment 3, the authentication card 10B operates in the same manner as described above. The user terminal 20B operates in the same manner as described above using the random number “N” and encrypted information Enc(SK1,N) received from the authentication card 10B, and using the identity authentication fingerprint information received from the card reader 30B.

In the case of Embodiment 4, the authentication card 10C operates in the same manner as described above. The user terminal 20C operates in the same manner as described above using the random number “N” and encrypted information Enc(SK1,N) received from the authentication card 1C, and using the identity authentication fingerprint information received from the card reader 30C.

(2) In the above-described Embodiments and modifications, the authentication is performed while the authentication card is inserted in the card reader. However, not limited to this, the authentication may be performed in other manners.

A sensor unit maybe provided on a surface of the card reader, and the authentication may be performed by allowing the authentication card to be in touch with the sensor unit.

Alternatively, a wireless IC tag may be attached to the authentication card, and the authentication may be performed while the authentication card is not in touch with the sensor unit.

(3) In the above-described Embodiments and modifications, the user terminal and the card reader are connected to each other via a cable. However, the present invention is not limited to this.

The user terminal and the card reader may be connected to each other via a wireless communication.

(4) In the above-described Embodiments and modifications, the authentication result is displayed on the user terminal. However, the present invention is not limited to this.

The entrance door may be unlocked if it is judged through an authentication process that the visitor is authentic. In this case, an electronic lock is used to lock or unlock the entrance door. The component unit that locks or unlocks the entrance door is called an entrance door control unit. If it is judged that the authentication card inserted in the card reader is authentic, the user terminal generates the authentic visitor information and outputs the generated authentic visitor information to the entrance door control unit; and if it is judged that the authentication card inserted in the card reader is unauthentic, the user terminal generates the unauthentic visitor information and outputs the generated unauthentic visitor information to the entrance door control unit. Upon receiving information from the user terminal, the entrance door control unit judges whether the received information is the authentic visitor information or the unauthentic visitor information. If it judges that the received information is the authentic visitor information, the entrance door control unit unlock the entrance door; and if it judges that the received information is the unauthentic visitor information, the entrance door control unit does not unlock the entrance door.

As another modification, a release button for releasing the lock of the entrance door may be provided on the user terminal. In this case, if an authentication successfully ends and the release button is depressed, the lock of the entrance door is released. If the authentication does not successfully end, the lock of the entrance door is not released even if the release button is depressed. For example, a child might depress the release button by mistake when only the child stays at home. In such a case, however, the lock of the entrance door is not released unless an authentication successfully ends. This is an advantageous effect.

Further, as another modification, the authentication result may be notified to a stationary or mobile phone that is specified in advance. The notification method is, for example, an automatic message or an e-mail.

(5) In the above-described modification to the communication method, the QR code is used. However, another image information may be used. For example, a bar code may be used.

Also, information other than image information may be used instead. For example, an optical signal may be used.

(6) In the above-described modification to the communication method, an information transfer is performed by using (i) a display that displays an image and (ii) a camera that takes an image displayed on the display. However, not limited to this, the information transfer may be performed in other ways.

For example, the first and second input/output apparatuses may be provided with an infrared communication function, and may transfer information by an infrared communication. In this case, an infrared signal is used in the communication.

Alternatively, the first and second input/output apparatuses may be provided with a speaker and a microphone, convert the information to be transferred into an audio signal, and perform a communication using the converted audio signal.

(7) In the above-described modification to the communication method, the first and second input/output apparatuses are used for transferring information. However, not limited to this, the information transfer may be performed in other ways.

For example, the user terminal may be provided with the functions of the first input/output apparatus, and the second input/output apparatus may be replaced with a camera mobile phone to/from which the authentication card is attachable and detachable. In this case, an information transfer is performed using a peephole of the entrance door.

(8) In the above-described modification to the communication method, the method by which information is output from the user terminal 20D to the authentication card 10D and the method by which information is output from the authentication card 10D and the second input/output apparatus 70D to the user terminal 20D are the same method. However, not limited to this, the method by which information is output from the user terminal 20D to the authentication card 10D may be different from the method by which information is output from the authentication card 10D and the second input/output apparatus 70D to the user terminal 20D.

For example, information may be output from the user terminal 20D to the authentication card 10D in the form of QR code, and information may be output from the authentication card 10D and the second input/output apparatus 70D to the user terminal 20D in the form of an audio signal.

(9) In the above-described Embodiments and modifications, information may be converted into another type of information before the information is output from the user terminal to the authentication card or when the information is output from the authentication card or the card reader to the user terminal.

For example, information may be converted into a QR code, and the user terminal may output the information to the authentication card in the form of the QR code. In this case, upon receiving the information in the form of the QR code from the user terminal via the card reader, the authentication card restores the original information using the received information in the form of the QR code. Similarly, information may be converted into a QR code, and the authentication card or the card reader may output the information to the user terminal in the form of the QR code. In this case, upon receiving the information in the form of the QR code from the authentication card via the card reader, or upon receiving the information in the form of the QR code from the card reader, the user terminal restores the original information using the received information in the form of the QR code.

In the above-described example, the method by which information is output from the user terminal and the method by which information is output from the authentication card or the card reader are the same method (outputting the information in the form of QR code). However, not limited to this, the method by which information is output from the user terminal may be different from the method by which information is output from the authentication card or the card reader.

For example, information may be output from the user terminal in the form of QR code, and information may be output from the authentication card or the card reader in the form of an audio signal.

(10) In the above-described Embodiments and modifications, the control unit is provided in the authentication card. However, not limited to this, the control unit may be provided in the card reader, not in the authentication card, so as to transfer the processes performed by the control unit from the authentication card to the card reader.

Also, in the above-described modification to the communication method, the control unit may be provided in the second input/output apparatus, not in the authentication card, so as to transfer the processes performed by the control unit from the authentication card to the second input/output apparatus.

(11) In the above-described Embodiments and modifications, the user terminal may be a mobile phone. In this case, the mobile phone may be provided with the authentication unit in advance, or may download, from an application distribution apparatus which the home-visit company has, an application that operates in the same manner as the authentication unit, and store the downloaded application therein.

Alternatively, the user terminal may be a TV door-phone, instead of a unit in the intercommunication system.

(12) In the above-described Embodiments and modifications, the authentication card may identify the user terminal.

In this case, the user terminal stores a terminal ID in advance, and the authentication card includes a storage area for storing terminal IDs. The user terminal outputs the terminal ID it stores in advance to the authentication card if it judges through an authentication process that the visitor is authentic. The authentication card stores the received terminal ID into the storage area.

This arrangement enables the terminal IDs stored in the storage area of the authentication card as a visit history.

(13) In the above-described Embodiments and modifications, the authentication card may authenticate the user terminal.

This arrangement enables a proof of delivery to be provided.

(14) In the above-described Embodiment 1, the identity authentication key stored in the user terminal 20 may be changed, or the user terminal 20 may additionally store an identity authentication key.

In this case, the identity authentication system 1 further includes a distribution apparatus that transmits a pair of an authentication ID and an identity authentication key to the user terminal 20. Upon receiving the pair of the authentication ID and the identity authentication key from the distribution apparatus, the user terminal 20 judges whether or not the key information table T100 has the same authentication ID as the received authentication ID. If it judges that the key information table T100 has the same authentication ID as the received authentication ID, the user terminal 20 rewrites an identity authentication key that has been stored in correspondence with the authentication ID with the received identity authentication key. If it judges that the key information table T100 does not have the same authentication ID as the received authentication ID, the user terminal 20 adds the received pair of the authentication ID and the identity authentication key as a new identity authentication key.

(15) In the above-described Embodiment 2, the identity authentication key may be encrypted before it is distributed. In this case, the user terminal stores in advance a decryption key used to decrypt the encrypted identity authentication key, in a tamper-resistant storage area, decrypts the received encrypted identity authentication key, and stores the identity authentication key obtained through the decrypting into the tamper-resistant authentication key storage area.

(16) In the above-described Embodiment 2, the distribution apparatus 50A and the user terminal 20A are connected to each other via the Internet. However, not limited to this, they may be connected to each other in a network via a dedicated line.

(17) In the above-described Embodiment 2, the identity authentication key that is distributed from the distribution apparatus 50A in advance, and stored, is deleted after the authentication process. However, not limited to this, other methods are available.

For example, the identity authentication key may be kept to be stored, without being deleted. In this case, upon receiving an identity authentication key from the distribution apparatus 50A, the user terminal 20A judges whether or not the received identity authentication key matches a stored identity authentication key. If it judges that the received identity authentication key matches a stored identity authentication key, the user terminal 20A does not rewrite the key; and if it judges that the received identity authentication key does not match a stored identity authentication key, the user terminal 20A rewrites the stored identity authentication key with the received identity authentication key.

(18) In the above-described Embodiment 3, as the biometrics information used in the authentication, the information (hereinafter, fingerprint information) that is composed of characteristic points of the fingerprint pattern of the visitor is used. However, not limited to this, other information may be used.

The biometrics information may be, for example, fingerprint information, voiceprint information which indicates characteristics of the voiceprint of the visitor, iris information which indicates characteristics of the iris of the visitor, facial outline information which indicates characteristics of the facial outline of the visitor, DNA information which indicates characteristics of the DNA of the visitor, or any combination of these types of information.

When the voiceprint information is used, the card reader 30B is provided with a voiceprint reading unit that receives a voice of the visitor, and generates, from the received voice, identity authentication voiceprint information that indicates characteristics of the visitor's voiceprint. On the other hand, the authentication card 10B stores identity certification voiceprint information that indicates characteristics of the visitor's voiceprint, in advance.

When the iris information is used, the card reader 30B is provided with an iris reading unit that reads an iris of the visitor, and generates, from the read iris, identity authentication iris information that indicates characteristics of the visitor's iris. On the other hand, the authentication card 10B stores identity certification iris information that indicates characteristics of the visitor's iris, in advance.

When the facial outline information is used, the card reader 30B is provided with a facial outline reading unit that reads a facial outline of the visitor, and generates, from the read facial outline, identity authentication facial outline information that indicates characteristics of the visitor's facial outline. On the other hand, the authentication card 10B stores identity certification facial outline information that indicates characteristics of the visitor's facial outline, in advance.

When the DNA information is used, the card reader 30B is provided with a DNA reading unit that receives identity authentication DNA information that is DNA information generated by analyzing the DNA of the visitor. On the other hand, the authentication card 10B stores identity certification DNA information that is DNA information generated by analyzing the DNA of the visitor, in advance. It should be noted here that the DNA information is information that is generated by analyzing, for example, the hair, blood, or saliva of the visitor.

Similarly, in the above-described Embodiment 4, the biometrics information may be, for example, fingerprint information, voiceprint information which indicates characteristics of the voiceprint of the visitor, iris information which indicates characteristics of the iris of the visitor, facial outline information which indicates characteristics of the facial outline of the visitor, DNA information which indicates characteristics of the DNA of the visitor, or any combination of these types of information.

(19) In the above-described Embodiments 3 and 4, the identity authentication fingerprint information may be encrypted before it is output from the card reader to the user terminal.

This can be achieved with a construction in which the card reader stores, in advance, an encryption key that is used for encrypting the identity authentication fingerprint information, and the user terminal stores, in advance, a decryption key that is used for decrypting encrypted identity authentication fingerprint information received from the card reader.

(20) In the visit key authentication process in the above-described Embodiment 4, the secret key encryption process is used as the authentication method by the challenge-response system. However, not limited to this, another encryption process may be used as the authentication method by the challenge-response system as is the case with the above-described modification to the authentication method. Alternatively, another authentication method may be used as is the case with the above-described (1).

(21) In the above-described modification (1) to the authentication method, a public key is stored in the user terminal, and a secret key is stored in the authentication card. However, not limited to this, the following is possible.

That is to say, a public key may be stored in the authentication card, and a secret key may be stored in the user terminal. The description of the operation in the authentication process is omitted here since it is the same as the case in which the secret key encryption process is used.

(22) In the above-described Embodiments and modifications, the user terminal and the card reader of the identity authentication system are treated as separate apparatuses. However, not limited to this, the following is possible.

That is to say, the user terminal and the card reader may be replaced with one apparatus that is composed of the user terminal and the card reader.

Similarly, in the above-described modification to the communication method, the user terminal and the first input/output apparatus may be replaced with one apparatus that is composed of the user terminal and the first input/output apparatus.

(23) In Embodiment 4, the second random number is generated for use in an authentication that is performed based on the certification visit key and the authentication visit key. However, not limited to this, the following is possible. That is to say, without generating the second random number, the first random number that was used in a previous authentication may be used for use in the authentication that is performed based on the certification visit key and the authentication visit key. In this case, in the identity authentication process shown in FIGS. 26 and 27, the step S715 is changed so that the first random number “N1” stored in the random number storage area 250C is output to the card reader 30C, and in the succeeding operation, the first random number “N1” is used instead of the second random number “N2”.

(24) In Embodiment 4, after the authentication that is performed based on the certification visit key and the authentication visit key, it is judged whether or not the certification time information and the certification business information contained in the certification visit information respectively match the time information and the business information contained in the authentication visit information, and it is judged whether or not the current time falls into the visit time period. However, not limited to this, the following is possible.

Without performing the authentication based on the certification visit key and the authentication visit key, after the authentication based on the identity authentication fingerprint information and the identity certification information is performed, it may be judged whether or not the certification time information and the certification business information contained in the certification visit information respectively match the time information and the business information contained in the authentication visit information, and it may be judged whether or not the current time falls into the visit time period.

Alternatively, without performing the authentication based on the certification visit key and the authentication visit key, after the authentication based on the identity authentication fingerprint information and the identity certification information is performed, either of the judgment on whether or not the certification time information and the certification business information contained in the certification visit information respectively match the time information and the business information contained in the authentication visit information and the judgment on whether or not the current time falls into the visit time period may be made.

Further, after the authentication based on the identity authentication fingerprint information and the identity certification information is performed, only the authentication based on the certification visit key and the authentication visit key may be performed.

(25) In the above-described Embodiments 1, 2, and 3, only the certification key storage unit of the authentication card is tamper-resistant. However, other components may also be tamper-resistant.

For example, in Embodiment 1, the certification key storage unit 101, the control unit 102, and the input/output unit 103 of the authentication card 10 may be tamper-resistant.

This also applies to Embodiment 4. That is to say, although only the certification key storage unit and the visit key storage unit of the authentication card are tamper-resistant in Embodiment 4, other components may also be tamper-resistant.

(26) In the above-described Embodiments and modifications, the user terminal decrypts the encrypted information (in Embodiment 4, the first encrypted information) that is received from the authentication card, and judges whether or not the decrypting result matches the random number (in Embodiment 4, the first random number) that has been generated and stored therein. However, not limited to this, the following is possible.

The user terminal may generate an encrypted random number by encrypting the random number (in Embodiment 4, the first random number) that has been generated and stored therein, using the identity authentication key (in Embodiments 3 and 4, the identity authentication fingerprint information) that has been stored therein, and then judge whether or not the generated encrypted random number matches the encrypted information that has been received from the authentication card. If it judges that the encrypted random number matches the encrypted information, the user terminal determines that the authentication card is authentic, generates authentic visitor information and displays the generated authentic visitor information; and if it judges that the encrypted random number does not match the encrypted information, the user terminal determines that the authentication card is unauthentic, generates unauthentic visitor information and displays the generated unauthentic visitor information.

(27) In the above-described Embodiments and modifications, the user terminal outputs the generated random number (in Embodiment 4, the first random number) to the authentication card. However, the user terminal generate an encrypted random number by encrypting the random number using the identity authentication key (in Embodiments 3 and 4, the identity authentication fingerprint information), and output the generated encrypted random number.

In this case, upon receiving the encrypted random number from the user terminal, the authentication card decrypts the encrypted random number using the identity certification key, and outputs the decrypting result to the user terminal. Upon receiving the decrypting result, the user terminal judges whether or not the received decrypting result matches the stored random number (in Embodiment 4, the first random number). If it judges that the decrypting result matches the random number, the user terminal determines that the authentication card is authentic, generates authentic visitor information and displays the generated authentic visitor information; and if it judges that the encrypted random number does not match the encrypted information, the user terminal determines that the authentication card is unauthentic, generates unauthentic visitor information and displays the generated unauthentic visitor information.

(28) In the authentication card 10C in the above-described Embodiment 4, the certification visit information and the certification business information, namely the certification visit information, may be encrypted before they are stored in the certification visit information table T300.

In this case, the distribution apparatus 50C stores, in advance, an encryption key that is used for encrypting the certification visit information, encrypts the certification visit information using the stored encrypted key, and records the encrypted certification visit information into the authentication card 10C. Also, the user terminal 20C stores a decryption key that corresponds to the encryption key stored in the distribution apparatus 50C, and in case it performs the visit information authentication process, acquires the encrypted certification visit information from the authentication card 10C, generates certification visit information by decrypting the acquired encrypted certification visit information using the stored decryption key, and performs the visit information authentication process using the generated certification visit information.

(29) The forwarding agent may visit an apartment in a building. In this case, the card reader may be provided on the entrance door of each apartment in a building, or may be provided on the entrance door of the whole apartment building.

(30) The card reader may detect the lock status of the door of a storage box which is placed outside the residence for storing delivered goods.

(31) The target of the present invention is not limited to an ordinary residence, but may be a business user such as a company in so far as an article is delivered there.

(32) The detection of how a door is locked may be applied to Embodiments 2, 3, and 4 the above-described modifications.

(33) In Embodiment 1, the card reader 30 displays a door lock message if it does not detect the locked status. However, it may urge the user to lock the door by a warning beep.

Alternatively, if the card reader 30 does not detect the locked status, the card reader 30 may lock the door through an electronic control.

(34) The present invention may be methods shown by the above. The present invention may be a computer program that allows a computer to realize the methods, or may be digital signals representing the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal via the recording medium, or by transferring the program or the digital signal via the network or the like, the program or the digital signal may be executed by another independent computer system.

(35) The present invention may be any combination of the above-described embodiments and modifications.

### INDUSTRIAL APPLICABILITY

The above described identity authentication system can be used effectively, namely repetitively and continuously, in the industry in which a home-visit company sends a person to visit a residence of a user to provide the user with a service, such as the sales or delivery service.

1. An authentication system, comprising:
a portable recording medium which a forwarding agent has;
an authentication apparatus operable to verify authenticity of a visit by the forwarding agent, the authentication apparatus being provided in a residence of a person who is visited by the forwarding agent; and
an input/output apparatus operable to perform inputting and outputting of information between the portable recording medium and the authentication apparatus, the input/output apparatus being provided at an entrance of the residence, wherein
the portable recording medium stores therein in advance at least one piece of information concerning authenticity of the visit by the forwarding agent, and
the authentication apparatus stores therein at least one piece of information used for verifying authenticity of the visit by the forwarding agent, and judges whether or not the visit by the forwarding agent is authentic by, via the input/output apparatus, performing an authentication using the information stored in the portable recording medium and the information stored in the authentication apparatus.

2. The authentication system of claim 1, wherein
the portable recording medium is an IC card,
the input/output apparatus is a card reader for the IC card,
the card reader detects a lock status of an entrance door, and
the authentication apparatus performs the authentication if the card reader detects that the entrance door is locked.

3. The authentication system of claim 2, wherein
the IC card stores therein certification information that certifies authenticity of the forwarding agent, as the information concerning authenticity of the visit by the forwarding agent,
the authentication apparatus stores therein, as the information concerning verifying authenticity of the visit by the forwarding agent, authentication information that is used to examine the certification information, and
the authentication apparatus performs, via the card reader, the authentication using the certification information and the stored authentication information to judge whether or not the visit by the forwarding agent is authentic.

4. The authentication system of claim 3, wherein
the IC card further stores therein first visit information that indicates a business of the visit by the forwarding agent, as the information concerning authenticity of the visit by the forwarding agent,
the authentication apparatus further stores therein, as the information concerning verifying authenticity of the visit by the forwarding agent, second visit information used to examine the first visit information, and
the authentication apparatus, if a result of the authentication using the certification information and the authentication information is positive, acquires the first visit information from the IC card via the card reader, judges whether or not the acquired first visit information matches the stored second visit information, and if a result of the judgment is positive, judges that the visit by the forwarding agent is authentic.

5. The authentication system of claim 4, wherein
the first visit information is first time information that indicates a time period for the visit by the forwarding agent,
the second visit information is second time information that indicates a time period for the visit by the forwarding agent, and
the authentication apparatus judges whether or not the first time information matches the second time information.

6. The authentication system of claim 4, wherein
the first visit information is first business information that indicates a business of the visit by the forwarding agent,
the second visit information is second business information that indicates a business of the visit by the forwarding agent, and
the authentication apparatus judges whether or not the first business information matches the second business information.

7. The authentication system of claim 4, wherein
the first visit information includes (i) first time information that indicates a time period for the visit by the forwarding agent and (ii) first business information that indicates a business of the visit by the forwarding agent,
the second visit information includes (iii) second time information that indicates a time period for the visit by the forwarding agent and (iv) second business information that indicates a business of the visit by the forwarding agent, and
the authentication apparatus judges whether or not the first time information matches the second time information, and judges whether or not the first business information matches the second business information.

8. The authentication system of claim 4, wherein
the IC card further stores therein article information concerning an article delivered by the forwarding agent, and
the authentication apparatus further acquires the article information from the IC card via the card reader, and if the authentication apparatus judges that the visit by the forwarding agent is authentic, displays the article information.

9. The authentication system of claim 8, wherein
the article information is a name of a sender of the article, and
the authentication apparatus acquires the name of the sender from the IC card and displays the acquired name.

10. The authentication system of claim 8, wherein
the article information is a name of the article, and
the authentication apparatus acquires the name of the article from the IC card and displays the acquired name of the article.

11. The authentication system of claim 8, wherein
the article information is a message from a sender of the article, and
the authentication apparatus acquires the message from the IC card and displays the acquired message.

12. The authentication system of claim 4, wherein
the IC card further stores therein visitor information for identifying a visitor,
the authentication apparatus further acquires the visitor information from the IC card via the card reader, and if the authentication apparatus judges that the visit by the forwarding agent is authentic, displays the visitor information.

13. The authentication system of claim 12, wherein
the visitor information is a name of the visitor, and
the authentication apparatus acquires the name of the visitor from the IC card and displays the acquired name of the visitor.

14. The authentication system of claim 12, wherein
the visitor information is an image of a facial photo of the visitor, and
the authentication apparatus acquires the image of the facial photo of the visitor from the IC card and displays the acquired image of the facial photo.

15. The authentication system of claim 12, wherein
the visitor information is a name and an image of a facial photo of the visitor, and
the authentication apparatus acquires the name and the image of the facial photo of the visitor from the IC card and displays the acquired name and image of the facial photo.

16. The authentication system of claim 4, wherein
the authentication apparatus and the IC card perform a challenge-response authentication process using the certification information and the authentication information.

17. The authentication system of claim 16, wherein
the certification information is an encryption key,
the authentication information is a decryption key,
the authentication apparatus generates challenge data, and outputs the generated challenge data to the IC card via the card reader,
the IC card receives the challenge data from the authentication apparatus, generates response data by encrypting the challenge data using the encryption key, and outputs the generated response data to the authentication apparatus via the card reader, and
the authentication apparatus receives the response data from the IC card, generates decrypted data by decrypting the response data using the decryption key, and performs an authentication by judging whether or not the generated decrypted data matches the challenge data.

18. The authentication system of claim 17, wherein
the encryption key is holder certification information that shows biometric characteristics of a holder of the IC card, and
the authentication apparatus further receives holder authentication information that shows biometric characteristics of a visitor, and uses the holder authentication information as the decryption key.

19. The authentication system of claim 17, wherein
the authentication apparatus is connected, via a network, to a distribution apparatus that distributes the decryption key,
the authentication apparatus receives the decryption key distributed from the distribution apparatus and stores the received decryption key prior to the visit by the forwarding agent.

20. The authentication system of claim 16, wherein
the authentication information is a secret key,
the IC card stores therein a first key that is obtained by executing a one-way function on a key that is identical with the secret key,
the authentication apparatus generates challenge data, and outputs the generated challenge data to the IC card via the card reader,
the IC card receives the challenge data from the authentication apparatus, generates response data by encrypting the challenge data using the first key, and outputs the generated response data to the authentication apparatus via the card reader, and
the authentication apparatus receives the response data from the IC card, generates a second key by executing a function, which is identical with the one-way function, on the secret key, generates decrypted data by decrypting the response data using the second key, and performs an authentication by judging whether or not the generated decrypted data matches the challenge data.

21. The authentication system of claim 16, wherein
the authentication information is a first secret key,
the IC card stores therein a second secret key that is identical with the first secret key,
the authentication apparatus generates challenge data, and outputs the generated challenge data to the IC card via the card reader,
the IC card receives the challenge data from the authentication apparatus, generates response data by encrypting the challenge data using the second secret key, and outputs the generated response data to the authentication apparatus via the card reader, and
the authentication apparatus receives the response data from the IC card, generates encrypted data by encrypting the challenge data using the first secret key, and performs an authentication by judging whether or not the generated encrypted data matches the response data.

22. The authentication system of claim 16, wherein
the certification information is a secret key,
the authentication information is a public key that corresponds to the secret key,
the authentication apparatus generates challenge data, and outputs the generated challenge data to the IC card via the card reader,
the IC card receives the challenge data from the authentication apparatus, generates a digital signature of the received challenge data using the secret key, and outputs the generated digital signature as response data, to the authentication apparatus via the card reader, and
the authentication apparatus receives the response data from the IC card, and then performs an authentication by performing a signature verification on the received digital signature using the public key and the challenge data.

23. The authentication system of claim 22, wherein
the secret key is holder certification information that shows biometric characteristics of a holder of the IC card, and
the authentication apparatus further receives holder authentication information that shows biometric characteristics of a visitor, and uses the holder authentication information as the public key.

24. The authentication system of claim 16, wherein
the certification information is a secret key,
the authentication information is a public key that corresponds to the secret key,
the authentication apparatus generates challenge data, generates encrypted challenge data by encrypting the generated challenge data using the public key, and outputs the generated encrypted challenge data to the IC card via the card reader,
the IC card receives the encrypted challenge data from the authentication apparatus, generates response data by decrypting the received encrypted challenge data using the secret key, and outputs the generated response data to the authentication apparatus via the card reader, and
the authentication apparatus receives the response data from the IC card, and performs an authentication by judging whether or not the received response data matches the challenge data.

25. The authentication system of claim 24, wherein
the IC card stores therein a public key certificate that is a proof of validity for the public key, which is also contained in the public key certificate, and
the authentication apparatus further acquires the public key certificate from the IC card, performs an authentication by judging whether or not the acquired public key certificate is authentic, and if a result of the authentication is positive, stores therein the public key that is contained in the public key certificate.

26. The authentication system of claim 16, wherein
the IC card stores there in a second visit key that is identical with a first visit key that is distributed from the forwarding agent to the authentication apparatus prior to the visit,
the authentication apparatus further stores therein the first visit key,
if a result of an authentication by a challenge-response is positive, the authentication apparatus further generates visit examination data, and outputs the generated visit examination data to the IC card via the card reader,
the IC card receives the visit examination data from the authentication apparatus, generates encrypted visit examination data by encrypting the received visit examination data using the second visit key, and outputs the generated encrypted visit examination data to the authentication apparatus via the card reader, and
the authentication apparatus receives the encrypted visit examination data from the IC card, decrypts the encrypted visit examination data using the first visit key, judges whether or not a result of the decrypting matches the visit examination data, and if it judges that the result of the decrypting matches the visit examination data, judges whether or not first visit information matches second visit information.

27. The authentication system of claim 16, wherein
when the authentication apparatus outputs the challenge data to the IC card, the authentication apparatus converts the challenge data into converted challenge information that has the same contents as the challenge data but has a different data structure from the challenge data, and outputs, to the IC card, the converted challenge information as the challenge data.

28. The authentication system of claim 27, wherein
when the IC card outputs the response data to the authentication apparatus, the IC card converts the response data into converted response information that has the same contents as the response data but has a different data structure from the response data, and outputs, to the authentication apparatus, the converted response information as the response data.

29. The authentication system of claim 28, wherein
the converted challenge information is composed of one of an optical signal, a bar code, a QR code, an infrared signal, and an audio signal, and
the converted response information is composed of one of an optical signal, a bar code, a QR code, an infrared signal, and an audio signal.

30. The authentication system of claim 16, wherein
the authentication apparatus further stores therein an apparatus identifier for identifying the authentication apparatus itself,
the authentication apparatus outputs the apparatus identifier to the IC card via the card reader if the authentication apparatus judges that the visit by the forwarding agent is authentic, and
the IC card, upon receiving the apparatus identifier from the authentication apparatus, stores therein the received apparatus identifier.

31. An authentication apparatus for verifying authenticity of a visit by a forwarding agent using a portable recording medium which the forwarding agent has, the authentication apparatus being provided in a residence of a person who is visited by the forwarding agent, the authentication apparatus comprising:
an information storage unit operable to store therein information used for the verifying of authenticity of the visit by the forwarding agent; and
a judgment unit operable to judge whether or not the visit by the forwarding agent is authentic by, via an input/output apparatus provided at an entrance of the residence, performing an authentication using information stored in the portable recording medium concerning authenticity of the visit by the forwarding agent and using the information stored in the information storage unit.

32. The authentication apparatus of claim 31, wherein
the input/output apparatus is a card reader for the recording medium,
the card reader detects a lock status of an entrance door, and
the judgment unit performs the authentication if the card reader detects that the entrance door is locked.

33. The authentication apparatus of claim 32, wherein
the recording medium stores therein certification information that certifies authenticity of the forwarding agent, as the information concerning authenticity of the visit by the forwarding agent,
the information storage unit stores therein, as the information concerning verifying authenticity of the visit by the forwarding agent, authentication information that is used to examine the certification information, and
the judgment unit performs, via the card reader, the authentication using the certification information and the stored authentication information to judge whether or not the visit by the forwarding agent is authentic.

34. The authentication apparatus of claim 33, wherein
the recording medium further stores therein first visit information that indicates a business of the visit by the forwarding agent, as the information concerning authenticity of the visit by the forwarding agent,
the information storage unit further stores therein, as the information concerning verifying authenticity of the visit by the forwarding agent, second visit information used to examine the first visit information, and
the judgment unit, if a result of the authentication using the certification information and the authentication information is positive, acquires the first visit information from the recording medium via the card reader, judges whether or not the acquired first visit information matches the stored second visit information, and if a result of the judgment is positive, judges that the visit by the forwarding agent is authentic.

35. The authentication apparatus of claim 34, wherein
the recording medium further stores therein article information concerning an article delivered by the forwarding agent, and
the authentication apparatus further comprises:
an article information acquiring unit operable to acquire the article information from the recording medium via the card reader; and
an article information display unit operable to display the article information if the judgment unit judges that the visit by the forwarding agent is authentic.

36. The authentication apparatus of claim 34, wherein
the recording medium further stores therein visitor information for identifying a visitor, and
the authentication apparatus further comprises:
a visitor information acquiring unit operable to acquire the visitor information from the recording medium via the card reader; and
a visitor information display unit operable to display the visitor information if the judgment unit judges that the visit by the forwarding agent is authentic.

37. The authentication apparatus of claim 34, wherein
the authentication apparatus and the recording medium perform a challenge-response authentication process using the certification information and the authentication information.

38. The authentication apparatus of claim 37, wherein
the authentication apparatus is a mobile phone.

39. A portable recording medium which a forwarding agent has and is used by an authentication apparatus operable to verify authenticity of a visit by the forwarding agent, the authentication apparatus being provided in a residence of a person who is visited by the forwarding agent, the portable recording medium comprising:
a storage unit operable to store therein in advance at least one piece of information concerning authenticity of the visit by the forwarding agent;
a receiving unit operable to receive first data from the authentication apparatus via an input/output apparatus provided at an entrance of the residence;
a data generating unit operable to generate second data from the first data using the information stored in the storage unit, the second data being used for an authentication process; and
an output unit operable to output the second data to the authentication apparatus via the input/output apparatus.

40. The recording medium of claim 39, wherein
the storage unit stores therein certification information that certifies authenticity of the forwarding agent, as the information concerning authenticity of the visit by the forwarding agent, and
the data generating unit generates the second data using the certification information.

41. The recording medium of claim 40, wherein
the storage unit further stores therein visit information that indicates a business of the visit by the forwarding agent, as the information concerning authenticity of the visit by the forwarding agent, and
the output unit further outputs the visit information to the authentication apparatus via the input/output apparatus.

42. The recording medium of claim 41 further comprising
an article information storage unit operable to store therein article information concerning an article delivered by the forwarding agent, wherein
the output unit further outputs the article information to the authentication apparatus via the input/output apparatus.

43. The recording medium of claim 41 further comprising
a visitor information storage unit operable to store therein visitor information for identifying a visitor, wherein
the output unit further outputs the visitor information to the authentication apparatus via the input/output apparatus.

44. The recording medium of claim 41, wherein
the authentication apparatus stores therein authentication information that is used to examine the certification information, and
the authentication apparatus and the recording medium perform a challenge-response authentication process using the certification information and the authentication information.

45. The recording medium of claim 44, wherein
the recording medium is attached to a mobile phone.

46. An authentication method for an authentication apparatus for verifying authenticity of a visit by a forwarding agent using a portable recording medium which the forwarding agent has, the authentication apparatus being provided in a residence of a person who is visited by the forwarding agent,
the authentication apparatus comprising:
an information storage unit operable to store therein information used for the verifying of authenticity of the visit by the forwarding agent, and
the authentication method comprising the step of:
judging whether or not the visit by the forwarding agent is authentic by, via an input/output apparatus provided at an entrance of the residence, performing an authentication using information stored in the portable recording medium concerning authenticity of the visit by the forwarding agent and using the information stored in the information storage unit.

47. An authentication program that is run in an authentication apparatus for verifying authenticity of a visit by a forwarding agent using a portable recording medium which the forwarding agent has, the authentication apparatus being provided in a residence of a person who is visited by the forwarding agent,
the authentication apparatus comprising:
an information storage unit operable to store therein information used for the verifying of authenticity of the visit by the forwarding agent, and
the authentication program comprising the step of:
judging whether or not the visit by the forwarding agent is authentic by, via an input/output apparatus provided at an entrance of the residence, performing an authentication using information stored in the portable recording medium concerning authenticity of the visit by the forwarding agent and using the information stored in the information storage unit.

48. A computer-readable program recording medium that records therein an authentication program that is run in an authentication apparatus for verifying authenticity of a visit by a forwarding agent using a portable recording medium which the forwarding agent has, the authentication apparatus being provided in a residence of a person who is visited by the forwarding agent,
the authentication apparatus comprising:
an information storage unit operable to store therein information used for the verifying of authenticity of the visit by the forwarding agent, and
the authentication program comprising the step of: judging whether or not the visit by the forwarding agent is authentic by, via an input/output apparatus provided at an entrance of the residence, performing an authentication using information stored in the portable recording medium concerning authenticity of the visit by the forwarding agent and using the information stored in the information storage unit.
